(19) United States
(12) Patent Application Publication
(10) Pub. No.: US 2025/0274246 A1
(43) Pub. Date: Aug. 28, 2025

(54) MEASUREMENT REFERENCE SIGNALS FOR UE-INITIATED BEAM MANAGEMENT

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/049,969

(22) Filed: Feb. 10, 2025

Related U.S. Application Data
(60) Provisional application No. 63/557,321, filed on Feb. 23, 2024.
(60) Provisional application No. 63/701,110, filed on Sep. 30, 2024.

(51) Int. Cl. H04L 5/00

(52) U.S. Cl. CPC H04L 5/0091; H04L 5/0051

(57) ABSTRACT

Methods and apparatuses for determination of reference signals (RSs) for user equipment (UE)-initiated beam management. A method performed by a UE includes receiving a transmission configuration indication (TCI) state and receiving channel state information (CSI) reporting setting for UE-initiated or event-driven beam reporting. The CSI reporting setting includes an indication related to one or more report quantities associated with a current beam and information related to event evaluation. The method further includes determining, based on the CSI reporting setting, a set of one or more RS resources for event evaluation and identifying, based on the indication and the TCI state, a current beam RS resource. The method further includes identifying, based on the indication, one or more candidate beam RS resources, determining, based on the information and measurements of the current and candidate beam RSs, an event, and transmitting, based on determination of the event, the beam report.

### CROSS-REFERENCE TO RELATED AND CLAIM OF PRIORITY

The present application claims priority under 35 U.S.C. § 119 (c) to U.S. Provisional Patent Application No. 63/557,321 filed on Feb. 23, 2024 and U.S. Provisional Patent Application No. 63/701,110 filed on Sep. 30, 2024, which are hereby incorporated by reference in their entirety.

### TECHNICAL FIELD

The present disclosure relates generally to wireless communication systems and, more specifically, the present disclosure relates to methods and apparatuses for determination of reference signals (RSs) for user equipment (UE)-initiated beam management.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets. “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications. 5G communication systems have been developed and are currently being deployed.

### SUMMARY

The present disclosure relates to determination of RSs for UE-initiated beam management.

In one embodiment, a user equipment (UE) is provided. The UE includes a transceiver configured to receive a transmission configuration indication (TCI) state and receive channel state information (CSI) reporting setting for UE-initiated or event-driven beam reporting. The CSI reporting setting includes an indication related to one or more report quantities associated with a current beam and information related to event evaluation. The UE further includes a processor operably coupled with the transceiver. The processor is configured to determine, based on the CSI reporting setting, a set of one or more reference signal (RS) resources for event evaluation; identify, based on the indication and the TCI state, a current beam RS resource; identify, based on the indication, one or more candidate beam RS resources; and determine, based on the information and measurements of the current and candidate beam RSs, an event. The transceiver is further configured to transmit, based on determination of the event, the beam report.

In another embodiment, a base station (BS) is provided. The BS includes a processor and a transceiver operably coupled with the processor. The transceiver is configured to transmit a TCI state and transmit CSI reporting setting for UE-initiated or event-driven beam reporting. The CSI reporting setting includes an indication related to one or more report quantities associated with a current beam and information related to event evaluation. The CSI reporting setting indicates a set of one or more RS resources for event evaluation. The indication and the TCI state indicate a current beam RS resource. The indication indicates one or more candidate beam RS resources. An event is determined based on the information and measurements of the current and candidate beam RSs. The transceiver is further configured to receive the beam report based on the event occurring.

In yet another embodiment, a method performed by a UE is provided. The method includes receiving a TCI state and receiving CSI reporting setting for UE-initiated or event-driven beam reporting. The CSI reporting setting includes an indication related to one or more report quantities associated with a current beam and information related to event evaluation. The method further includes determining, based on the CSI reporting setting, a set of one or more RS resources for event evaluation and identifying, based on the indication and the TCI state, a current beam RS resource. The method further includes identifying, based on the indication, one or more candidate beam RS resources, determining, based on the information and measurements of the current and candidate beam RSs, an event, and transmitting, based on determination of the event, the beam report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example UE-initiated report content/quantity according to embodiments of the present disclosure;

FIG. 8 illustrates a diagram of an example time window for UE-initiated beam management according to embodiments of the present disclosure;

FIG. 9 illustrates a diagram of an example time window for UE-initiated beam management according to embodiments of the present disclosure;

FIG. 10 illustrates a diagram of an example time window for UE-initiated beam management according to embodiments of the present disclosure;

FIG. 11 illustrates a diagram of an example time window for UE-initiated beam management according to embodiments of the present disclosure; and

FIG. 12 illustrates an example method performed by a UE in a wireless communication system according to embodiments of the present disclosure.

### DETAILED DESCRIPTION

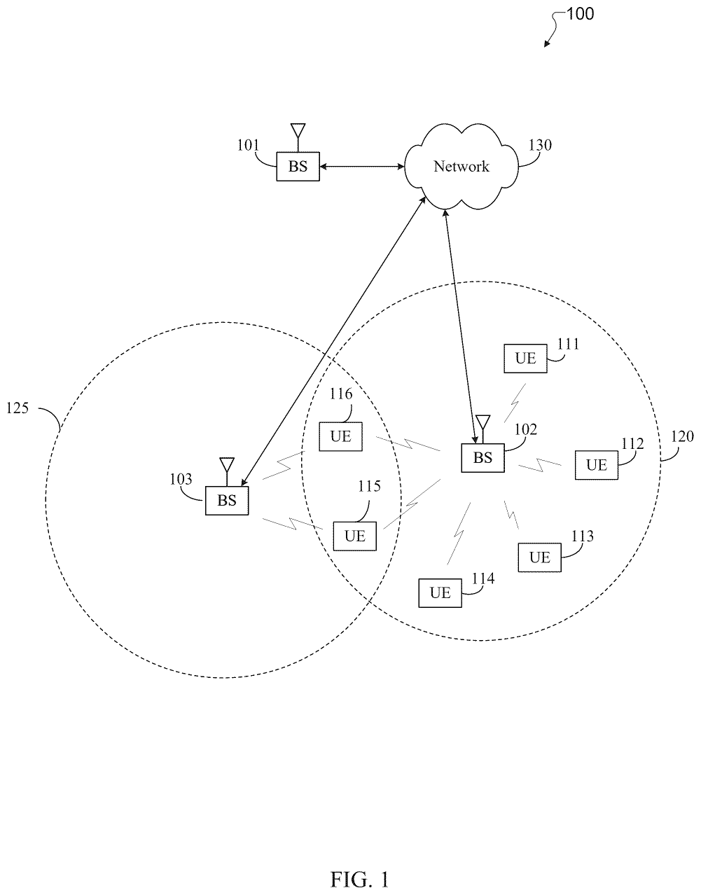

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determination of RSs for UE-initiated beam management. In certain embodiments, one or more of the BSs 101-103 include circuitry, programing, or a combination thereof to support determination of RSs for UE-initiated beam management.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

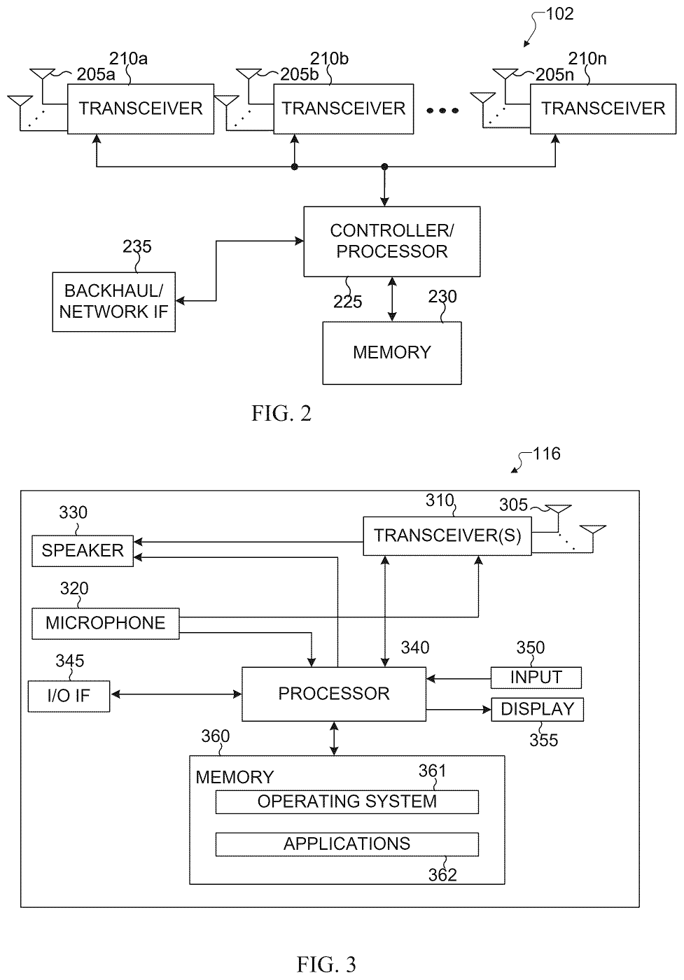

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting determination of RSs for UE-initiated beam management. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify configuration and determination of RSs for UE-initiated beam management as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

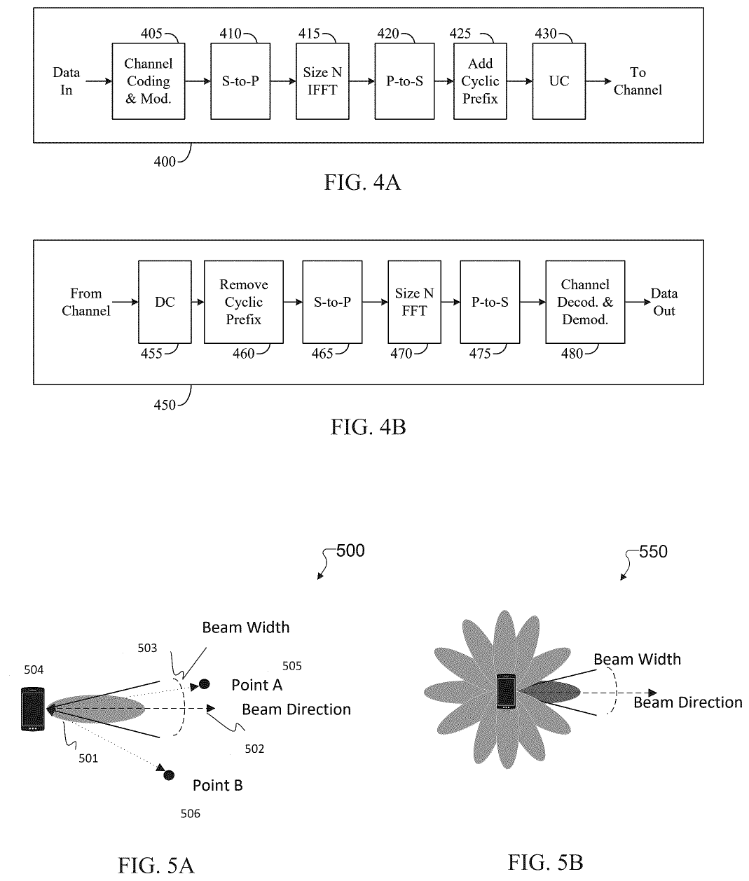

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support determination of RSs for UE-initiated beam management as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

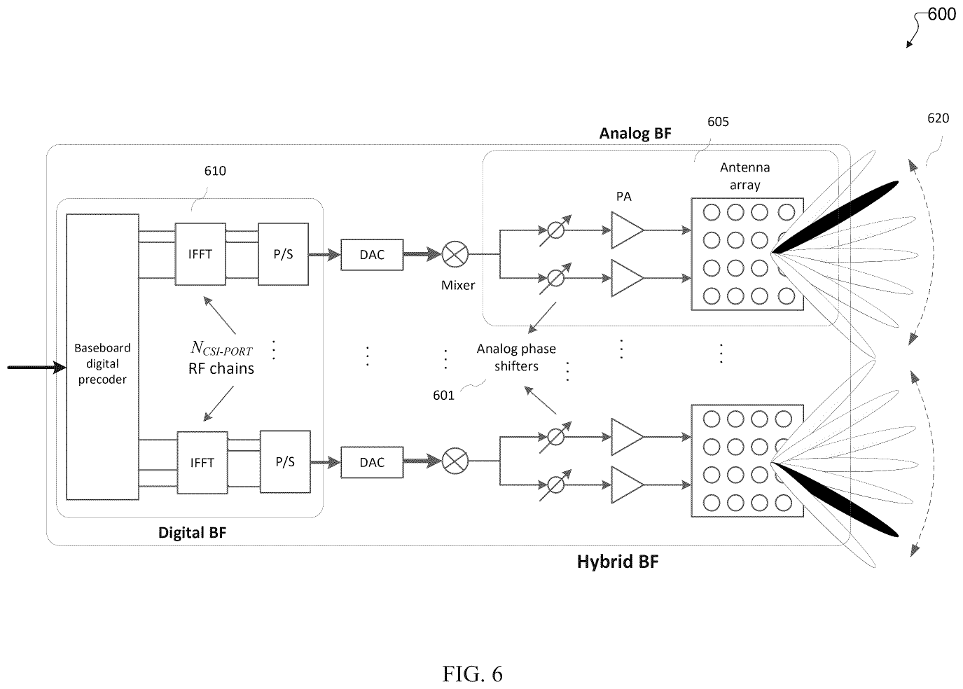

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of
A transmission configuration indication (TCI) state that establishes a quasi-colocation (QCL) relationship between a source reference signal (e.g., synchronization signal block (SSB) and/or CSI-RS) and a target reference signal.
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognizes that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated beam operations.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE (e.g., the UE 116) could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SSB resource indicator (SSBRI)) and Jᵢ is a beam metric (e.g. L1-reference signal received power (RSRP), L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration. A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g. beam-related | No |
| | | event) | |
| | (B) | No | Yes |
| | (C) | Yes (e.g. beam-related | Yes |
| | | event) | |
| 1: CSI | (A) | Yes (e.g. CSI-related | No |
| | | event) | |
| | (B) | No | Yes |
| | (C) | Yes (e.g. CSI-related | Yes |
| | | event) | |
| 2: TDCP | (A) | Yes (e.g. TDCP-related | No |
| | | event) | |
| | (B) | No | Yes |
| | (C) | Yes (e.g. TDCP-related | Yes |
| | | event) | |
| 3: non-CSI/beam/TDCP | (A) | Yes (e.g. non-CSI-related | No |
| | | event) | |
| | (B) | No | Yes |
| | (C) | Yes (e.g. non-CSI-related | Yes |
| | | event) | |
| 4. other (content-free/less | (A) | Yes (no need for content) | No |
| events) | | | |

TABLE 2
event-based UE-initiated report

| Event-type | Event |
|---|---|
| 0 | Beam-related |
| 1 | CSI-related |
| 2 | TDCP-related |
| 3 | Non- |
| | beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content-specific | No |
| | or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for anew or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (non-codebook (NCB), or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of carrier waves (CWs).
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

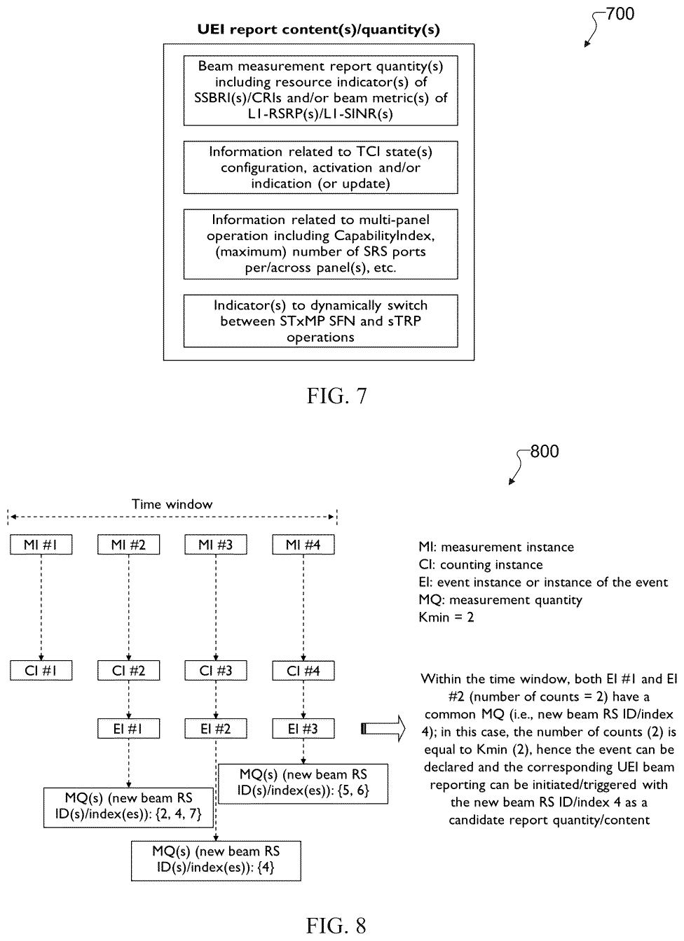

FIG. 7 illustrates a diagram of an example UE-initiated report content/quantity 700 according to embodiments of the present disclosure. For example, report content/quantity 700 can be reported by any of the UEs 111-116 of FIG. 1. This example is for illustration only and other embodiments can be used without departing from the scope of the present disclosure.

In one embodiment, a UE could send to the network one or more indicators/triggers or report quantities (e.g., in part of the content(s) in a (report-)type (B) based report or a (report-)type (C) based report) each comprising/including/containing or corresponding to one or more of the report quantities (RQs):
RQ-1: An identity (ID) of the TCI state
RQ-2: An index/ID of a higher layer RRC configured list/set/pool of TCI states that comprises/indicates/provides the TCI state
RQ-3: An index of the TCI state in a list/set/pool of TCI states higher layer RRC configured to the UE
RQ-4: An index of the TCI state in a set of TCI states activated by a (unified) TCI state(s) activation/deactivation MAC CE
RQ-5: An index/ID of a set of TCI states—e.g., among sets of TCI states activated/provided by a (unified) TCI state(s) activation/deactivation MAC CE—that comprises/indicates/provides the TCI state
RQ-6: An index of the TCI state among TCI states mapped to a TCI codepoint activated/provided by a (unified) TCI state(s) activation/deactivation MAC CE
RQ-7: A TCI codepoint activated/provided by a (unified) TCI state(s) activation/deactivation MAC CE that comprises/indicates/provides the TCI state
RQ-8: An index/ID of a TCI codepoint—e.g., among TCI codepoints activated/provided by a (unified) TCI state(s) activation/deactivation MAC CE—that comprises/indicates/provides the TCI state
RQ-9: An index of the TCI state among TCI states indicated by a TCI codepoint of a TCI field in a beam indication DCI (e.g., DCI format 1_1/1_2 with or without DL assignment)
RQ-10: An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
RQ-11: An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
RQ-12: An index/ID of a CORESET or a coresetPoolIndex/coresetGrouplndex associated to a CORESET, in which a beam indication DCI that provides/indicates the TCI state or a TCI codepoint that comprises/indicates/provides the TCI state was received
RQ-13: RS index(es)/ID(s) such as SSB index(es)/ID(s) and/or CSI-RS resource index(es)/ID(s) provided/indicated in the TCI state along with the corresponding QCL-type(s)
RQ-14: Resource indicator(s) such as SSBRI(s) and/or CRI(s) reported in one or more CSI/beam reports
RQ-15: Beam metric(s) such as L1-RSRP(s) and/or L1-SINR(s) reported in one or more CSI/beam reports
RQ-16: Index(es)/ordering(s) of resource indicator(s) such as SSBRI(s) and/or CRI(s) among resource indicators such as SSBRIs and/or CRIs reported in one or more CSI/beam reports
RQ-17: Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
RQ-18: Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
RQ-19: Index(es)/ordering(s) of beam metric(s) such as L1-RSRP(s) and/or L1-SINR(s) among beam metrics such as L1-RSRPs and/or L1-SINRs reported in one or more beam/CSI reports
RQ-20: Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
RQ-21: Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
RQ-22: Group(s)/pair(s) of resource indicators such as SSBRIs and/or CRIs reported in one or more CSI/beam reports
RQ-23: Index(es)/ordering(s) of group(s)/pair(s) of resource indicators among groups/pairs of resource indicators such as SSBRIs and/or CRIs reported in one or more CSI/beam reports
RQ-24: Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
RQ-25: Index(es)/ordering(s) of group(s)/pair(s) of resource indicators among groups/pairs of candidate resource indicators such as SSBRIs and/or CRIs—as specified herein in the present disclosure—reported in one or more CSI/beam reports
RQ-26: Group(s)/pair(s) of beam metrics such as L1-RSRPs and/or L1-SINRs reported in one or more CSI/beam reports
RQ-27: Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
RQ-28: Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
RQ-29: Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure—reported in one or more CSI/beam reports
RQ-30: A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report.

In one example, when a UE could or is able to or is configured to send to the network (e.g., the network 130) a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE (e.g., the UE 116) could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

In one embodiment, the UEI report(s)—e.g., in part of the content(s) in a (report-)type (B) based report or a (report-)type (C) based report as specified herein in the present disclosure—could comprise, include, contain one or more of the report quantities (RQs) specified/provided herein (e.g., when/if the UE that would send the UEI report(s) is configured, provided or indicated by the network, e.g., via higher layer RRC signaling(s)/parameter(s) and/or MAC CE command(s) and/or dynamic DCI based L1 signaling(s), that the multi-panel operation/scheme is enabled—for instance, the higher layer parameter multipanelScheme is set to ‘SDMscheme’ or ‘SFNscheme’, or the simultaneous (multi-panel) transmission scheme is enabled—for instance, the higher layer parameter enableSTxMP is configured/provided):
RQ-31: One or more (e.g., N≥1) groups of resource indicators including SSBRIs and/or CRIs with each group comprising one or more (e.g., M≥1) resource indicators including SSBRIs and/or CRIs, wherein N≤Nₘₐₓ and/or M≤Mₘₐₓ.
RQ-32: One or more (e.g., N≥1) groups of beam metrics including L1-RSRPs and/or L1-SINRs with each group comprising one or more (e.g., M≥1) beam metrics including L1-RSRPs and/or L1-SINRs, wherein N≤Nₘₐₓ and/or M≤Mₘₐₓ.

For the described or specified UEI report content(s)/quantity(s) herein, the UE could indicate to the network, at least in part of or by the PN message/trigger—e.g., of (report-)type (A) or (report-)type (C) as specified herein in the present disclosure, and/or the (corresponding) content(s)—e.g., of (report-)type (B) or (report-)type (C) as specified herein in the present disclosure, one or more of (each of which can also be referred to as a report quantity (RQ) throughout the present disclosure):
RQ-33: Type(s) of the reported resource indicator(s)—e.g., whether a reported resource indicator is a SSBRI or a CRI, or whether a reported group of resource indicators are SSBRIs, CRIs or a mixture of SSBRIs and CRIs.
   For example, the PN message/trigger could indicate to network whether the resource indicator(s) reported in the corresponding UEI report(s)—e.g., in part of the content(s) as specified herein in the present disclosure—could comprise only SSBRIs, only CRIs or a mixture of SSBRI(s) and CRI(s); for instance, the PN message/trigger could correspond to or comprise a one-bit indicator; when/if the one-bit indicator is set to ‘0’ (or ‘1’), the resource indicator(s) reported in the corresponding UEI report(s) could be SSBRI(s), and when/if the one-bit indicator is set to ‘1’ (or ‘0’), the resource indicator(s) reported in the corresponding UEI report(s) could be CRI(s); optionally, the PN message/trigger could correspond to or comprise a two-bit indicator; when/if the two-bit indicator is set to ‘00’ (or ‘01’, ‘10’ or ‘11’), the resource indicator(s) reported in the corresponding UEI report(s) could be SSBRI(s), when/if the two-bit indicator is set to ‘01’ (or ‘00’, ‘10’ or ‘11’), the resource indicator(s) reported in the corresponding UEI report(s) could be CRI(s), and when/if the two-bit indicator is set to ‘10’ or ‘11’ (or ‘00’ or ‘01’), the resource indicator(s) reported in the corresponding UEI report(s) could be a mixture of SSBRI(s) and CRI(s).
   For another example, the UEI report(s)—e.g., the content(s) of (report-)type (B) or (report-)type (C) as specified herein in the present disclosure—could comprise or include or contain or provide one or more indicators with each indicator corresponding/associated to one or more resource indicators or one or more groups of resource indicators in the UEI report(s) according to those specified herein in the present disclosure. For instance, the indicator(s) could be or could correspond to one-bit indicator(s); when/if a one-bit indicator is set to ‘0’ (or ‘1’), the resource indicator(s)/group(s) of resource indicators—associated/corresponding to the one-bit indicator—in the corresponding UEI report(s) could be SSBRI(s), and when/if a one-bit indicator is set to ‘1’ (or ‘0’), the resource indicator(s)/group(s) of resource indicators—associated/corresponding to the one-bit indicator—in the corresponding UEI report(s) could be CRI(s); optionally, the indicator(s) could be or could correspond to two-bit indicator(s); when/if a two-bit indicator is set to ‘00’ (or ‘01’, ‘10’ or ‘11’), the resource indicator(s)/group(s) of resource indicators—associated/corresponding to the two-bit indicator—in the corresponding UEI report(s) could be SSBRI(s), when/if a two-bit indicator is set to ‘01’ (or ‘00’, ‘10’ or ‘11’), the resource indicator(s)/group(s) of resource indicators—associated/corresponding to the two-bit indicator—in the corresponding UEI report(s) could be CRI(s), and when/if a two-bit indicator is set to ‘10’ or ‘11’ (or ‘00’ or ‘01’), the resource indicator(s)/group(s) of resource indicators—associated/corresponding to the two-bit indicator—in the corresponding UEI report(s) could be a mixture of SSBRI(s) and CRI(s).
RQ-34: Type(s) of the reported beam metric(s)—e.g., whether a reported beam metric is a L1-RSRP or a L1-SINR, or whether a reported group of beam metrics are L1-RSRPs, L1-SINRs or a mixture of L1-RSRPs and L1-SINRs.
   For example, the PN message/trigger could indicate to network whether the beam metric(s) reported in the corresponding UEI report(s)—e.g., in part of the content(s) as specified herein in the present disclosure—could comprise only L1-RSRPs, only L1-SINRs or a mixture of L1-RSRP(s) and L1-SINR(s); for instance, the PN message/trigger could correspond to or comprise a one-bit indicator; when/if the one-bit indicator is set to ‘0’ (or ‘1’), the beam metric(s) reported in the corresponding UEI report(s) could be L1-RSRP(s), and when/if the one-bit indicator is set to ‘1’ (or ‘0’), the beam metric(s) reported in the corresponding UEI report(s) could be L1-SINR(s); optionally, the PN message/trigger could correspond to or comprise a two-bit indicator; when/if the two-bit indicator is set to ‘00’ (or ‘01’, ‘10’ or ‘11’), the beam metric(s) reported in the corresponding UEI report(s) could be L1-RSRP(s), when/if the two-bit indicator is set to ‘01’ (or ‘00’, ‘10’ or ‘11’), the beam metric(s) reported in the corresponding UEI report(s) could be L1-SINR(s), and when/if the two-bit indicator is set to ‘10’ or ‘11’ (or ‘00’ or ‘01’), the beam metric(s) reported in the corresponding UEI report(s) could be a mixture of L1-RSRP(s) and L1-SINR(s).
   For another example, the UEI report(s)—e.g., the content(s) of (report-)type (B) or (report-)type (C) as specified herein in the present disclosure—could comprise or include or contain or provide one or more indicators with each indicator corresponding/associated to one or more beam metrics or one or more groups of beam metrics in the UEI report(s) according to those specified herein in the present disclosure. For instance, the indicator(s) could be or could correspond to one-bit indicator(s); when/if a one-bit indicator is set to ‘0’ (or ‘1’), the beam metric(s)/group(s) of beam metrics—associated/corresponding to the one-bit indicator—in the corresponding UEI report(s) could be L1-RSRP(s), and when/if a one-bit indicator is set to ‘1’ (or ‘0’), the beam metric(s)/group(s) of beam metrics—associated/corresponding to the one-bit indicator—in the corresponding UEI report(s) could be L1-SINR(s); optionally, the indicator(s) could be or could correspond to two-bit indicator(s); when/if a two-bit indicator is set to ‘00’ (or ‘01’, ‘10’ or ‘11’), the beam metric(s)/group(s) of beam metrics—associated/corresponding to the two—bit indicator—in the corresponding UEI report(s) could be L1-RSRP(s), when/if a two-bit indicator is set to ‘01’ (or ‘00’, ‘10’ or ‘11’), the beam metric(s)/group(s) of beam metrics—associated/corresponding to the two-bit indicator—in the corresponding UEI report(s) could be L1-SINR(s), and when/if a two-bit indicator is set to ‘10’ or ‘11’ (or ‘00’ or ‘01’), the beam metric(s)/group(s) of beam metrics—associated/corresponding to the two-bit indicator—in the corresponding UEI report(s) could be a mixture of L1-RSRP(s) and L1-SINR(s).
RQ-35: Value(s) of N, M, Nₘₐₓ and/or Mₘₐₓ as specified/defined herein in the present disclosure: for instance, the PN message/trigger—e.g., of (report-)type (A) or (report-)type (C) as specified herein in the present disclosure—could indicate value(s) of N, M, Nₘₐₓ and/or Mₘₐₓ; in one example, the PN message/trigger could indicate, provide, comprise, include or contain an index pointing to an entry of a list/set/pool of candidate values of N that are higher layer configured to the UE as the value of N; in another example, the PN message/trigger could indicate, provide, comprise, include or contain an index pointing to an entry of a list/set/pool of candidate values of M that are higher layer configured to the UE as the value of M.
RQ-36: Information related to whether a reported group of resource indicators are for simultaneous reception and/or simultaneous transmission—for simultaneous reception, the CSI-RS and/or SSB resources of each reported group could be received simultaneously by the UE (e.g., with a single spatial domain receive filter, or with multiple simultaneous spatial domain receive filters); for simultaneous transmission, the CSI-RS and/or SSB resources of each reported group could be applied for simultaneous transmission by the UE (e.g., with a single spatial domain transmit filter, or with multiple simultaneous spatial domain transmit filters).
   For example, the PN message/trigger could indicate to network whether the reported group(s) of resource indicators in the corresponding UEI report(s)—e.g., in part of the content(s) as specified herein in the present disclosure—could for simultaneous reception and/or simultaneous transmission (RQ-36a); for instance, the PN message/trigger could correspond to or comprise a one-bit indicator; when/if the one-bit indicator is set to ‘0’ (or ‘1’), the CSI-RS and/or SSB resources of each reported group in the corresponding UEI report(s) could be for simultaneous reception, and when/if the one-bit indicator is set to ‘1’ (or ‘0’), the CSI-RS and/or SSB resources of each reported group in the corresponding UEI report(s) could be for simultaneous transmission; optionally, the PN message/trigger could correspond to or comprise a two-bit indicator; when/if the two-bit indicator is set to ‘00’ (or ‘01’, ‘10’ or ‘11’), the CSI-RS and/or SSB resources of each reported group in the corresponding UEI report(s) could be for simultaneous reception, when/if the two-bit indicator is set to ‘01’ (or ‘00’, ‘10’ or ‘11’), the CSI-RS and/or SSB resources of each reported group in the corresponding UEI report(s) could be for simultaneous transmission, and when/if the two-bit indicator is set to ‘10’ or ‘11’ (or ‘00’ or ‘01’), the CSI-RS and/or SSB resources of each reported group in the corresponding UEI report(s) could be for both simultaneous reception and simultaneous transmission.
   For another example, the UEI report(s)—e.g., the content(s) of (report-)type (B) or (report-)type (C) as specified herein in the present disclosure—could comprise or include or contain or provide one or more indicators with each indicator corresponding/associated to one or more reported groups of resource indicators/beam metrics in the UEI report(s) according to those specified herein in the present disclosure (RQ-36b). For instance, the indicator(s) could be or could correspond to one-bit indicator(s); when/if a one-bit indicator is set to ‘0’ (or ‘1’), the CSI-RS and/or SSB resources of the reported group that is associated/corresponding to the one-bit indicator in the corresponding UEI report(s) could be for simultaneous reception, and when/if a one-bit indicator is set to ‘1’ (or ‘0’), the CSI-RS and/or SSB resources of the reported group that is associated/corresponding to the one-bit indicator in the corresponding UEI report(s) could be for simultaneous transmission; optionally, the indicator(s) could be or could correspond to two-bit indicator(s); when/if a two-bit indicator is set to ‘00’ (or ‘01’, ‘10’ or ‘11’), the CSI-RS and/or SSB resources of the reported group that is associated/corresponding to the two-bit indicator in the corresponding UEI report(s) could be for simultaneous reception, when/if a two-bit indicator is set to ‘01’ (or ‘00’, ‘10’ or ‘11’), the CSI-RS and/or SSB resources of the reported group that is associated/corresponding to the two-bit indicator in the corresponding UEI report(s) could be for simultaneous transmission, and when/if a two-bit indicator is set to ‘10’ or ‘11’ (or ‘00’ or ‘01’), the CSI-RS and/or SSB resources of the reported group that is associated/corresponding to the two-bit indicator in the corresponding UEI report(s) could be for both simultaneous transmission and simultaneous reception.
RQ-37: Index(es)/ID(s) of CSI resource set(s) and/or CSI resource group(s) and/or CSI resource sub-set(s) associated/specific to one or more resource indicators (and therefore, the corresponding beam metric(s)) and/or one or more groups of resource indicators (and therefore, the corresponding beam metric(s)) in the UEI report(s)
RQ-38: Information of or related to whether or not differential L1-RSRP/L1-SINR reporting is applied to the reported (group(s) of) beam metrics in the UEI report(s); if differential L1-RSRP/L1-SINR reporting is applied, step-size value(s) used for computing differential L1-RSRP/L1-SINR value(s).

Furthermore, the UEI report(s) as specified herein in the present disclosure—for instance, including the PN message/trigger—e.g., of (report-)type (A) or (report-)type (C) as specified herein in the present disclosure, and/or the (corresponding) content(s)—e.g., of (report-)type (B) or (report-)type (C) as specified herein in the present disclosure—could also comprise information related to panel status at the UE, e.g., when the UE is equipped with multiple panels—also known as multi-panel UE or multi-panel user equipment (MPUE)—and uses or activates one or more of them at a time; in particular, the information related to panel status could comprise, include, contain or provide one or more of (each of which can also be referred to as a report quantity throughout the present disclosure):
RQ-39: One or more values of CapabilityIndex (e.g., 1, 2, 3 or 4), or one or more maximum numbers of SRS ports, each associated/corresponding to one or more resource indicators/beam metrics in each reported group of resource indicators/beam metrics, and/or associated/corresponding to one or more reported groups of resource indicators/beam metrics specified/defined herein in the present disclosure
RQ-40: One or more panel IDs/indexes—e.g., {panel ID #1}, {panel ID #2}, {panel ID #1, panel ID #2}-indicating, informing or providing to the network that the corresponding panel(s) at the UE could be activated/deactivated
RQ-41: A bitmap (e.g., of length two) with each entry/bit position of the bitmap indicating ‘on’/‘off’ condition or status of a corresponding panel at the UE; when/if an entry/bit position of the bitmap is set to ‘0’ (or ‘1’), the UE could indicate, inform or provide to the network that the panel (or panel ID/index) corresponding or associated to the entry/bit position is turned off or deactivated at the UE, and/or when/if an entry/bit position of the bitmap is set to ‘1’ (or ‘0’), the UE could indicate, inform or provide to the network that the panel (or panel ID/index) corresponding or associated to the entry/bit position is turned on or activated at the UE.
RQ-42: Number of SRS ports (of a SRS resource) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for instance, for a UE equipped with a first and a second panels, the UEI report(s) could comprise a set of two values {P1, P2}, respectively indicating the numbers of SRS ports (of a SRS resource) associated/specific to the first and second panels, wherein P1+P2=P, and P could represent the corresponding maximum number of SRS ports, which could be reported as a value of CapabilityIndex as defined/specified herein in the present disclosure.
RQ-43: Number of SRS resources (e.g., 1, 2, etc.) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure
RQ-44: Number of SRS resource sets (e.g., 1, 2, etc.) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure
RQ-45: SRS resource index(es)/ID(s)—e.g., from a configured set of SRS resource index(es)/ID(s)—associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for example, the UEI report(s) could comprise a single SRS resource index/ID indicating, providing or informing to the network that the SRS resource associated/corresponding to the reported SRS resource index/ID could be used for panels at the UE; for another example, for a UE equipped with a first and a second panels, the UEI report(s) could comprise one or more first SRS resource indexes/IDs associated/specific to the first panel (and therefore, the one or more resource indicators/beam metrics in each reported group of resource indicators/beam metrics and/or the one or more reported groups of resource indicators/beam metrics associated/specific to the first panel), and/or one or more second SRS resource indexes/IDs associated/specific to the second panel (and therefore, the one or more resource indicators/beam metrics in each reported group of resource indicators/beam metrics and/or the one or more reported groups of resource indicators/beam metrics associated/specific to the second panel)
RQ-46: SRS resource set index(es)/ID(s) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for instance, when two SRS resource sets—referred to as a first SRS resource set and a second SRS resource set—are configured in srs-ResourceSetToAddModList or srs-ResourceSetToAddModListDCI-0-2 with higher layer parameter usage in SRS-ResourceSet set to ‘codebook’ or ‘nonCodebook’, the UEI report(s) could comprise a first SRS resource set index/ID for the first SRS resource set associated/specific to the first panel (and therefore, the one or more resource indicators/beam metrics in each reported group of resource indicators/beam metrics and/or the one or more reported groups of resource indicators/beam metrics associated/specific to the first panel) and/or a second SRS resource set index/ID for the second SRS resource set associated/specific to the second panel (and therefore, the one or more resource indicators/beam metrics in each reported group of resource indicators/beam metrics and/or the one or more reported groups of resource indicators/beam metrics associated/specific to the second panel)
Information related to uplink power control and/or uplink data volume at the UE, including
   RQ-47: One or more buffer sizes and/or one or more buffer size reports
   RQ-48: Information indicating whether or not maximum permissible exposure (MPE) reporting—e.g., via the UEI reporting—is enabled
   RQ-49: Information indicating whether or not the applied P-MPR value, to meet MPE requirements, is less than P-MPR_00; for instance, the information could be a one-bit indicator—when/if the one-bit indicator is set to ‘0’ (or ‘1’), the information could indicate that the applied P-MPR value, to meet MPE requirements, is less than P-MPR_00, and/or when/if the one-bit indicator is set to ‘1’ (or ‘0’), the information could indicate that the applied P-MPR value, to meet MPE requirements, is greater than (and/or equal to) P-MPR_00
   RQ-50: Applied power back-off to meet MPE requirements: when/if the MPE reporting is enabled (e.g., via network's configuration(s)/indication(s)—e.g., via higher layer RRC signaling(s)/parameter(s), and/or via UEI reporting as specified herein in the present disclosure), and/or when/if the applied P-MPR value is greater than (and/or equal to) P-MPR_00 (e.g., via network's configuration(s)/indication(s)—e.g., when/if the Pi field in a single-entry/multi-entry power headroom report (PHR) MAC CE is set to 1, and/or via the one-bit indicator in the UEI report(s)—e.g., set to ‘1’—as specified herein in the present disclosure), the UEI report(s) could comprise the applied power back-off indicating an index to Table 6.1.3.8-3 in the 3GPP TS 38.321 [REF5] and the corresponding measured values of P-MPR levels in dB are specified/provided in the 3GPP TS 38.133; furthermore, the applied power back-off could be a 2-bit value.
   RQ-51: Information indicating whether or not a power headroom (PH) value/level is reported, e.g., in the UEI report(s), for a physical cell ID (PCI) or PCI index (e.g., a serving cell PCI or PCI index, or a PCI/PCI index other than the serving cell PCI/PCI index)
   RQ-52: Information indicating whether or not the PH value/level—e.g., reported in a UEI report according to those specified herein in the present disclosure—is based on a real transmission or a reference format. The information could be a one-bit indicator; for Type 1 PH, the one-bit indicator set to 0 could indicate real transmission on PUSCH and the one-bit indicator set to 1 could indicate that a PUSCH reference format is used; for Type 2 PH, the one-bit indicator set to 0 could indicate real transmission on PUCCH and the one-bit indicator set to 1 could indicate that a PUCCH reference format is used; for Type 3 PH, the one-bit indicator set to 0 could indicate real transmission on SRS and the one-bit indicators set to 1 could indicate that an SRS reference format is used; in addition, for Type 1, Type 2, and Type 3 PH, the one-bit indicator set to 0 could indicate the presence of Pcmax and MPE reporting in the corresponding PHR MAC CE and/or UEI report(s) as specified herein in the present disclosure, and the one-bit indicator set to 1 could indicate that Pcmax and MPE reporting could be omitted in the corresponding PHR MAC CE and/or UEI report(s) as specified herein in the present disclosure.
   RQ-53: PH: the UEI report(s) could comprise or indicate the PH level, which could correspond to a 6-bit indicator; the reported PH and the corresponding power headroom levels are provided in Table 6.1.3.8-1 in the 3GPP TS 38.321 [REF5](the corresponding measured values in dB are specified in the 3GPP TS 38.133)
   RQ-54: Pcmax: the UEI report(s) could comprise or indicate the Pcmax used for calculating the preceding PH value/level; the reported Pcmax and the corresponding nominal UE (e.g., the UE 116) transmit power levels are shown in Table 6.1.3.8-2 in the 3GPP TS 38.321 [REF5](the corresponding measured values in dBm are specified in the 3GPP TS 38.133).

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
   In one example, the UE could send to the network (e.g., the network 130) a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
   In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
   In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
   In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s).
   In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In one example, the UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, whether or not differential RSRP/SINR reporting is enabled for a UEI report comprising (1), (2) and/or (3) as described herein in the present disclosure. For example, when/if a higher layer parameter diffUeiReporting is provided or configured or set to ‘enabled’, the differential L1-RSRP/L1-SINR based reporting could be enabled/used, where a reference L1-RSRP/L1-SINR value could be quantized to a 7-bit value in the range [−140, −44] dBm for differential RSRP reporting/[−23, 40] dB for differential SINR reporting with 1 dB step size for differential RSRP reporting/0.5 dB step size for differential SINR reporting, and the differential L1-RSRP/L1-SINR could be quantized to a 4-bit value. The differential L1-RSRP/L1-SINR value could be computed with 2 dB step size for differential RSRP reporting/1 dB step size for differential SINR reporting with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size.

In one example, whether or not differential RSRP/SINR reporting is enabled for a UEI report comprising (1), (2) and/or (3) as described herein in the present disclosure could depend on the number of report content(s)/quantity(s)—including resource indicator(s) such as SSBRI(s)/CRI(s) and/or beam metric(s) such as L1-RSRP(s)/LI-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s). For example, when/if the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), is greater than or equal to 1, the differential L1-RSRP/L1-SINR based reporting could be enabled/used, where a reference L1-RSRP/L1-SINR value could be quantized to a 7-bit value in the range [−140, −44] dBm with 1 dB step size, and the differential L1-RSRP/L1-SINR could be quantized to a 4-bit value. The differential L1-RSRP/L1-SINR value could be computed with 2 dB step size with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam in the same/current UEI report or a different UEI report associated/linked to the current UEI report, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size. The UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the number of report content(s)/quantity(s)—including resource indicator(s) such as SSBRI(s)/CRI(s) and/or beam metric(s) such as L1-RSRP(s)/LI-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s); alternatively, the UE could autonomous determine the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), and report their determined number(s)—e.g., by/in part of the UEI report and/or via the PN message—to the network.

In one example, for (1), i.e., when/if a UEI report could only comprise report content(s)/quantity(s) including resource indicator(s) such as SSBRI(s)/CRI(s) and beam metric(s) such as L1-RSRP(s)/L1-SINR(s) for the current serving beam(s), and/or when/if the differential RSRP/SINR based reporting is enabled/used according to those specified herein in the present disclosure, the reference L1-RSRP/L1-SINR value could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report
   where the different/previous/earlier UEI report could be the last UEI report sent prior to the current UEI report, or alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y| dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a third threshold. For instance, if a differential L1-RSRP/L1-SINR value is x dBm, and the third threshold is y dBm, the difference delta_diff=|x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE (e.g., the UE 116) could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the third (RSRP/SINR) threshold.

In another example, for (2), i.e., when/if a UEI report could only comprise report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used according to those specified herein in the present disclosure, the reference L1-RSRP/L1-SINR value could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report where the different/previous/earlier UEI report could be the last UEI report sent prior to the current UEI report, or alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′ dBm, and the second threshold is y′ dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to a A′-bit value in the range [B′, C′] dBm with D′ dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a fourth threshold. For instance, if a differential L1-RSRP/L1-SINR value is x′ dBm, and the fourth threshold is y′ dBm, the difference delta_diff′=x′−y′| dBm could be reported in the UEI report as a report content/quantity, and a corresponding one-bit sign indicator indicating either positive or negative of the difference could also be reported in the same UEI report. The value of delta_diff′ in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the fourth (RSRP/SINR) threshold.

In another example, for (3), i.e., when/if a UEI report could comprise report content(s)/quantity(s) including resource indicator(s) such as SSBRI(s)/CRI(s) and beam metric(s) such as L1-RSRP(s)/LI-SINR(s) for the current serving beam(s) and report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used, e.g., for the serving beam(s) in the current UEI report, according to those specified herein in the present disclosure, the reference L1-RSRP/L1-SINR value for the current serving beam(s) in the current UEI report could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report
the largest measured L1-RSRP/L1-SINR value of a candidate beam in the same/current UEI report
the measured L1-RSRP/L1-SINR value of the candidate beam in the same/current UEI report
   where the different/previous/earlier UEI report could be the last UEI report sent prior to the current UEI report, or alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y| dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for the current serving beam(s), if reported, and the third threshold as specified/described herein in the present disclosure. For instance, if a differential L1-RSRP/L1-SINR value computed with respect to or regarding or for a current serving beam is x dBm, and the third threshold is y dBm, the difference delta_diff=x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. In addition, when/if the differential RSRP/SINR based reporting, e.g., for the candidate beam(s) in the current UEI report, is enabled/used according to those specified herein in the present disclosure, the reference L1-RSRP/L1-SINR value for the candidate beam(s) in the current UEI report could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network (e.g., the network 130) in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report
the largest measured L1-RSRP/L1-SINR value of a serving beam in the same/current UEI report
the measured L1-RSRP/L1-SINR value of the serving beam in the same/current UEI report
   where the different/previous/earlier UEI report could be the last UEI report sent prior to the current UEI report, or alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′ dBm, and the second threshold is y′ dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for a candidate beam, if reported, and the fourth threshold. For instance, if a differential L1-RSRP/L1-SINR value computed with respect to or regarding or for a candidate beam is x′ dBm, and the fourth threshold is y′ dBm, the difference delta_diff=x′−y′| dBm could be reported in the UEI report as a report content/quantity, and a corresponding one-bit sign indicator indicating either positive or negative of the difference could also be reported in the same UEI report. The value of delta_diff in the UEI report could be quantized to a A′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling.

Throughout the present disclosure, a SSBRI or a CRI reported in a UEI report(s) as specified herein in the present disclosure could indicate or identify a candidate beam, and the SSBRI or the CRI could be signaled by the number (index) of entries in the corresponding CSI-SSB or nonzero power (NZP)-CSI-RS ResourceSets identified or provided by a higher layer parameter/signaling, e.g., denoted by uei-ResourcePool, that provides or configures RS resources including SSB and/or CSI-RS resources for the UEI reporting. For instance, the higher layer parameter/signaling uei-ResourcePool could provide, comprise, contain, include, configure or indicate a list of SSB/CSI-RS resources for UEI reporting; each resource is configured with a PCI (e.g., a serving cell PCI or a serving cell index or a PCI/PCI index other than the serving cell PCI/PCI index/index) where the resource is configured for the UE. Furthermore, the higher layer parameter/signaling uei-ResourcePool could also indicate, provide or configure to the UE the maximum number of RS resources including SSB and/or CSI-RS resources configured for the UEI reporting, time and/or frequency domain resource allocation(s)/behaviors of the RS resources including SSB and/or CSI-RS resources configured for the UEI reporting, corresponding SSB and/or CSI-RS resource set(s)—e.g., in terms of their resource set ID(s)/index(es)—configured for the UEI reporting. Examples of the corresponding/related higher layer parameters for configuring UEI measurement and/or reporting are provided in Table 6.

TABLE 6
UEI-Config information element

-- ASN1START
-- TAG-UEI-CONFIG-START

| | |
|---|---|
| UEI-Config ::= | SEQUENCE { |

...

| | | |
|---|---|---|
| uei-Reporting | SetupRelease { UEI-Resource-Report-Config } | OPTIONAL, -- Need |

M
...
}
...

| | |
|---|---|
| UEI-Resource-Report-Config ::= | SEQUENCE { |

...,

| | |
|---|---|
| uei-ResourcePool | SEQUENCE (SIZE(1..maxUEI-Resources)) OF UEI-Resource, |

...
}

| UEI-Resource ::= | SEQUENCE { | |
|---|---|---|
| uei-ResourceId | INTEGER (1..maxUEI-Resources), | |
| cell | ServCellIndex | OPTIONAL, -- Need R |

| | |
|---|---|
| uei-ReferenceSignal | CHOICE { |
| uei-csi-RS-Resource | NZP-CSI-RS-ResourceId, |
| uei-ssb-Resource | SSB-Index |

}
}

In one embodiment, when/if a UE is configured with one or two SRS resource sets in srs-ResourceSetToAddModList or srs-ResourceSetToAddModListDCI-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, (1) one or two SRIs (e.g., a first and a second SRIs), and/or one or two transmit precoding matrix indicators (TPMIs) (e.g., a first and a second TPMIs) could be indicated/given by the DCI field(s) of one or two SRS resource indicator, and/or one or two Precoding information and number of layers for DCI format 0_1 and 0_2, and/or (2) one or two SRIs (e.g., a first and a second SRIs)—e.g., selected by the UE, and/or one or two TPMIs (e.g., a first and a second TPMIs)—e.g., selected by the UE, could be provided, indicated, comprised, included or contained via/in a UEI report as specified herein in the present disclosure—or equivalently, the UE could transmit or send to the network a UEI report comprising, including, containing, providing or indicating the one or two SRIs (e.g., a first and a second SRIs)—e.g., selected by the UE, and the one or two TPMIs (e.g., a first and a second TPMIs)—e.g., selected by the UE. For this case/setting, the UEI report(s) as defined/specified herein in the present disclosure could also comprise, include, contain, provide or indicate information related to or indicating dynamic switching between STxMP SFN scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator (RQ-55).
In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’:
   When/if the two-bit indicator is set to ‘00’ or ‘01’, the second indicated/selected SRI and the second indicated/selected TPMI as defined/specified herein in the present disclosure could be reserved, and the first indicated/selected TPMI could be used to indicate the precoder to be applied over layers {0 . . . v−1}, where v≤maxRank, where maxRank is defining the maximum number of layers.
   When/if the two-bit indicator is set to ‘10’, the first indicated/selected TPMI as defined/specified herein in the present disclosure could be used to indicate the precoder to be applied over layers {0 . . . v₁−1}, where v₁ is the number of layers indicated by the first indicated/selected TPMI, that corresponds to the SRS resource selected by the corresponding SRI when multiple SRS resources are configured for the applicable SRS resource set or if single SRS resource is configured for the applicable SRS resource set, and the second indicated/selected TPMI is used to indicate the precoder to be applied over layers {v₁ . . . v₂+v₁−1}, where v2 is the number of layers indicated by the second indicated/selected TPMI, that corresponds to the SRS resource selected by the corresponding SRI when multiple SRS resources are configured for the applicable SRS resource set or if single SRS resource is configured for the applicable SRS resource set, v₁≤maxRankSdm and v₂≤maxRankSdm or maxRankSdmDCI-0-2 and maxRankSdm or maxRankSdmDCI-0-2 are defining the maximum number of layers applied over the first and the second SRS resource sets, separately.
   The two-bit indicator set to ‘11’ could be reserved.
   For one or two indicated/selected TPMIs as defined/specified herein in the present disclosure, the transmission precoder is selected from the uplink codebook that has a number of antenna ports equal to the higher layer parameter nrofSRS-Ports in SRS-Config for the indicated SRI(s). When two TPMIs are indicated/selected, the UE could expect that the precoder indicated/selected by the first indicated/selected TPMI and the precoder indicated/selected by the second indicated/selected TPMI are mapped to different PUSCH antenna ports.
   When two SRIs are indicated/selected as specified/defined herein in the present disclosure, the UE could expect that the number of SRS antenna ports associated with two indicated/selected SRIs would be the same. When the UE is configured with the higher layer parameter txConfig set to ‘codebook’, the UE is configured with at least one SRS resource. Each of the indicated/selected one or two SRIs in slot n is associated with the most recent transmission of SRS resource of associated SRS resource set identified by the SRI, where the SRS resource is prior to the physical downlink control channel (PDCCH) carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘codebook’, the UE is not expected to be configured with different number of SRS resources in the two SRS resource sets.
In another example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SFNScheme’:
   When/if the two-bit indicator is set to ‘00’ or ‘01’, the second indicated/selected SRI and the second indicated/selected TPMI as defined/specified herein in the present disclosure are reserved, the first indicated/selected TPMI is used to indicate precoder to be applied over layers {0 . . . v−1}, where v≤maxRank and where maxRank is defining the maximum number of layers applied over the first SRS resource set or the second SRS resource set.
   For one or two indicated/selected TPMIs, the transmission precoder is selected from the uplink codebook that has a number of antenna ports equal to nrofSRS-Ports in SRS-Config for the indicated SRI(s), as defined in Clause 6.3.1.5 of the 3GPP TS 38.211 [REF1]. When two TPMIs are indicated/selected, the UE could expect that the precoder indicated/selected by the first indicated/selected TPMI and the precoder indicated/selected by the second indicated/selected TPMI are mapped to different PUSCH antenna ports.
   When/if the two-bit indicator is set to ‘10’, the first indicated/selected TPMI is used to indicate precoder to be applied over layers {0 . . . v−1} and the second indicated/selected TPMI is used to indicate the precoder to be applied over layers {0 . . . v−1}, where v≤maxRankSfn or maxRankSfnDCI-0-2 and maxRankSfn or maxRankSfnDCI-0-2 defining the maximum number of layers applied over the first SRS resource set and over the second SRS resource set separately.
   The two-bit indicator set to ‘11’ could be reserved.
   When two TPMIs are indicated/selected, the UE could expect that the number of SRS antenna ports associated with two indicated/selected SRIs to be the same. When the UE is configured with the higher layer parameter txConfig set to ‘codebook’, the UE is configured with at least one SRS resource. Each of the indicated/selected one or two SRIs in slot n is associated with the most recent transmission of SRS resource of associated SRS resource set identified by the SRI, where the SRS resource is prior to the PDCCH carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘codebook’, the UE is not expected to be configured with different number of SRS resources in the two SRS resource sets.

In one embodiment, when/if a UE is configured with one or two SRS resource sets in srs-ResourceSetToAddModList or srs-ResourceSetToAddModListDCI-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, (1) one or two SRIs (e.g., a first and a second SRIs) could be indicated/given by the DCI field(s) of one or two SRS resource indicator for DCI format 0_1 and 0_2, and/or (2) one or two SRIs (e.g., a first and a second SRIs)—e.g., selected by the UE—could be provided, indicated, comprised, included or contained via/in a UEI report as specified herein in the present disclosure—or equivalently, the UE could transmit or send to the network a UEI report comprising, including, containing, providing or indicating the one or two SRIs (e.g., a first and a second SRIs)—e.g., selected by the UE. For this case/setting, the UEI report(s) as defined/specified herein in the present disclosure could also comprise, include, contain, provide or indicate information related to or indicating dynamic switching between STxMP SFN scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator (RQ-56).
In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’:
   When/if the two-bit indicator is set to ‘00’ or ‘01’, the second indicated/selected SRI is reserved, the first indicated/selected SRI is used to indicate resource(s) to be associated with layers {0 . . . v−1}, v≤Lₘₐₓ.
   When/if the two-bit indicator is set to ‘10’, the first indicated/selected SRI is used to indicate resource(s) to be associated with layer(s) {0 . . . v₁−1}}, where v₁ being the number of layers indicated by the first indicated/selected SRI, and the second indicated/selected SRI is used to indicate resource(s) to be associated with layer(s) {v₁ . . . v₂+v₁−1}, v₁≤Lₘₐₓ and v₂≤Lₘₐₓ where Lₘₐₓ is defined in clauses 7.3.1.1.2 and 7.3.1.1.3 of the 3GPP TS 38.212 [REF2]. The UE (e.g., the UE 116) could expect that SRS resource(s) indicated/selected by the first indicated/selected SRI and SRS resource(s) indicated/selected by the second indicated/selected SRI are corresponding to different PUSCH antenna ports.
In another example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SFNScheme’:
   When/if the two-bit indicator is set to ‘10’, the first indicated/selected SRI is used to indicate resource(s) to be associated with layer(s) {0 . . . v−1} and the second indicated/selected SRI is used to indicate resource(s) to be associated with layer(s) {0 . . . v−1}, where v≤Lₘₐₓ and where Lₘₐₓ is defined in clauses 7.3.1.1.2 and 7.3.1.1.3 of the 3GPP TS 38.212 [REF2]. The UE could expect that SRS resource(s) indicated/selected by the first indicated/selected SRI and SRS resource(s) indicated/selected by the second indicated/selected SRI are corresponding to different PUSCH antenna ports.
   When/if the two-bit indicator is set to ‘00’ or ‘01’, the second indicated/selected SRI is reserved, the first indicated/selected SRI is used to indicate resources(s) to be associated with layers {0 . . . v−1}, where v≤Lₘₐₓ. When two SRIs are indicated/selected, the UE could expect that the number of SRS antenna ports associated with two indicated/selected SRIs to be the same.
   The two-bit indicator set to ‘11’ could be reserved.
   When the UE is configured with the higher layer parameter txConfig set to ‘Noncodebook’, the UE is configured with at least one SRS resource. Each of the indicated/selected one or two SRI(s) in slot n is associated with the most recent transmission of SRS resource of associated SRS resource set identified by the SRI, where the SRS resource is prior to the PDCCH carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘Noncodebook’, the UE is not expected to be configured with different number of SRS resources in the two SRS resource sets.

In one embodiment, when/if a UE is configured with one or two SRS resource sets in srs-ResourceSetToAddModList or srs-ResourceSetToAddModListDCl-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, the UEI report(s) as defined/specified herein in the present disclosure could also comprise, include, contain, provide or indicate information related to or indicating dynamic switching between STxMP SFN scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator. In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’, and/or when/if the UE is scheduled with Qₚ{1,2} phase tracking reference signal (PT-RS) port(s) in uplink and the number of scheduled layers is n_{layer}^{PUSCH}, and/or when/if two SRS resource sets are used/applied, e.g., configured in srs-ResourceSetToAddModList or srs-ResourceSetToAddModListDCl-0-2 with higher layer parameter usage in SRS-ResourceSet set to ‘codebook’/‘nonCodebook’, and/or when/if the two-bit indicator in the UEI report(s) is set to ‘10’, α_{PTS}^{PUSCH} for each PT-RS port is based on Table 6.2.3.1-3B in the 3GPP TS 38.214 [REF4], where Qₚ is the total number of PT-RS ports for the PUSCH.

A UE could be configured, indicated or provided by the network, e.g., via higher layer RRC signaling(s)/parameter(s) and/or MAC CE command(s) and/or dynamic DCI based L1 signaling(s)—e.g., based on or according to a corresponding UE's capability or capability signaling, to report, in a UEI report, one or more of candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a subset {RQ-39, . . . RQ-54}, of the candidate report quantities as specified or defined herein in the present disclosure). For instance, the UE could be provided by the network reportQuantity or ueiReportQuantity in CSI-ReportConfig set to one or more of the report quantities as specified herein in the present disclosure. In FIG. 7, examples of the UEI report content(s)/quantity(s) are provided.

Optionally, the UE could autonomously determine which one or more of candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a subset {RQ-39, . . . , RQ-54}, of the candidate report quantities as specified or defined herein in the present disclosure) to report as content(s) of one or more UEI reports according to those specified herein in the present disclosure—e.g., of (report-)type (B) or (report-)type (C) as specified herein in the present disclosure. Furthermore, the UE could indicate or inform or provide to the network, e.g., via a PN message/trigger or an indicator or a UCI (including hybrid automatic repeat request acknowledgement (HARQ-ACK), scheduling request (SR), CSI and etc.), their autonomously determined report quantity(s) such as a full-set or one or more sub-sets of the candidate report quantities as defined or specified herein in the present disclosure.
In one example, the PN message/trigger could be or could correspond to/comprise a one-bit/multi-bit indicator or a multi-level indicator or a multi-state indicator, e.g., a L-bit indicator (L≥1) having 2^{L} states, with each bit/level/state of the PN message/trigger or the indicator associated/specific to one or more candidate report quantities (or a separate/different sub-set of the candidate report quantities) according to those specified or defined herein in the present disclosure. In particular, the association(s)/mapping(s) between each of the bits/levels/states of the PN message/trigger or the indicator(s) and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if the PN message/trigger or the one-bit/multi-bit indicator or the multi-level indicator or the multi-state indicator is set to a particular bit/level/state value, the UE could indicate or inform or provide to the network that the one or more candidate report quantities associated/specific to the bit/level/state value of the PN message/trigger or the one-bit/multi-bit indicator or the multi-level indicator or the multi-state indicator could be in/as the content(s) of the UEI report(s).
   For example, the PN message/trigger could be or could correspond to/comprise a one-bit indicator (i.e., L=1). When/if the one-bit indicator is set to ‘0’ (or ‘1’), the UEI report content(s) could comprise a full-set of the candidate report quantities, e.g., {RQ-1, RQ-2, . . . , RQ-56}, according to those defined/specified herein in the present disclosure; and/or when/if the one-bit indicator is set to ‘1’ (or ‘0’), the UEI report content(s) could comprise a sub-set of the candidate report quantities, e.g., {RQ-39, . . . , RQ-54}, according to those defined/specified herein in the present disclosure.
   For another example, the PN message/trigger could be or could correspond to/comprise a one-bit indicator (i.e., L=1). When/if the one-bit indicator is set to ‘0’ (or ‘1’), the UEI report content(s) could comprise a first sub-set of the candidate report quantities, e.g., {RQ-31, . . . , RQ-38}, according to those defined/specified herein in the present disclosure; and/or when/if the one-bit indicator is set to ‘1’ (or ‘0’), the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network (e.g., the network 130) via various UL channels/signals.
   For another example, the PN message/trigger could be or could correspond to/comprise a two-bit indicator (i.e., L=2). When/if the two-bit indicator is set to ‘00’ (or ‘01’ or ‘10’ or ‘11’), the UEI report content(s) could comprise a first sub-set of the candidate report quantities, e.g., {RQ-1, . . . , RQ-30}, according to those defined/specified herein in the present disclosure; when/if the two-bit indicator is set to ‘01’ (or ‘00’ or ‘10’ or ‘11’), the UEI report content(s) could comprise a second sub-set of the candidate report quantities, e.g., {RQ-31, . . . , RQ-38}, according to those defined/specified herein in the present disclosure; when/if the two-bit indicator is set to ‘10’ (or ‘00’ or ‘01’ or ‘11’), the UEI report content(s) could comprise a third sub-set of the candidate report quantities, e.g., {RQ-39, . . . , RQ-54}, according to those defined/specified herein in the present disclosure; and/or when/if the two-bit indicator is set to ‘11’ (or ‘00’ or ‘01’ or ‘10’), the UEI report content(s) could comprise a fourth sub-set of the candidate report quantities, e.g., {RQ-55, RQ-56}, according to those defined/specified herein in the present disclosure. The UE could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a multi-bit indicator (i.e., L≥1) having 2^{L} states with each state of the multi-bit indicator corresponding/associated to one or more candidate RQs, e.g., belonging to {RQ-1, . . . , RQ-56}, following those specified or defined herein in the present disclosure. When/if the multi-bit indicator is set to a particular state, the UEI report content(s) could comprise the one or more candidate RQs associated/specific to the state of the multi-bit indicator. The UE could determine or identify the association(s)/mapping(s) between the states of the multi-bit indicator and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the PN message/trigger could provide, indicate, contain, include or comprise one or more (R≥1) or more than one (R>1) the one-bit/multi-bit indicators or multi-level indicators or multi-state indicators as defined/specified herein in the present disclosure to indicate, inform or provide to the network which one or more of the candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a sub-set {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the PN message/trigger could be or could correspond to/comprise a bitmap, e.g., of length L (L≥1), with each entry/bit position of the PN message/trigger or the bitmap associated/specific to one or more candidate report quantities (or a separate/different sub-set of the candidate report quantities) according to those specified or defined herein in the present disclosure. In particular, the association(s)/mapping(s) between each of entries/bit positions of the PN message/trigger or the bitmap and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if an entry/bit position of the PN message/trigger or the bitmap is set to ‘1’ (or ‘0’), the UE could indicate or inform or provide to the network that the one or more candidate report quantities associated/specific to the entry/bit position of the PN message/trigger or the bitmap could be in/as the content(s) of the UEI report(s).
   For example, the PN message/trigger could be or could correspond to/comprise a bitmap of length 2 (i.e., L=2). When/if the first entry/bit position of the bitmap is set to ‘1’ (or ‘0’), the UEI report content(s) could comprise a full-set of the candidate report quantities, e.g., {RQ-1, RQ-2, . . . , RQ-56}, according to those defined/specified herein in the present disclosure; and/or when/if the second entry/bit position of the bitmap is set to ‘1’ (or ‘0’), the UEI report content(s) could comprise a sub-set of the candidate report quantities, e.g., {RQ-39, . . . , RQ-54}, according to those defined/specified herein in the present disclosure.
   For another example, the PN message/trigger could be or could correspond to/comprise a bitmap of length 2 (i.e., L=2). When/if the first entry/bit position of the bitmap is set to ‘1’ (or ‘0’), the UEI report content(s) could comprise a first sub-set of the candidate report quantities, e.g., {RQ-31, . . . , RQ-38}, according to those defined/specified herein in the present disclosure; and/or when/if the second entry/bit position of the bitmap is set to ‘1’ (or ‘0’), the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a bitmap of length 4 (i.e., L=4). When/if the first entry/bit position of the bitmap is set to ‘1’ (or ‘0’), the UEI report content(s) could comprise a first sub-set of the candidate report quantities, e.g., {RQ-1, . . . , RQ-30}, according to those defined/specified herein in the present disclosure; when/if the second entry/bit position of the bitmap is set to ‘1’ (or ‘0’), the UEI report content(s) could comprise a second sub-set of the candidate report quantities, e.g., {RQ-31, . . . , RQ-38}, according to those defined/specified herein in the present disclosure; when/if the third entry/bit position of the bitmap is set to ‘1’ (or ‘0’), the UEI report content(s) could comprise a third sub-set of the candidate report quantities, e.g., {RQ-39, . . . , RQ-54}, according to those defined/specified herein in the present disclosure; and/or when/if the fourth entry/bit position of the bitmap is set to ‘1’ (or ‘0’), the UEI report content(s) could comprise a fourth sub-set of the candidate report quantities, e.g., {RQ-55, RQ-56}, according to those defined/specified herein in the present disclosure. The UE could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a bitmap of length L with L≥1; each entry/bit position of the bitmap could correspond to or could be associated to one or more candidate RQs, e.g., belonging to {RQ-1, . . . , RQ-56}, following those specified or defined herein in the present disclosure. When/if an entry/bit position of the bitmap is set to ‘1’ (or ‘0’), the UEI report content(s) could comprise the one or more candidate RQs associated/specific to the entry/bit position of the bitmap. The UE could determine or identify the association(s)/mapping(s) between the entries/bit positions of the bitmap and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the PN message/trigger could provide, indicate, contain, include or comprise one or more (R≥1) or more than one (R>1) the bitmaps as defined/specified herein in the present disclosure to indicate, inform or provide to the network which one or more of the candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the UE could be provided/configured/indicated by the network, e.g., via higher layer RRC signaling(s)/parameter(s) and/or MAC CE command(s) and/or dynamic DCI based L1 signaling(s), one or more (e.g., L≥1) PN configurations (e.g., each denoted/provided by a higher layer RRC configuration/parameter PN-Config) for transmitting PN message(s)/trigger(s) and/or the corresponding content(s)/RQ(s). For this case/design example, each of the PN configurations (e.g., the higher layer configuration/parameter PN-Config) could provide one or more of:
   Resource allocation(s)—e.g., of UL channel(s)/signal(s) including PUCCH, PUSCH, PRACH and/or etc.—for transmitting PN message(s)/trigger(s) and/or the corresponding content(s)/RQ(s). For example, when/if PUCCH is used (or configured to be used or indicated to be used) for transmitting/sending the PN message(s)/trigger(s) and/or the corresponding content(s)/RQ(s), the UE could be provided/indicated/provided by the network, e.g., via higher layer RRC signaling(s)/parameter(s) and/or MAC CE command(s) and/or dynamic DCI based L1 signaling(s), a list of PUCCH resources to use for reporting the UEI report(s) on PUCCH; for this case/design example, the list of PUCCH resources to use for the UEI reporting could be provided by pucch-UEI-ResourceList in, e.g., PN-Config. For another example, when/if PUSCH is used (or configured to be used or indicated to be used) for transmitting/sending the PN message(s)/trigger(s) and/or the corresponding content(s)/RQ(s), the UE could be provided/indicated/provided by the network, e.g., via higher layer RRC signaling(s)/parameter(s) and/or MAC CE command(s) and/or dynamic DCI based L1 signaling(s), a list of PUSCH resources to use for reporting the UEI report(s) on PUSCH; for this case/design example, the list of PUSCH resources to use for the UEI reporting could be provided by pusch-UEI-ResourceList, ConfiguredGrantConfig, ueiConfiguredGrantConfig and/or etc. in, e.g., PN-Config.
   Time and/or frequency domain behaviors for transmitting PN message(s)/trigger(s) and/or the corresponding content(s)/RQ(s) including “periodic”, “semi-persistent”, “aperiodic” and/or etc. for the corresponding UL channels/signals or signaling mediums including PUCCH, PUSCH and/or etc.
   Measurement RS resources (including SSB resource(s), CSI-RS resource(s) and/or etc.) used for UEI measurements; for instance, the UE could be provided/indicated/provided by the network, e.g., via higher layer RRC signaling(s)/parameter(s) and/or MAC CE command(s) and/or dynamic DCI based L1 signaling(s), a list of channel measurement RS resources to use for the UEI measurements; for this case/design example, the list of channel measurement RS resources and their associated/corresponding resource setting(s) could be provided by UEI-CSI-ResourceConfig in, e.g., PN-Config.
   CSI report setting(s)/configuration(s) used for UEI reporting; for instance, the UE could be provided/indicated/provided by the network, e.g., via higher layer RRC signaling(s)/parameter(s) and/or MAC CE command(s) and/or dynamic DCI based L1 signaling(s), one or more CSI report settings/configurations to use for the UEI reporting; for this case/design example, each of the one or more CSI report settings/configurations could be provided by UEI-CSI-ReportConfig in, e.g., PN-Config.

Each of the L (L≥1) PN configurations could be associated/specific to one or more candidate report quantities (or a separate/different sub-set of the candidate report quantities) according to those specified or defined herein in the present disclosure. In particular, the association(s)/mapping(s) between each of the PN configurations and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if the PN message/trigger of a specific PN configuration is transmitted/sent, the UE could indicate or inform or provide to the network that the one or more candidate report quantities associated/specific to the PN configuration (and therefore, the transmitted/sent PN message/trigger) could be in/as the content(s) of the UEI report(s).
For example, the UE could be provided/configured/indicated by the network, e.g., via higher layer RRC signaling(s)/parameter(s) and/or MAC CE command(s) and/or dynamic DCI based L1 signaling(s), a first and a second PN configurations (e.g., each denoted/provided by a higher layer RRC configuration/parameter PN-Config) for transmitting the PN message(s)/trigger(s) and/or the corresponding content(s)/RQ(s) (i.e., L=2). When/if a PN message/trigger of the first PN configuration is transmitted/sent, the UEI report content(s) could comprise a full-set of the candidate report quantities, e.g., {RQ-1, RQ-2, . . . , RQ-56}, according to those defined/specified herein in the present disclosure; and/or when/if the a PN message/trigger of the second PN configuration is transmitted/sent, the UEI report content(s) could comprise a sub-set of the candidate report quantities, e.g., {RQ-39, . . . , RQ-54}, according to those defined/specified herein in the present disclosure.
For another example, the UE could be provided/configured/indicated by the network, e.g., via higher layer RRC signaling(s)/parameter(s) and/or MAC CE command(s) and/or dynamic DCI based L1 signaling(s), a first and a second PN configurations (e.g., each denoted/provided by a higher layer RRC configuration/parameter PN-Config) for transmitting the PN message(s)/trigger(s) and/or the corresponding content(s)/RQ(s) (i.e., L=2). When/if a PN message/trigger of the first PN configuration is transmitted/sent, the UEI report content(s) could comprise a first sub-set of the candidate report quantities, e.g., {RQ-31, . . . , RQ-38}, according to those defined/specified herein in the present disclosure; and/or when/if a PN message/trigger of the second PN configuration is transmitted/sent, the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
For another example, the UE could be provided/configured/indicated by the network, e.g., via higher layer RRC signaling(s)/parameter(s) and/or MAC CE command(s) and/or dynamic DCI based L1 signaling(s), a first, a second, a third, and a fourth PN configurations (e.g., each denoted/provided by a higher layer RRC configuration/parameter PN-Config) for transmitting the PN message(s)/trigger(s) and/or the corresponding content(s)/RQ(s) (i.e., L=4). When/if a PN message/trigger of the first PN configuration is transmitted/sent, the UEI report content(s) could comprise a first sub-set of the candidate report quantities, e.g., {RQ-1, . . . , RQ-30}, according to those defined/specified herein in the present disclosure; when/if a PN message/trigger of the second PN configuration is transmitted/sent, the UEI report content(s) could comprise a second sub-set of the candidate report quantities, e.g., {RQ-31, . . . , RQ-38}, according to those defined/specified herein in the present disclosure; when/if a PN message/trigger of the third PN configuration is transmitted/sent, the UEI report content(s) could comprise a third sub-set of the candidate report quantities, e.g., {RQ-39, . . . , RQ-54}, according to those defined/specified herein in the present disclosure; and/or when/if a PN message/trigger of the fourth PN configuration is transmitted/sent, the UEI report content(s) could comprise a fourth sub-set of the candidate report quantities, e.g., {RQ-55, RQ-56}, according to those defined/specified herein in the present disclosure. The UE (e.g., the UE 116) could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
For another example, the UE could be provided/configured/indicated by the network, e.g., via higher layer RRC signaling(s)/parameter(s) and/or MAC CE command(s) and/or dynamic DCI based L1 signaling(s), one or more (e.g., L 1) PN configurations (e.g., each denoted/provided by a higher layer RRC configuration/parameter PN-Config) for transmitting PN message(s)/trigger(s) and/or the corresponding content(s)/RQ(s). When/if a PN message/trigger of a particular PN configuration is transmitted/sent, the UEI report content(s) could comprise the one or more candidate RQs associated/specific to the PN configuration (and therefore, the transmitted/sent PN message/trigger). The UE could determine or identify the association(s)/mapping(s) between the PN configurations and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the UE could transmit/send one or more or more than one PN messages/triggers, e.g., in one or more or in a single or separate (UEI) report(s), of one or more (R≥1) or more than one (R>1) the PN configurations as defined/specified herein in the present disclosure to indicate, inform or provide to the network which one or more of the candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the PN message/trigger could be or could correspond to/comprise one or more, e.g., L (L≥1), indexes, e.g., belonging to {0, 1, . . . , L−1} or {1, 2, . . . , L}, each associated/specific to one or more candidate report quantities (or a separate/different sub-set of the candidate report quantities) or pointing/corresponding to one or more entries (and therefore, the corresponding candidate report quantities) of a list/set/pool of candidate report quantities according to those specified or defined herein in the present disclosure. When/if the PN message/trigger indicates, provides or comprises one or more indexes (e.g., an index l∈{0, 1, . . . , L−1} or {1, 2, . . . , L}), the UE could indicate or inform or provide to the network that the one or more entries, and therefore, the corresponding one or more candidate report quantities (e.g., the l-th candidate report quantity or the l-th sub-set of the candidate report quantities) in the lists/set/pool of candidate report quantities associated/specific to the one or more indexes could be in/as the content(s) of the UEI report(s). The UE could determine or identify the L 1 sub-set(s) of the candidate report quantities (e.g., in/from the list/set/pool of candidate report quantities) and/or their association(s)/mapping(s) to the index(es) indicated/comprised by/in the PN message(s)/trigger(s) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For example, when/if the PN message/trigger indicates, provides or comprises an index of value 0 (or 1), the UEI report content(s) could comprise a full-set of the candidate report quantities, e.g., {RQ-1, RQ-2, . . . , RQ-56}, according to those defined/specified herein in the present disclosure; and/or when/if the PN message/trigger indicates, provides or comprises an index of value 1 (or 2), the UEI report content(s) could comprise a sub-set of the candidate report quantities, e.g., {RQ-39, . . . , RQ-54}, according to those defined/specified herein in the present disclosure.
   For another example, when/if the PN message/trigger indicates, provides or comprises an index of value 0 (or 1), the UEI report content(s) could comprise the candidate report quantity(s) or the sub-set of the candidate report quantities, e.g., {RQ-31, . . . , RQ-38}, corresponding to the first entry(s) of/in a list/set/pool of candidate report quantities according to those defined/specified herein in the present disclosure; and/or when/if the PN message/trigger indicates, provides or comprises an index of value 1 (or 2), the UEI report content(s) could comprise the candidate report quantity(s) or the sub-set of the candidate report quantities, e.g., {RQ-39, . . . , RQ-54}, corresponding to the second entry(s) of/in the list/set/pool of candidate report quantities according to those defined/specified herein in the present disclosure. The UE could determine or identify the first and/or the second entry(s) of/in the list/set/pool of candidate report quantities (and therefore, the corresponding candidate report quantity(s)/subset(s) of the candidate report quantities) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, when/if the PN message/trigger indicates, provides or comprises an index of value 0 (or 1), the UEI report content(s) could comprise the candidate report quantity(s) or the sub-set of the candidate report quantities, e.g., {RQ-1, . . . , RQ-30}, corresponding to the first entry(s) of/in a list/set/pool of candidate report quantities according to those defined/specified herein in the present disclosure; when/if the PN message/trigger indicates, provides or comprises an index of value 1 (or 2), the UEI report content(s) could comprise the candidate report quantity(s) or the sub-set of the candidate report quantities, e.g., {RQ-31, . . . , RQ-38}, corresponding to the second entry(s) of/in the list/set/pool of candidate report quantities according to those defined/specified herein in the present disclosure; when/if the PN message/trigger indicates, provides or comprises an index of value 2 (or 3), the UEI report content(s) could comprise the candidate report quantity(s) or the sub-set of the candidate report quantities, e.g., {RQ-39, . . . , RQ-54}, corresponding to the third entry(s) of/in the list/set/pool of candidate report quantities according to those defined/specified herein in the present disclosure; and/or when/if the PN message/trigger indicates, provides or comprises an index of value 3 (or 4), the UEI report content(s) could comprise the candidate report quantity(s) or the sub-set of the candidate report quantities, e.g., {RQ-55, RQ-56}, corresponding to the fourth entry(s) of/in the list/set/pool of candidate report quantities according to those defined/specified herein in the present disclosure. The UE could determine or identify the first and/or the second and/or the third and/or the fourth entry(s) of/in the list/set/pool of candidate report quantities (and therefore, the corresponding candidate report quantity(s)/subset(s) of the candidate report quantities) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network (e.g., the network 130) via various UL channels/signals.
   For another example, when/if the PN message/trigger indicates, provides or comprises an index of value l, wherein l∈{0, 1, . . . , L−1} or {1, 2, . . . , L}), the UEI report content(s) could comprise the candidate report quantity(s) or the sub-set of the candidate report quantities, e.g., {RQ-1, . . . , RQ-30}, corresponding to the l-th entry(s) of/in a list/set/pool of candidate report quantities according to those defined/specified herein in the present disclosure. The UE could determine or identify the association(s)/mapping(s) between the index(es) indicated/comprised by/in the PN message(s)/trigger(s) and the entry(s) of/in the list/set/pool of candidate RQs (and therefore, the corresponding RQs or sub-set(s) of RQs) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the UE could transmit/send one or more (R≥1) or more than one (R>1) PN messages/triggers, e.g., in one or more or in a single or separate (UEI) report(s), as defined/specified herein in the present disclosure to indicate, inform or provide to the network which one or more of the candidate report quantities, e.g., {RQ-1, RQ-2, . . . , RQ-56}, as specified or defined herein in the present disclosure (or a full-set, e.g., {RQ-1, RQ-2, . . . , RQ-56}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

The (set/list/pool of) candidate report quantities as defined/specified herein in the present disclosure could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. For instance, the UE could be configured or provided by the network, e.g., via/in a higher layer RRC configuration/parameter CSI-ReportConfig, one or more (or a set/list/pool of) candidate report quantities (e.g., denoted by candidateReportQuantityList), wherein the one or more (or the set/list/pool of) configured candidate report quantities could be a full-set or a sub-set of the report quantities, e.g., {RQ-1, RQ-2, . . . , RQ-56}, specified/defined herein in the present disclosure for the UEI reporting.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 configured grant (CG) PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
   In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

In one embodiment, the resource indicator(s) including SSBRI(s) and/or CRI(s) for the current serving beam(s) and the resource indicator(s) including SSBRI(s) and/or CRI(s) for the candidate beam(s), reported in the same UEI report or in different/separate UEI reports, could be determined/selected from the same RS resource set (e.g., the same SSB resource set or the same NZP CSI-RS resource set). Alternatively, the resource indicator(s) including SSBRI(s) and/or CRI(s) for the current serving beam(s) could be determined/selected from a first RS resource set (e.g., a first SSB resource set or a first NZP CSI-RS resource set) configured for reporting the serving beam(s), and the resource indicator(s) including SSBRI(s) and/or CRI(s) for the candidate beam(s), could be determined/selected from a second RS resource set (e.g., a second SSB resource set or a second NZP CSI-RS resource set) configured for reporting the candidate beam(s), wherein the resource indicators for the serving beam(s) and the candidate beam(s) could be reported in the same UEI report or in different/separate UEI reports, and the first and second RS resource sets could be the same/identical or different. If the first and second RS resource sets are different, (1) in one example, the bitwidth of the RS indexes in the first RS resource set is computed with respect to the total number K of RS resources configured in the first set, i.e., log2(K) or floor(log2(K)) or ceil(log2(K)) bit(s), and the bitwidth of the RS indexes in the second RS resource set is computed with respect to the total number L of RS resources configured in the second set, i.e., log2(L) or floor(log2(L)) or ceil(log2(L)) bit(s), and/or (2) in another example, the bitwidth of the RS indexes in the first RS resource set is computed with respect to the total number (K+L) of RS resources configured in both the first and second sets, i.e., log2(K+L) or floor(log2(K+L)) or ceil(log2(K+L)) bit(s), and the bitwidth of the RS indexes in the second RS resource set is computed with respect to the total number (K+L) of RS resources configured in both the first and second sets, i.e., log2(K+L) or floor(log2(K+L)) or ceil(log2(K+L)) bit(s).

All the design examples and procedures specified herein in the present disclosure could be conducted/performed under the condition that the UE-initiated reporting or the UE-initiated beam management is enabled—e.g., via network's configuration(s)/indication(s) through higher layer RRC signaling(s)/parameter(s) and/or MAC CE command(s) and/or dynamic DCI based L1 signaling(s) based on or according to a corresponding UE's capability or capability signaling(s).

In one embodiment, a UE could be provided, for each bandwidth part (BWP) of a serving cell, a serving beam(s) set s̅₀ of (periodic) CSI-RS resource configuration indexes and/or synchronization signal/physical broadcast channel (SS/PBCH) block indexes by currentServBeamRSList for monitoring/assessing the radio link and/or beam qualities for the current serving beam(s) according to those specified herein in the present disclosure. The serving beam(s) set s̅₀ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure. Furthermore, the UE could be provided/indicated/configured by the network, e.g., via higher layer RRC signaling(s)/parameter(s) and/or MAC CE command(s) and/or dynamic DCI based L1 signaling(s), which one or more of the RS resources in the serving beam(s) set s̅₀—i.e., a subset of the RS resources provided in the serving beam(s) set s̅0—the UE could measure for the UEI reporting.
In one example, the UE could (or could be configured to) measure the RS resources provided/indicated/configured in the serving beam(s) set s̅₀ for the UEI beam reporting according to those specified herein in the present disclosure.
In another example, the UE could measure the first (or last) S≥1 RS resource(s) or transmission occasion(s) TO(s) among the RS resource(s)/TO(s) provided in the serving beam(s) set go. The value of S could be provided/indicated/configured to the UE, e.g., via higher layer RRC signaling(s)/parameter(s) and/or MAC CE command(s) and/or dynamic DCI based L1 signaling(s) based on or according to a corresponding UE's capability or capability signaling. Optionally, the value of S could be fixed in system specification(s).
In another example, the UE could be provided/indicated/configured by the network, e.g., via higher layer RRC signaling(s)/parameter(s) and/or MAC CE command(s) and/or dynamic DCI based L1 signaling(s), RS resource index(es) of the subset of the RS resource(s)—from/among the RS resources or RS resource indexes in the serving beam(s) set s̅₀—the UE could measure for the UEI reporting.
In another example, the UE could be provided/indicated/configured by the network, e.g., via higher layer RRC signaling(s)/parameter(s) and/or MAC CE command(s) and/or dynamic DCI based L1 signaling(s), a bitmap with each bit position/entry of the bitmap corresponding/associated to a RS/RS resource provided/configured in the serving beam(s) set go. For instance, the bitmap could be provided/configured in the same higher layer parameter(s)/signaling(s) that provides/configures the serving beam(s) set s̅₀. When/if an entry/bit position of the bitmap is set to ‘1’ (or ‘0’), the RS or RS resource or RS resource index in the serving beam(s) set s̅₀ corresponding/associated to the entry/bit position could be used for measurement for the UEI reporting.
In another example, each of the RSs, RS resources or RS resource indexes in the serving beam(s) set s̅₀ could be associated with a one-bit indicator, wherein the one-bit indicator(s) could be provided/configured in the same higher layer parameter(s)/signaling(s) that provides/configures the serving beam(s) set s̅₀. When/if a one-bit indicator is set to ‘1’ (or ‘0’), the RS or RS resource or RS resource index in the serving beam(s) set s̅₀ corresponding/associate to the one-bit indicator could be used for measurement for the UEI reporting.

In addition, the serving beam(s) set s̅₀ could be periodic, semi-persistent and/or aperiodic. For semi-persistent or aperiodic, the serving beam(s) set s̅₀ (and therefore, the corresponding RS resource indexes provided therein) could be activated or triggered via DCI (e.g., via the ‘CSI request’ field and associated to the corresponding CSI triggering state(s) and/or CSI resource setting(s) and/or CSI reporting setting(s)) after/upon (e.g., after a time window/periodic, e.g., corresponding to a fixed value in system specifications and/or configured/provided by the network) reception or detection of the PN message (or UEI report(s)) transmitted or sent from/by the UE. That is, in this case, transmission of the PN message (or the corresponding UEI report(s)) also activates or triggers the semi-persistent or aperiodic transmission(s) of the serving beam(s) set s̅₀.
In one example, after a certain time period or when a timer has expired, the semi-statically activated or aperiodically triggered measurement RSs in the serving beam(s) set s̅₀ could be deactivated or no longer used for measurement for the UEI reporting. In this case, the UE could be provided/indicated/configured by the network, e.g., via higher layer RRC signaling(s)/parameter(s) and/or MAC CE command(s) and/or dynamic DCI based L1 signaling(s) based on or according to a UE's capability or capability signaling, the time period and/or the timer.
In another example, the UE could indicate to the network (e.g., send a PN message, a UEI report(s), a SR or a SR-like signal) to deactivate or turn off the transmission(s) of the semi-statically activated or aperiodically triggered measurement RSs in the serving beam(s) set s̅₀.

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s).

For the set s̅₀, the UE could assess the radio link or beam qualities only according to SS/PBCH blocks on the primary cell (PCell) or the primary secondary cell (PSCell) or (periodic) CSI-RS resource configurations that are quasi co-located with the RS index(es) in the RS set(s) in one or more indicated TCI states under the unified TCI framework as specified herein in the present disclosure and/or DM-RS(s) of the PDCCH/PDSCH reception(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signaling(s)/parameter(s) and/or MAC CE command(s) and/or dynamic DCI based L1 signaling(s) according to or based on a corresponding UE's capability or capability signaling. Optionally, the UE could receive from the network a MAC CE to update one or more of the RS resource indexes in the serving beam(s) set s̅₀, and/or to update the RS resource indexes in the serving beam(s) set s̅₀, and/or to indicate one or more RS resource indexes, e.g., from a higher layer configured set of RS resource indexes (denoted by currentServSet), for measurement for the UEI reporting. For example, the MAC CE could correspond to UEI-RS Indication MAC CE is identified by a MAC subheader with eLCID. It could have a variable size, and includes a number of RS ID fields, e.g., a UEI-RS-ID₀ field and a UEI-RS-ID₁ field (optional) of currentServSet. It has a variable size including the following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in the 3GPP TS 38.213 [REF3]. The length of the BWP ID field is 2 bits;
S: This field indicates the presence of the octet containing the UEI-RS ID₁ of the same serving beam(s) RS set s̅₀. The S field set to 1 indicates that the octet containing UEI-RS ID₁ is included. The S field set to 0 indicates that the octet containing the UEI-RS ID₁ of the same serving beam(s) RS set s̅₀ is not included;
UEI-RS ID₁: This field indicates the RS resource from currentServSet as specified herein in the present disclosure;
R: Reserved bit, set to 0.

If the UE (e.g., the UE 116) is not provided so by currentServBeamRSList for a BWP of the serving cell and/or the UEI-RS Indication MAC CE as specified herein in the present disclosure, the UE could determine the serving beam(s) set s̅₀ to include periodic CSI-RS resource configuration indexes and/or SSB indexes with same values as the RS indexes in the RS sets indicated by the one or more TCI states under the unified TCI framework and/or DM-RS(s) of the PDCCH/PDSCH reception(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signaling(s)/parameter(s) and/or MAC CE command(s) and/or dynamic DCI based L1 signaling(s) according to or based on a corresponding UE's capability or capability signaling.

The UE could expect the serving beam(s) set s̅₀ to include up to a number of N_{UEI} RS indexes indicated by maxUEI-RS-resourcesPerSetPerBWP. The UE could expect single port RS in the serving beam(s) set s̅₀. Optionally, the UE could expect single-port or two-port CSI-RS with frequency density equal to 1 or 3 REs per resource block (RB) in the serving beam(s) set s̅₀. The physical layer in the UE could assess the radio link or beam quality according to the set s̅₀ of resource configurations against a threshold Q_{out,serv}, wherein the value of the threshold Q_{out,serv} could be provided/indicated/configured to the UE by the network, e.g., via higher layer RRC signaling(s)/parameter(s) and/or MAC CE command(s) and/or dynamic DCI based L1 signaling(s). The UE could apply the Q_{out,serv} threshold to the RSRP/SINR measurement, e.g., the L1-RSRP/L1-SINR measurement, obtained from a SS/PBCH block, and the UE could apply the Q_{out,serv} threshold to the RSRP/SINR measurement, e.g., the L1-RSRP/L1-SINR measurement, obtained for a CSI-RS resource after scaling a respective CSI-RS reception power with a value provided by powerControlOffsetSS. In non-discontinuous reception (DRX) mode operation, the physical layer in the UE could provide an indication to higher layers when the radio link or beam quality(s) for corresponding resource configurations in the serving beam(s) set s̅₀ that the UE uses to assess the radio link or beam quality(s) is worse than the threshold Q_{out,serv}. The physical layer informs the higher layers when the radio link or beam quality(s) is worse than the threshold Q_{out,serv} with a periodicity determined by the maximum between the shortest periodicity among the SS/PBCH blocks on the PCell or the PSCell and/or the periodic CSI-RS configurations in the set s̅₀ that the UE uses to assess the radio link or beam quality(s) and 2 msec. In DRX mode operation, the physical layer provides an indication to higher layers when the radio link or beam quality(s) is worse than the threshold Q_{out,serv} with a predetermined periodicity. For a PCell or a PSCell or a SCell, upon request from higher layers, the UE could provide to higher layers the periodic CSI-RS configuration indexes and/or SS/PBCH block indexes from the set s̅₀ and the corresponding RSRP/SINR measurements, e.g., L1-RSRP/L1-SINR measurements, that are less than or equal to the Q_{out,serv} threshold. Optionally, for the PCell or the PSCell or the SCell, upon request from higher layers, the UE could indicate to higher layers whether there is at least one periodic CSI-RS configuration index or SS/PBCH block index from the set s̅₀ with corresponding RSRP/SINR measurements, e.g., the L1-RSRP/L1-SINR measurements, that is less than or equal to the Q_{out,serv} threshold, and provide the periodic CSI-RS configuration indexes and/or SS/PBCH block indexes from the set s̅₀ and the corresponding RSRP/SINR measurements including L1-RSRP/L1-SINR measurements that are less than or equal to the Q_{out,serv} threshold, if any. The information herein could also be sent or transmitted from the UE to the network (e.g., the network 130) in part of the UEI report(s)—e.g., as the UEI report content(s) or report quantity(s) as specified herein in the present disclosure, wherein the UEI report(s) could be sent via UCI or MAC CE over PUCCH and/or PUSCH and/or PRACH resource(s).

The corresponding MAC entity could or shall for each Serving Cell configured for UEI reporting according to those specified herein in the present disclosure (set A of conditions):
1>:
   2> if serving beam degradation instance indication has been received from lower layers:
      3> start or restart the servBeamDegradationDetectionTimer;
      3> increment serv_COUNTER by 1;
      3> if serv_COUNTER>=servBeamDegradationInstanceMaxCount:
         4> if the Serving Cell is SCell:
         5> trigger a UEI (beam) reporting for this Serving Cell;
         4> else if the Serving Cell is PSCell and, the secondary cell group (SCG) is deactivated:
         5> if serving beam degradation of the PSCell has not been indicated to upper layers since the SCG was deactivated or since the deactivated SCG was last reconfigured with UEI-RS:
         6> indicate serving beam(s) degradation of the PSCell to upper layers.
NOTE: After serving beam(s) degradation is indicated to upper layers, the UE may stop the servBeamDegradationDetectionTimer and lower layer serving beam(s) degradation indication while serv_COUNTER>=servBeamDegradationInstanceMaxCount for the deactivated SCG.
   4> else:
      5> initiate a Random Access procedure on the SpCell.
   2> if the servBeamDegradationDetectionTimer expires; or
   2> if servBeamDegradationDetectionTimer, servBeamDegradationInstanceMaxCount, or any of the reference signals used for UEI reporting is reconfigured by upper layers associated with this Serving Cell; or
   2> if the reference signal(s) associated with this Serving Cell used for serving beam(s) degradation detection is changed:
      3> set serv_COUNTER to 0.
   2> if the Serving Cell is SpCell and the Random Access procedure initiated for SpCell UEI reporting is successfully completed:
      3> set serv_COUNTER to 0;
      3> stop the ueiReportingTimer, if configured;
      3> regard the UE-initiated (UEI) reporting procedure successfully completed.
   2> else if the Serving Cell is SCell, and a PDCCH addressed to cell-radio network temporary identifier (C-RNTI) indicating uplink grant for a new transmission is received for the HARQ process used for the transmission of the MAC CE for UEI reporting which contains report content(s)/quantity(s) of this Serving Cell; or
   2> if the SCell is deactivated:
      3> set serv_COUNTER to 0;
      3> regard the UEI reporting procedure successfully completed and cancel the triggered UEI report(s) for this Serving Cell.

In the present disclosure, the serving beam(s) set s̅₀ could also correspond to a CSI resource set (including SSB resource set or NZP CSI-RS resource set provided in/associated to higher layer parameter(s) CSI-ReportConfig, CSI-ResourceConfig, nzp-CSI-RS-ResourceSet, CSI-SSB-ResourceSet, CSI-AssociatedReportConfigInfo and/or etc.) configured/provided/activated/triggered for (typical) CSI/beam reporting; optionally, one or more of the RS source indexes in the serving beam(s) set s̅₀ could correspond to one or more RS resource indexes in a CSI resource set (including SSB resource set or NZP CSI-RS resource set provided in/associated to higher layer parameter(s) CSI-ReportConfig, CSI-ResourceConfig, nzp-CSI-RS-ResourceSet, CSI-SSB-ResourceSet, CSI-AssociatedReportConfiglnfo and/or etc.) configured/provided/activated/triggered for (typical) CSI/beam reporting. For example, the (typical) CSI resource set could correspond to a bidirectional forwarding detection (BFD) RS resource set or a candidate RS resource set configured/determined in beam failure recovery procedure(s).

In one embodiment, a UE could be provided, for each BWP of a serving cell, a candidate beam(s) set s̅₁ of (periodic) CSI-RS resource configuration indexes and/or SS/PBCH block indexes by candidateBeamRSList for monitoring/assessing the radio link and/or beam qualities for one or more candidate beams according to those specified herein in the present disclosure. The candidate beam(s) set s̅₁ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure. Furthermore, the UE could be provided/indicated/configured by the network, e.g., via higher layer RRC signaling(s)/parameter(s) and/or MAC CE command(s) and/or dynamic DCI based L1 signaling(s), which one or more of the RS resources in the candidate beam(s) set s̅₁—i.e., a subset of the RS resources provided in the candidate beam(s) set s̅₁—the UE could measure for the UEI reporting.
In one example, the UE could (or could be configured to) measure the RS resources provided/indicated/configured in the candidate beam(s) set s̅₁ for the UEI beam reporting according to those specified herein in the present disclosure.
In another example, the UE could measure the first (or last) S≥1 RS resource(s) or transmission occasion(s) TO(s) among the RS resource(s)/TO(s) provided in the candidate beam(s) set s̅₁. The value of S could be provided/indicated/configured to the UE, e.g., via higher layer RRC signaling(s)/parameter(s) and/or MAC CE command(s) and/or dynamic DCI based L1 signaling(s) based on or according to a corresponding UE's capability or capability signaling. Optionally, the value of S could be fixed in system specification(s).
In another example, the UE could be provided/indicated/configured by the network, e.g., via higher layer RRC signaling(s)/parameter(s) and/or MAC CE command(s) and/or dynamic DCI based L1 signaling(s), RS resource index(es) of the subset of the RS resource(s)—from/among the RS resources or RS resource indexes in the candidate beam(s) set s̅₁—the UE could measure for the UEI reporting.
In another example, the UE could be provided/indicated/configured by the network, e.g., via higher layer RRC signaling(s)/parameter(s) and/or MAC CE command(s) and/or dynamic DCI based L1 signaling(s), a bitmap with each bit position/entry of the bitmap corresponding/associated to a RS/RS resource provided/configured in the candidate beam(s) set s̅₁. For instance, the bitmap could be provided/configured in the same higher layer parameter(s)/signaling(s) that provides/configures the candidate beam(s) set s̅₁. When/if an entry/bit position of the bitmap is set to ‘1’ (or ‘0’), the RS or RS resource or RS resource index in the candidate beam(s) set s̅₁ corresponding/associated to the entry/bit position could be used for measurement for the UEI reporting.
In another example, each of the RSs, RS resources or RS resource indexes in the candidate beam(s) set s̅₁ could be associated with a one-bit indicator, wherein the one-bit indicator(s) could be provided/configured in the same higher layer parameter(s)/signaling(s) that provides/configures the candidate beam(s) set s̅₁. When/if a one-bit indicator is set to ‘1’ (or ‘0’), the RS or RS resource or RS resource index in the candidate beam(s) set s̅₁ corresponding/associate to the one-bit indicator could be used for measurement for the UEI reporting.

In addition, the candidate beam(s) set s̅₁ could be periodic, semi-persistent and/or aperiodic. For semi-persistent or aperiodic, the candidate beam(s) set s̅₁ (and therefore, the corresponding RS resource indexes provided therein) could be activated or triggered via DCI (e.g., via the ‘CSI request’ field and associated to the corresponding CSI triggering state(s) and/or CSI resource setting(s) and/or CSI reporting setting(s)) after/upon (e.g., after a time window/periodic, e.g., corresponding to a fixed value in system specifications and/or configured/provided by the network) reception or detection of the PN message (or UEI report(s)) transmitted or sent from/by the UE. That is, in this case, transmission of the PN message (or the corresponding UEI report(s)) also activates or triggers the semi-persistent or aperiodic transmission(s) of the candidate beam(s) set s.
In one example, after a certain time period or when a timer has expired, the semi-statically activated or aperiodically triggered measurement RSs in the candidate beam(s) set s̅₁ could be deactivated or no longer used for measurement for the UEI reporting. In this case, the UE could be provided/indicated/configured by the network, e.g., via higher layer RRC signaling(s)/parameter(s) and/or MAC CE command(s) and/or dynamic DCI based L1 signaling(s) based on or according to a UE's capability or capability signaling, the time period and/or the timer.
In another example, the UE could indicate to the network (e.g., send a PN message, a UEI report(s), a SR or a SR-like signal) to deactivate or turn off the transmission(s) of the semi-statically activated or aperiodically triggered measurement RSs in the candidate beam(s) set s̅₁.

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s).

For the set s̅₁, the UE could assess the radio link or beam qualities only according to SS/PBCH blocks on the PCell or the PSCell or (periodic) CSI-RS resource configurations that are quasi co-located with the RS index(es) in the RS set(s) in one or more indicated TCI states under the unified TCI framework as specified herein in the present disclosure and/or DM-RS(s) of the PDCCH/PDSCH reception(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signaling(s)/parameter(s) and/or MAC CE command(s) and/or dynamic DCI based L1 signaling(s) according to or based on a corresponding UE's capability or capability signaling. Optionally, the UE could receive from the network a MAC CE to update one or more of the RS resource indexes in the candidate beam(s) set s̅₁, and/or to update the RS resource indexes in the candidate beam(s) set s̅₁, and/or to indicate one or more RS resource indexes, e.g., from a higher layer configured set of RS resource indexes (denoted by candidateRSsSet), for measurement for the UEI reporting. For example, the MAC CE could correspond to cand-RS Indication MAC CE is identified by a MAC subheader with eLCID. It could have a variable size, and includes a number of RS ID fields, e.g., a cand-RS-ID₀ field and a cand-RS-ID₁ field (optional) of candidateRSsSet. It has a variable size including the following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in the 3GPP TS 38.213 [REF3]. The length of the BWP ID field is 2 bits;
S: This field indicates the presence of the octet containing the cand-RS ID₁ of the same candidate beam(s) RS set s̅₁. The S field set to 1 indicates that the octet containing cand-RS ID₁ is included. The S field set to 0 indicates that the octet containing the cand-RS ID₁ of the same candidate beam(s) RS set s̅₁ is not included;
cand-RS ID₁: This field indicates the RS resource from candidateRSsSet as specified herein in the present disclosure;
R: Reserved bit, set to 0.

If the UE is not provided s̅₁ by candidateBeamRSList for a BWP of the serving cell and/or the cand-RS Indication MAC CE as specified herein in the present disclosure, the UE could determine the candidate beam(s) set s̅₁ to include periodic CSI-RS resource configuration indexes and/or SSB indexes with same values as the RS indexes in the RS sets indicated by the one or more TCI states under the unified TCI framework and/or DM-RS(s) of the PDCCH/PDSCH reception(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signaling(s)/parameter(s) and/or MAC CE command(s) and/or dynamic DCI based L1 signaling(s) according to or based on a corresponding UE's capability or capability signaling.

The UE could expect the candidate beam(s) set s̅₁ to include up to a number of Ncand RS indexes indicated by maxCand-RS-resourcesPerSetPerBWP. The UE could expect single port RS in the candidate beam(s) set s̅₁. Optionally, the UE could expect single-port or two-port CSI-RS with frequency density equal to 1 or 3 REs per RB in the candidate beam(s) set s̅₁. The physical layer in the UE could assess the radio link or beam quality according to the set s̅₁ of resource configurations against a threshold Q_{in,cand}, wherein the value of the threshold Q_{in,cand} could be provided/indicated/configured to the UE by the network, e.g., via higher layer RRC signaling(s)/parameter(s) and/or MAC CE command(s) and/or dynamic DCI based L1 signaling(s). The UE could apply the Q_{in,cand} threshold to the RSRP/SINR measurement, e.g., the L1-RSRP/L1-SINR measurement, obtained from a SS/PBCH block, and the UE could apply the Q_{in,cand} threshold to the RSRP/SINR measurement, e.g., the L1-RSRP/L1-SINR measurement, obtained for a CSI-RS resource after scaling a respective CSI-RS reception power with a value provided by powerControlOffsetSS. In non-DRX mode operation, the physical layer in the UE could provide an indication to higher layers when the radio link or beam quality(s) for corresponding resource configurations in the candidate beam(s) set s̅₁ that the UE uses to assess the radio link or beam quality(s) is larger than or equal to the threshold Q_{in,cand}. The physical layer informs the higher layers when the radio link or beam quality(s) is larger than or equal to the threshold Q_{in,cand} with a periodicity determined by the maximum between the shortest periodicity among the SS/PBCH blocks on the PCell or the PSCell and/or the periodic CSI-RS configurations in the set s̅₁ that the UE uses to assess the radio link or beam quality(s) and 2 msec. In DRX mode operation, the physical layer provides an indication to higher layers when the radio link or beam quality(s) is larger than or equal to the threshold Q_{in,cana} with a predetermined periodicity. For a PCell or a PSCell or a SCell, upon request from higher layers, the UE could provide to higher layers the periodic CSI-RS configuration indexes and/or SS/PBCH block indexes from the set s̅₁ and the corresponding RSRP/SINRmeasurements, e.g., L1-RSRP/L1-SINRmeasurements, that are larger than or equal to the Q_{in,cand} threshold. Optionally, for the PCell or the PSCell or the SCell, upon request from higher layers, the UE could indicate to higher layers whether there is at least one periodic CSI-RS configuration index or SS/PBCH block index from the set s̅₁ with corresponding RSRP/SINR measurements, e.g., the L1-RSRP/L1-SINR measurements, that is larger than or equal to the Q_{in,cand} threshold, and provide the periodic CSI-RS configuration indexes and/or SS/PBCH block indexes from the set s̅₁ and the corresponding RSRP/SINR measurements including L1-RSRP/L1-SINR measurements that are larger than or equal to the Q_{in,cand} threshold, if any. The information herein could also be sent or transmitted from the UE to the network in part of the UEI report(s)—e.g., as the UEI report content(s) or report quantity(s) as specified herein in the present disclosure, wherein the UEI report(s) could be sent via UCI or MAC CE over PUCCH and/or PUSCH and/or PRACH resource(s).

The corresponding MAC entity could or shall for each Serving Cell configured for UEI reporting according to those specified herein in the present disclosure (set B of conditions):
1>:
   2> if candidate beam(s) identification instance indication has been received from lower layers:
      3> start or restart the candBeamDetectionTimer;
      3> increment cand COUNTER by 1;
      3> if cand COUNTER>=candBeamIdentificationInstanceMaxCount:
         4> if the Serving Cell is SCell:
         5> trigger a UEI (beam) reporting for this Serving Cell;
         4> else if the Serving Cell is PSCell and, the SCG is deactivated:
         5> if candidate beam(s) identification of the PSCell has not been indicated to upper layers since the SCG was deactivated or since the deactivated SCG was last reconfigured with cand-RS:
         6> indicate candidate beam(s) identification of the PSCell to upper layers.
NOTE: After candidate beam(s) identification is indicated to upper layers, the UE may stop the candBeamDetectionTimer and lower layer candidate beam(s) identification indication while cand COUNTER>=candBeamIdentificationInstanceMaxCount for the deactivated SCG.
   4> else:
      5> initiate a Random Access procedure on the SpCell.
2> if the candBeamDetectionTimer expires; or
2> if candBeamDetectionTimer, candBeamIdentificationInstanceMaxCount, or any of the reference signals used for UEI reporting is reconfigured by upper layers associated with this Serving Cell; or
2> if the reference signal(s) associated with this Serving Cell used for candidate beam(s) identification is changed:
   3> set cand COUNTER to 0.
   2> if the Serving Cell is SpCell and the Random Access procedure initiated for SpCell UEI reporting is successfully completed:
      3> set cand COUNTER to 0;
      3> stop the ueiReportingTimer, if configured;
      3> regard the UE-initiated (UEI) reporting procedure successfully completed.
   2> else if the Serving Cell is SCell, and a PDCCH addressed to C-RNTI indicating uplink grant for a new transmission is received for the HARQ process used for the transmission of the MAC CE for UEI reporting which contains report content(s)/quantity(s) of this Serving Cell; or
   2> if the SCell is deactivated:
      3> set cand COUNTER to 0;
      3> regard the UEI reporting procedure successfully completed and cancel the triggered UEI report(s) for this Serving Cell.

In the present disclosure, triggering of the UEI reporting could depend on one or more conditions in the set A of conditions and/or set B of conditions as specified/described herein in the present disclosure.

As specified herein in the present disclosure, the UEI report(s) could also comprise one or more indicators to indicate presence/absence of current serving beam(s) as specified/defined herein in the present disclosure in the UEI report(s). In one example, the indicator(s) could be one-bit indicator(s), and when/if the one-bit indicator(s) is set to ‘1’ (‘0’), report content(s)/quantity(s) such as resource indicator(s) and/or corresponding beam metric(s) for the current serving beam(s) could be present in the UEI report(s); otherwise, i.e., when/if the one-bit indicator(s) is set to ‘0’ (or ‘1’), report content(s)/quantity(s) such as resource indicator(s) and/or corresponding beam metric(s) for the current serving beam(s) could be absent from the UEI report(s). As specified herein in the present disclosure, the UEI report(s) could also comprise one or more indicators to indicate presence/absence of candidate beam(s) as specified/defined herein in the present disclosure in the UEI report(s). In one example, the indicator(s) could be one-bit indicator(s), and when/if the one-bit indicator(s) is set to ‘1’ (‘0’), report content(s)/quantity(s) such as resource indicator(s) and/or corresponding beam metric(s) for the identified candidate beam(s) could be present in the UEI report(s); otherwise, i.e., when/if the one-bit indicator(s) is set to ‘0’ (or ‘1’), report content(s)/quantity(s) such as resource indicator(s) and/or corresponding beam metric(s) for the identified candidate beam(s) could be absent from the UEI report(s).

In one example, the UEI report(s) as specified herein in the present disclosure could comprise one or more set indexes, wherein set index 0 (or 1) could correspond to the serving beam(s) set s̅₀ (or the candidate beam(s) set s̅₁), and set index 1 (or 2) could correspond to the candidate beam(s) set s̅₁ (or the serving beam(s) set s̅₀).
In one example, the UEI report(s) as specified herein in the present disclosure could comprise a set index, wherein the set index could correspond to the serving beam(s) set s̅₀ or the candidate beam(s) set s̅₁, from which the reference RSRP/SINR value or the largest measured RSRP/SINR value as specified herein in the present disclosure is determined/selected.
In another example, when/if both the serving beam(s) set s̅₀ and the candidate beam(s) set s̅₁ are configured, provided or determined, each of the report contents/report quantities in the UEI report(s) could be associated/corresponding to a set index provided/indicated in the same UEI report(s). As specified/described herein in the present disclosure, each reported set index could indicate the serving beam(s) set s̅₀ or the candidate beam(s) set s̅₁ from which the associated/corresponding report content(s)/quantity(s) including resource indicator(s) and their associated/corresponding beam metric(s) are determined or selected.

According to those specified herein in the present disclosure, the one or more indicated TCI states (and therefore, the corresponding RS resource indexes in the RS resource sets indicated/provided therein) used for determining the RS resource indexes in the serving beam(s) set s̅₀ and/or the candidate beam(s) set s̅₁ could correspond to:
The applied unified joint/DL/UL TCI state(s)—e.g., indicated by the TCI codepoint of the TCI field in the beam indication DCI format 1_1/1_2 with or without DL assignment—for various DL and/or UL channels and/or signals according to those specified herein in the present disclosure
The TCI state(s) activated in/by (unified) TCI state(s) activation/deactivation MAC CE command
The TCI state(s) higher layer configured/provided by the network, e.g., by jointDLTCIState-List and/or TCI-UL-StateList
One or more TCI states or TCI state IDs, e.g., among the higher layer configured list(s) of TCI state(s) and/or the TCI state(s) activated in the (unified) TCI state(s) activation/deactivation MAC CE command, provided/configured/indicated by the network, e.g., via higher layer RRC signaling(s)/parameter(s) and/or MAC CE command(s) and/or dynamic DCI based L1 signaling(s)

As specified herein in the present disclosure, a UE (e.g., the UE 116) could be respectively configured/provided by the network (e.g., the network 130), or could (or could be configured to) respectively determine the two sets—serving beam(s) set s̅₀ and/or the candidate beam(s) set s̅₁. Alternatively, a UE could be configured/provided by the network, or could (or could be configured to) determine a single RS set comprising RS resource index(es) for serving beam(s) and/or candidate beam(s) according to those specified herein in the present disclosure. Whether two sets of serving beam(s) set and candidate beam(s) set or a single set of serving beam(s) and/or candidate beam(s) RS resources could be applied/used for the UEI measurement and reporting could be provided/configured/indicated by the network, e.g., via higher layer RRC signaling(s)/parameter(s) and/or MAC CE command(s) and/or dynamic DCI based L1 signaling(s) according to or based on a corresponding UE's capability or capability signaling.

For a first event (denoted by Event-1), wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-la for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams
Component-1f: indicator(s) or bitmap(s) indicating the one or more second current serving beams—e.g., out of the current serving beams or out of the first current serving beam(s)
Component-1g: a number of the one or more first current serving beams in the UEI report(s)
Component-1h: a number of the one or more second current serving beams in the UEI report(s)
Component-1i: indicator(s) indicating occurrence of the first event and/or an event index/ID associated/specific/corresponding to the first event
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-1c in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-1d in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Ns>1. In another example, Ns≥1. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the first event or the Event-1 as described/specified herein could be denoted by or referred to as a first LTM event or a LTM Event-1. For the first LTM event or the LTM Event-1, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a second event (denoted by Event-2), wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)—throughout the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams
Component-2f: indicator(s) or bitmap(s) indicating the one or more second candidate beams—e.g., out of the candidate beams or out of the first candidate beam(s)
Component-2g: a number of the one or more first candidate beams in the UEI report(s)
Component-2h: a number of the one or more second candidate beams in the UEI report(s)
Component-2i: indicator(s) indicating occurrence of the second event and/or an event index/ID associated/specific/corresponding to the second event
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y|dBm could be reported in the UEI report as a report content/quantity, and a corresponding one-bit sign indicator indicating either positive or negative of the difference could also be reported in the same UEI report. Or the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-21: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc≥1. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the second event or the Event-2 as described/specified herein could be denoted by or referred to as a second LTM event or a LTM Event-2. For the second LTM event or the LTM Event-2, the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a third event (denoted by Event-3), wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the third event or the Event-3 as described/specified herein could be denoted by or referred to as a third LTM event or a LTM Event-3. For the third LTM event or the LTM Event-3, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), and the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For a fourth event (denoted by Event-4), wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE (e.g., the UE 116) uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C) specified/defined or obtained in Component-4e and if the threshold-C is z dBm, a second difference delta_diff_C′=delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams
Component-4h: indicator(s) or bitmap(s) indicating the one or more first candidate beams—e.g., out of the candidate beams.
Component-4i: a number of the one or more first current serving beams in the UEI report(s)
Component-4j: a number of the one or more first candidate beams in the UEI report(s)
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-41 for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=x2−x1| dBm could be reported in the UEI report as a report content/quantity, and a corresponding one-bit sign indicator indicating either positive or negative of the first difference could also be reported in the same UEI report. Or the first difference delta_diff_C=(x1—x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C) specified/defined or obtained in Component-4o and if the threshold-C is z dBm, a second difference delta_diff_C′=delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s)
Component-4r: indicator(s) or bitmap(s) indicating the one or more second candidate beams—e.g., out of the candidate beams or out of the first candidate beam(s).
Component-4s: a number of the one or more second current serving beams in the UEI report(s)
Component-4t: a number of the one or more second candidate beams in the UEI report(s)
Component-4u: indicator(s) indicating occurrence of the fourth event and/or an event index/ID associated/specific/corresponding to the fourth event
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-41 in the UEI report(s); e.g., the indicator(s) could be a one-bit indicator with ‘1’ (or ‘0’) indicating presence and ‘0’ (or ‘1’) indicating absence of Component-41 in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-51: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Nc>1 and/or Ns>1. In another example, Nc≥1 and/or Ns≥1. Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the fourth event or the Event-4 as described/specified herein could be denoted by or referred to as a fourth LTM event or a LTM Event-4. For the fourth LTM event or the LTM Event-4, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), and the one or more candidate/new beams (or equivalently, the RS(s)/RS resource(s)/RS resource index(es) corresponding to/of the one or more candidate/new beams or the candidate/new beam RS(s)/RS resource(s)/RS resource index(es)) could be associated to one or more PCIs and/or one or more candidate cells (e.g., one or more PCIs other than a serving cell PCI and/or a serving cell PCI, and/or one or more candidate cells other than a serving cell and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

Throughout the present disclosure, discussions, descriptions, specifications and etc. related to the first event (Event-1), the second event (Event-2), the third event (Event-3) and the fourth event (Event-4) can be equally applied or extended to the first LTM event (LTM Event-1), the second LTM event (LTM Event-2), the third LTM event (LTM event-3) and the fourth LTM event (LTM event-4), respectively, according to/following those described/specified herein in the present disclosure.

For each (or one or more) of the first, second, third and fourth events, and/or for a UE to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstanceDetectionTimer; thirdEventInstanceDetectionTimer or fourthEventInstanceDetectionTimer (higher layer configured respectively for the first, second, third or fourth event—when/if applicable)
      3> increment firstEvent COUNTER, secondEvent COUNTER, thirdEvent COUNTER or fourthEvent COUNTER (higher layer configured respectively for the first, second, third or fourth event—when/if applicable) by 1;
      3> if firstEvent COUNTER>=JfrstEventInstanceMaxCount, secondEvent COUNTER>=secondEventInstanceMaxCount, thirdEvent COUNTER>=thirdEventInstanceMaxCount or fourthEvent COUNTER>=fourthEventInstanceMaxCount (respectively for the first, second, third or fourth event—when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event—when/if applicable:
         4> trigger a UEI (beam) reporting specific to the first, second, third or fourth event—when/if applicable—for this Serving Cell, wherein the report content(s)/quantity(s) in the UEI report(s) is specific to the first, second, third or fourth event—when/if applicable—according to or following those specified herein in the present disclosure.
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable) expires; or
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable), firstEvent_COUNTER, secondEvent_COUNTER, thirdEvent_COUNTER or fourthEvent_COUNTER (respectively for the first, second, third or fourth event—when/if applicable), or any of the reference signals used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the reference signal(s) associated with this Serving Cell used for detection/declaration/indication for the first, second, third or fourth event as specified/defined herein in the present disclosure is changed and/or reconfigured by upper layers associated with this Serving Cell:
      3> setfirstEvent_COUNTER, secondEvent_COUNTER, thirdEvent_COUNTER or fourthEvent_COUNTER (respectively for the first, second, third or fourth event—when/if applicable) to 0; and/or
      3> stop the ueiReportingTimer, if configured; and/or
      3> regard the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity herein and the corresponding operation(s)/procedure(s) are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events—jointly or simultaneously, the corresponding MAC entity—e.g., for the third and fourth events—could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent_COUNTER and/or fourthEvent_COUNTER (higher layer configured for the third and/or fourth event(s)—when/if applicable) by 1;
      3> if both thirdEvent_COUNTER>=thirdEventInstanceMaxCount and fourthEvent_COUNTER>=fourthEventInstanceMaxCount (for the third and fourth events—when/if applicable), wherein the thirdEventInstanceMaxCount and fourthEventInstanceMaxCount are higher layer configured respectively for the third and fourth events—when/if applicable:
         4> trigger a UEI (beam) reporting specific to the third and fourth events for this Serving Cell, wherein the report content(s)/quantity(s) in the UEI report(s) is specific to the third and fourth events—when/if applicable—according to or following those specified herein in the present disclosure.
   2> if the thirdEventInstanceDetectionTimer and/or fourthEventInstanceDetectionTimer (respectively for the third and/or fourth event(s)—when/if applicable) expires; or
   2> if the thirdEventInstanceDetectionTimer and/or fourthEventInstanceDetectionTimer (respectively for the third and/or fourth event(s)—when/if applicable), thirdEvent_COUNTER and/or fourthEvent_COUNTER (respectively for the third and/or fourth event(s)—when/if applicable), or any of the reference signals used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the reference signal(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent_COUNTER and/or fourthEvent_COUNTER (respectively for the third and/or fourth event(s)—when/if applicable) to 0; and/or
      3> stop the ueiReportingTimer, if configured; and/or
      3> regard the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) herein and the corresponding operation(s)/procedure(s) could be applied or extended to when/if more than two events could be configured and/or enabled by the network and/or applied or used by the UE for initiating or triggering the UEI reporting.

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-4}, the UE could indicate or send or transmit to the network that they could support or could be capable of supporting the Event-1 and Event-4 in the present disclosure:
{Event-1}
{Event-2}
{Event-3}
{Event-4}
{Event-1, Event-2}
{Event-1, Event-3}
{Event-1, Event-4}
{Event-2, Event-3}
{Event-2, Event-4}
{Event-3, Event-4}
{Event-1, Event-2, Event-3}
{Event-1, Event-2, Event-4}
{Event-1, Event-3, Event-4}
{Event-2, Event-3, Event-4}
{Event-1, Event-2, Event-3, Event-4}

Furthermore, UEs that could or would support the UE-initiated or event-driven reporting should support or indicate their support of one or more of the events—such as Event-4; i.e., the one or more of the events—such as Event-4 in the present disclosure—could be specified or regarded as basic UE feature(s). The UE (e.g., the UE 116) could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one or more than one) of the events (e.g., Event-1 and/or Event-4) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when/if the eventType is set to ‘Event-1’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-4’ or ‘four’ or ‘4’ or ‘fourth’ or ‘two’ or ‘2’ or ‘second’ or ‘disabled’ (or ‘enabled’) or 0 (or 1), the Event-4 as specified/described herein in the present disclosure is enabled. For another example, when/if the eventType is set to ‘Event-1 and Event-4’ or ‘one and four’ or ‘1 and 4’ or ‘first and fourth’ or ‘enabled’ (or ‘disabled’) or 1 (or 0) or ‘00’ (or ‘01’ or ‘10’ or ‘11’), both the Event-1 and Event-4 as specified/defined herein in the present disclosure are enabled. Throughout the present disclosure, discussions, descriptions, specifications and etc. for when one/an event (e.g., Event-1 or Event-4) is enabled (e.g., detection, declaration, triggering and etc. of the event) can be equally applied or extended to when more than one events (e.g., both Event-1 and Event-4) are enabled (e.g., detection, declaration, triggering and etc. of the more than one events).

FIG. 8 illustrates a diagram of an example time window 800 for UE-initiated beam management according to embodiments of the present disclosure. For example, time window 800 can be utilized by any of the UEs 111-116 of FIG. 1, such as the UE 111. This example is for illustration only and other embodiments can be used without departing from the scope of the present disclosure.

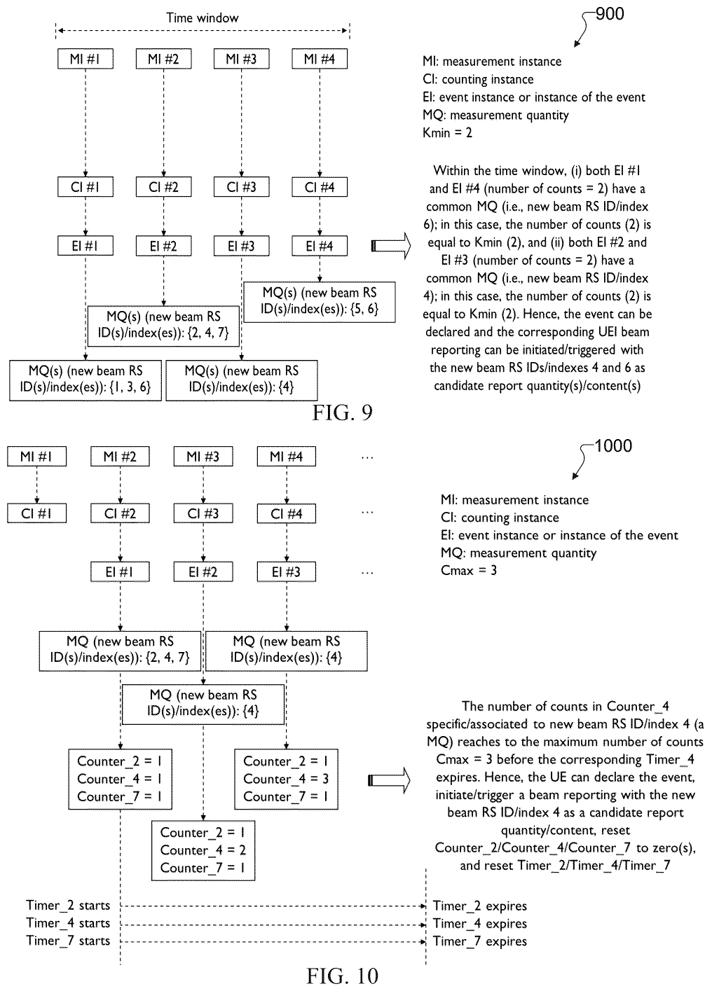

FIG. 9 illustrates a diagram of an example time window 900 for UE-initiated beam management according to embodiments of the present disclosure. For example, time window 900 can be utilized by any of the UEs 111-116 of FIG. 1, such as the UE 112. This example is for illustration only and other embodiments can be used without departing from the scope of the present disclosure.

FIG. 10 illustrates a diagram of an example time window 1000 for UE-initiated beam management according to embodiments of the present disclosure. For example, time window 1000 can be utilized by the UE 116 of FIG. 3. This example is for illustration only and other embodiments can be used without departing from the scope of the present disclosure.

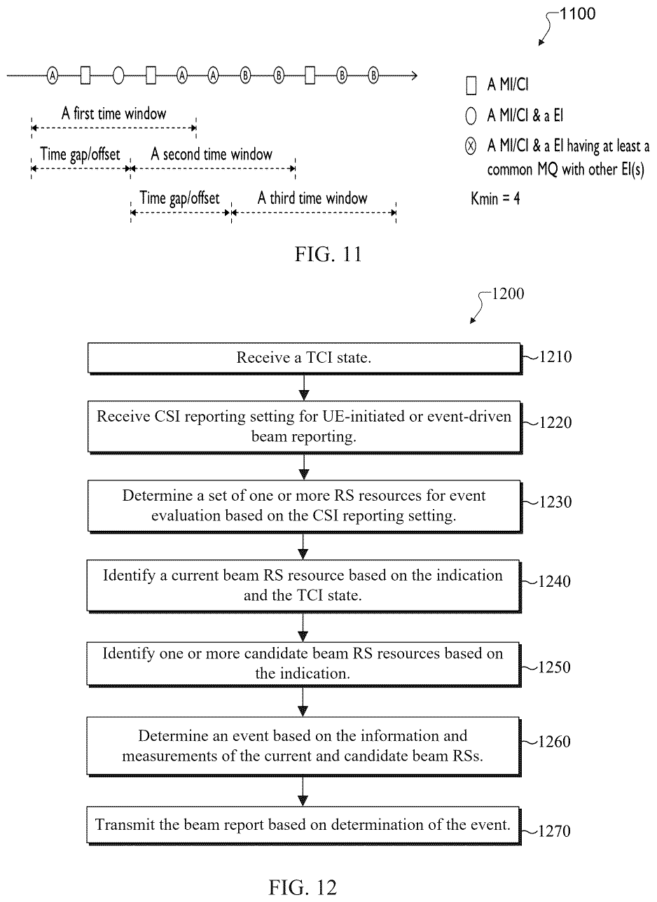

FIG. 11 illustrates a diagram of an example time window 1100 for UE-initiated beam management according to embodiments of the present disclosure. For example, time window 1100 can be utilized by any of the UEs 111-116 of FIG. 1, such as the UE 113. This example is for illustration only and other embodiments can be used without departing from the scope of the present disclosure.

As specified herein in the present disclosure, to declare an event and to trigger the corresponding (beam) reporting, a UE would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event (e.g., Event-4) and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure based on or according to or following one or more of:
In one example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. In this design example, a first counting instance (or a corresponding/associated measurement instance as specified/defined herein in the present disclosure) and a second counting instance (or a corresponding/associated measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE (e.g., the UE 116) could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if a/the number of instances of the event—denoted by K_1≥1 out of the total number of instances of the event, i.e., K_1≤K—that have at least one same measurement quantity (denoted by first same measurement quantity(s)) is less than (or greater than) or equal to a threshold (denoted by Kmax) or greater than (or less than) or equal to a threshold (denoted by Kmin), and/or a/the number of instances of the event—denoted by K_2≥1 out of the total number of instances of the event, i.e., K_2≤K—that have at least one same measurement quantity (denoted by second same measurement quantity(s)) is less than (or greater than) or equal to a threshold (denoted by Kmax) or greater than (or less than) or equal to a threshold (denoted by Kmin), and so on, and/or a/the number of instances of the event—denoted by K_k≥1 out of the total number of instances of the event, i.e., K_k≤K—that have at least one same measurement quantity (denoted by k-th same measurement quantity(s)) is less than (or greater than) or equal to a threshold (denoted by Kmax) or greater than (or less than) or equal to a threshold (denoted by Kmin), wherein kE{1, 2, . . . , Btot} with Btot representing the maximum/total number of unique measurement quantities obtained/identified/determined from the K event instances, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. Two conceptual examples are presented in FIG. 8 and FIG. 9. In FIG. 8, the UE could determine or identify three instances of the event (denoted by event instance (EI) #1, EI #2 and EI #3) from four measurement instances (MIs)/counting instances (CIs) in the time window/period/gap/offset, and in FIG. 9, the UE could determine or identify four instances of the event (denoted by EI #1, EI #2, EI #3 and EI #4) from four MIs/CIs within the time window/period/gap/offset. Among the three determined/identified EIs in FIG. 8, the two (equal to Kmin=2 in this design example) EI #1 and EI #2 have a/the same measurement quantity—i.e., a new beam RS ID/index 4; hence, according to those specified herein in the present disclosure, the UE could declare the event and initiate/trigger a beam reporting with the new beam RS ID/index 4 as a candidate report quantity/content. Among the four determined/identified EIs in FIG. 9, the two (equal to Kmin=2 in this design example) EI #1 and EI #4 have a/the same measurement quantity—i.e., a new beam RS ID/index 6, and the two (equal to Kmin=2 in this design example) EI #2 and EI #3 have a/the same measurement quantity—i.e., a new beam RS ID/index 4; hence, according to those specified herein in the present disclosure, the UE could declare the event and initiate/trigger a beam reporting with the new beam RS IDs/indexes 4 and 6 as candidate report quantities/contents.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if there is at least one common/same measurement quantity (e.g., in terms of new beam RS ID(s)/index(es)) among the first, second, . . . , and/or K-th measurement quantities as specified/defined herein in the present disclosure and/or the number of at least one of the common/same measurement quantities—denoted by/referred to as triggering measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or K-th measurement quantities as specified/defined herein in the present disclosure, and/or when/if a/the number of one or more same/common measurement quantities—denoted by/referred to as first same measurement quantity(s)—among the first, second, . . . and/or K-th measurement quantities as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . and/or K-th measurement quantities as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), k∈{1, 2, . . . , Btot} with Btot representing the maximum/total number of unique measurement quantities obtained/identified/determined from the K event instances, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as specified/defined herein in the present disclosure, and/or the first same measurement quantity(s), the second same measurement quantity(s), . . . , the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine an event instance counter specific/associated to the k-th instance of the event wherein k=1, . . . , K. The UE (e.g., higher layer(s) of the UE) could increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein l∈{1, . . . , K} and l≠k, that has at least one same measurement quantity, denoted by k′-th same measurement quantity(s) wherein k′∈{1, . . . , Btot} with Btot representing the maximum/total number of unique measurement quantities obtained/identified/determined from the K event instances, as that determined or identified for the k-th instance of the event. When/if a/the number of count(s) in at least one event instance counter as specified/defined herein in the present disclosure reaches to the maximum number of count(s)—denoted by Cmax, wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in each of the event instance counter(s) as specified/defined herein in the present disclosure to zero(s) when/if (1) the number of count(s) in the corresponding event instance counter has reached to Cmax, and/or (2) after, e.g., the last symbol/slot/etc. of, the K-th measurement instance or the K-th counting instance or the K-th instance of the event or out of the time window/period/gap/offset as specified/defined herein in the present disclosure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), . . . , the k′-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine an event instance counter specific/associated to the k-th instance of the event wherein k=1, . . . , K, . . . . The UE (e.g., higherlayer(s) of the UE) could start atimer specific/associated to the k-th instance of the event and/or increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the 1-th instance of the event wherein IE{1, . . . , K, . . . } and l≠k, that has at least one same measurement quantity, denoted by k′-th same measurement quantity(s) wherein k′∈{1, . . . , Btot} with Btot representing the maximum/total number of unique measurement quantities obtained/identified/determined from the event instances, as that determined or identified for the k-th instance of the event. When/if a/the number of count(s) in at least one event instance counter as specified/defined herein in the present disclosure reaches to the maximum number of count(s)—denoted by Cmax—before the corresponding timer expires (the corresponding same measurement quantity(s) specific/associated to the at least one event instance counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE (e.g., the UE 116) could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the event instance counter specific/associated to the k-th instance of the event as specified/defined herein in the present disclosure to zero and/or reset the timer specific/associated to the k-th instance of the event when/if (1) the number of count(s) in the event instance counter specific/associated to the k-th instance of the event has reached to Cmax, and/or (2) the timer specific/associated to the k-th instance of the event has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For a m-th measurement quantity, wherein m=1, 2, . . . , Btot with Btot representing the total/maximum number of unique measurement quantities obtained/identified/determined from the K event instances, the UE could determine or identify a/the number of event instance(s)—denoted by K_m≥1 out of the total number of instances of the event, i.e., K_m≤K—that have at least the m-th measurement quantity. In this case, when/if at least one of K 1, . . . , K_Btot is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, when/if K_k (k∈{1, . . . , Btot}) is less than (or greater than) or equal to a threshold (denoted by Kmax) or greater than (or less than) or equal to a threshold (denoted by Kmin), the k-th measurement quantity as defined/specified herein in the present disclosure could be regarded as one of candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine a measurement quantity counter specific/associated to a m-th measurement quantity, wherein m=1, . . . , Btot with Btot representing the total/maximum number of unique measurement quantities obtained/identified/determined from the K event instances. The UE (e.g., higher layer(s) of the UE) could increase the number of count(s), e.g., in the measurement quantity counter specific/associated to the m-th measurement quantity, by 1, when/if the UE has identified, determined or detected a/the same value of the m-th measurement quantity from any of the K event instances and therefore their corresponding/associated counting/measurement instances. When/if a/the number of count(s) in at least one measurement quantity counter as specified/defined herein in the present disclosure reaches to the maximum number of count(s)—denoted by Cmax (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero when/if (1) the number of count(s) in the measurement quantity counter specific/associated to the m-th measurement quantity has reached to Cmax, and/or (2) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine a measurement quantity counter specific/associated to a m-th measurement quantity, wherein m=1, 2, . . . , Btot, . . . with Btot representing the total/maximum number of unique measurement quantities obtained/identified/determined from the K event instances. The UE (e.g., higher layer(s) of the UE) could start a timer specific/associated to the m-th measurement quantity and/or increase the number of count(s), e.g., in the measurement quantity counter specific/associated to the m-th measurement quantity, by 1, when/if the UE has identified, determined or detected a/the same value of the m-th measurement quantity from any of the (K) event instances and therefore their corresponding/associated counting/measurement instances. When/if a/the number of count(s) in at least one measurement quantity counter as specified/defined herein in the present disclosure reaches to the maximum number of count(s)—denoted by Cmax—before the corresponding timer expires (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero and/or reset the timer specific/associated to the m-th measurement quantity when/if (1) the number of count(s) in the measurement quantity counter specific/associated to the m-th measurement quantity has reached to Cmax, and/or (2) the timer specific/associated to the m-th measurement quantity has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. One conceptual example characterizing the described/specified design procedures herein is provided in FIG. 10. As can be seen from FIG. 10, only the number of counts in the measurement quantity counter specific/associated to the measurement quantity of new beam RS ID/index 4 (denoted by Counter_4 in FIG. 10) has reached to the maximum number of counts Cmax before the corresponding timer specific/associated to the measurement quantity of new beam RS ID/index 4 (denoted by Timer_4 in FIG. 10) expires. In this case, the UE could declare the event and initiate/trigger a beam reporting with at least the new beam RS ID/index 4 as a candidate report quantity/content.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE (e.g., the UE 116) could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, wherein the first instance of the event (or the corresponding/associated first counting/measurement instance as specified/defined herein in the present disclosure), the second instance of the event (or the corresponding/associated second counting/measurement instance as specified/defined herein in the present disclosure), . . . , and the K-th instance of the event (or the corresponding/associated K-th measurement/counting instance as specified/defined herein in the present disclosure) could be within a t-th (e.g., t∈{1, . . . , T}) time window/period/gap/offset (e.g., in terms of number of symbols/slots/etc.), wherein the value(s) of T and/or the t-th time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if at least one of the second measurement quantity(s), . . . , at least one of the K-th measurement quantity(s) is identical to or the same as at least one of the first measurement quantity(s)—denoted by/as channel triggering condition(s)—within the t-th time window/period/gap/offset as specified/defined herein in the present disclosure, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s), and K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event—within the t-th time window/period/gap/offset—as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., tE{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event—denoted by K_1≥1 out of the total number of instances of the event within the t-th time window/period/gap/offset, i.e., K_1≤Kt—that have at least one same measurement quantity (denoted by first same measurement quantity(s)) is less than (or greater than) or equal to a threshold (denoted by Kmax) or greater than (or less than) or equal to a threshold (denoted by Kmin)—denoted by/referred to as channel triggering condition(s), and/or a/the number of instances of the event—denoted by K_2≥1 out of the total number of instances of the event within the t-th time window/period/gap/offset, i.e., K_2≤Kt—that have at least one same measurement quantity (denoted by second same measurement quantity(s)) is less than (or greater than) or equal to a threshold (denoted by Kmax) or greater than (or less than) or equal to a threshold (denoted by Kmin)—denoted by/referred to as channel triggering condition(s), and so on, and/or a/the number of instances of the event—denoted by K_k≥1 out of the total number of instances of the event within the t-th time window/period/gap/offset, i.e., K_k≤Kt—that have at least one same measurement quantity (denoted by k-th same measurement quantity(s)) is less than (or greater than) or equal to a threshold (denoted by Kmax) or greater than (or less than) or equal to a threshold (denoted by Kmin)—denoted by/referred to as channel triggering condition(s), wherein k∈{1, 2, . . . , Btot,t} with Btot,t representing the maximum/total number of unique measurement quantities obtained/identified/determined from the Kt event instances within the t-th time window/period/gap/offset, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . , the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance —denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event that have at least one same measurement quantity (denoted by triggering measurement quantity(s)) within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE (e.g., the UE 116) would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. A conceptual example characterizing the described design procedure(s) herein is presented in FIG. 11. As illustrated in FIG. 11, only within the third time window/period/gap/offset, the number of counts of the instances of the event that have at least one common measurement quantity (e.g., in term of new beam RS ID(s)/index(es)) is equal to Kmin (i.e., 4 in this example). Hence, the UE could declare the event and trigger/initiate a beam reporting after the third time window/period/offset/gap. Note there that there is a time gap/offset t_p between two adjacent time windows/periods/offsets/gaps in time, which can be configured/provided by the network, e.g., via higher layer RRC signaling/parameter (e.g., provided in higher layer parameter(s) such as CSI-ResourceConfig, CSI-ReportConfig, UEI-ReportConfig or UEI-ResourceConfig that provides necessary information/settings for the UEI beam reporting).
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure and/or the number of at least one of the common/same measurement quantities—denoted by/referred to as triggering measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by or referred to as channel trigging condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure, and/or when/if a/the number of one or more same/common measurement quantities—denoted by/referred to as first same measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by/referred to as channel triggering condition(s), k∈{1, 2, . . . , Btot} with Btot representing the maximum/total number of unique measurement quantities obtained/identified/determined from the Kt event instances within the t-th time window/period/gap/offset, and/or when/if the t-th time window/period/gap/offset ends the earliest in time than the other time window(s)/period(s)/gap(s)/offset(s) each having one or more same/common measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of same/common measurement quantity(s) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . the k-th same measurement quantity(s)—within the t-th time window/period/gap/offset—as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among (all) the measurement quantities within at least one time window/period/offset/gap (e.g., the t-th time window/period/offset/gap), and/or when/if a/the number of at least one of the common/same measurement quantities (denoted by triggering measurement quantity(s)) among (all) the measurement quantities within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of common/same measurement quantity(s) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.

For the (herein described) design examples discussed/specified herein in the present disclosure, when/if a UE is configured/provided by the network, e.g., via higher layer RRC signaling/parameter, a parameter, the parameter could be provided in higher layer parameter(s) such as CSI-ResourceConfig, CSI-ReportConfig, UEI-ReportConfig or UEI-ResourceConfig that provides necessary information/settings for the UEI beam reporting. Furthermore, as specified herein in the present disclosure, for a measurement instance (or a counting instance), the UE (e.g., the UE 116) could measure or assess one or more measurement RSs (for the current serving beam and/or one or more candidate/new beams as specified/defined herein in the present disclosure), obtain/determine/identify the corresponding measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs, and determine or identify an event instance (if any). In the present disclosure, the UE could identify or determine an instance of an event if the condition(s) of the event is achieved/satisfied; for instance, for the fourth event (Event-4) as specified/defined herein in the present disclosure, the UE could identify or determine an instance of the Event-4 or an Event-4 instance when/if the radio link or beam quality(s)—e.g., in form of (measured) L1-RSRP/L1-SINR value(s)—of one or more (or at least one) candidate/new beams is beyond or greater than the radio link or beam quality(s)—e.g., in form of (measured) L1-RSRP/L1-SINR value(s)—of one or more current serving beams by a threshold/offset value, denoted by threshold-C in the present disclosure.

As specified herein in the present disclosure, for a given event, a measurement quantity (and therefore, a corresponding candidate report content/quantity as defined/specified herein in the present disclosure) could correspond to a report content/quantity as specified herein in the present disclosure for the event. For instance, for the Event-4 as specified herein in the present disclosure, a measurement quantity and/or a triggering measurement quantity as specified/defined herein in the present disclosure (and therefore, a corresponding candidate report content/quantity as defined/specified herein in the present disclosure) could correspond to an identified candidate/new beam that satisfies the Event-4 condition, an identified candidate/new beam RS/RS resource/RS resource index (or the corresponding SSBRI/CRI) that satisfies the Event-4 condition, the current serving beam or the current serving beam RS/RS resource/RS resource index (or the corresponding SSBRI/CRI) that satisfies the Event-4 condition, a (measured/differential) L1-RSRP/L1-SINR value associated/specific to an identified candidate/new beam or candidate/new beam RS/RS resource/RS resource index (or the corresponding SSBRI/CRI) that satisfies the Event-4 condition, and a (measured/differential) L1-RSRP/L1-SINR value associated/specific to the current serving beam or the current serving beam RS/RS resource/RS resource index (or the corresponding SSBRI/CRI) that satisfies the Event-4 condition. Or, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more report contents/quantities as specified herein in the present disclosure for the event. For instance, for the Event-4 as specified herein in the present disclosure, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams that satisfy the Event-4 condition, one or more identified candidate/new beam RSs/RS resources/RS resource indexes (or the corresponding SSBRIs/CRIs) that satisfy the Event-4 condition, the current serving beam or the current serving beam RS/RS resource/RS resource index (or the corresponding SSBRI/CRI) that satisfies the Event-4 condition, one or more (measured/differential) L1-RSRP/L1-SINR values associated/specific to the one or more identified candidate/new beams or candidate/new beam RSs/RS resources/RS resource indexes (or the corresponding SSBRIs/CRIs) that satisfy the Event-4 condition, and a (measured/differential) L1-RSRP/L1-SINR value associated/specific to the current serving beam or the current serving beam RS/RS resource/RS resource index (or the corresponding SSBRI/CRI) that satisfies the Event-4 condition. Across different measurement instances as described/specified herein in the present disclosure, the type of the measurement RS(s) for the candidate/new beam(s) could be the same/identical, e.g., CSI-RS(s) or SSB(s). Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), for a LTM event, a measurement quantity and/or a triggering measurement quantity as specified/defined herein in the present disclosure (and therefore, a corresponding candidate report content/quantity as defined/specified herein in the present disclosure) could correspond to an identified candidate/new beam—associated to a PCI other than the serving cell PCI or the serving cell PCI—that satisfies the LTM event condition, an identified candidate/new beam RS/RS resource/RS resource index (or the corresponding SSBRI/CRI)—associated to a PCI other than the serving cell PCI or the serving cell PCI—that satisfies the LTM event condition, the current serving beam or the current serving beam RS/RS resource/RS resource index (or the corresponding SSBRI/CRI)—associated to the serving cell PCI—that satisfies the LTM event condition, a (measured/differential) L1-RSRP/L1-SINR value associated/specific to an identified candidate/new beam or candidate/new beam RS/RS resource/RS resource index (or the corresponding SSBRI/CRI)—associated to a PCI other than the serving cell PCI or the serving cell PCI—that satisfies the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. In addition, for the LTM event, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams—associated to one or more PCIs other than the serving cell PCI or the serving cell PCI (and/or associated to one or more candidate cells other than the serving cell or the serving cell)—that satisfy the LTM event condition, one or more identified candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, the current serving beam or the current serving beam RS/RS resource/RS resource index (or the corresponding SSBRI/CRI)—associated to the serving cell PCI—that satisfies the LTM event condition, one or more (measured/differential) L1-RSRP/L1-SINR values associated/specific to the one or more identified candidate/new beams or candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. Across different measurement instances as described/specified herein in the present disclosure, the type of the measurement RS(s) for the candidate/new beam(s) could be the same/identical, e.g., CSI-RS(s) or SSB(s), and/or the measurement RS(s) for the candidate/new beam(s) could be associated to a/the same PCI (e.g., a PCI other than the serving cell PCI or the serving cell PCI)—or a/the same candidate cell (e.g., a candidate cell other than the serving cell or the serving cell)—or different PCIs (e.g., different PCIs other than the serving cell PCI or different PCIs comprising one or more PCIs other than the serving cell PCI and the serving cell PCI)—or different candidate cells (e.g., different candidate cells other than the serving cell or different candidate cells comprising one or more candidate cells other than the serving cell and the serving cell). Here, a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)
   There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.
      Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network (e.g., the network 130), e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam—denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking reference signal (TRS) is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set s̅₀ of (periodic) CSI-RS resource configuration indexes by currentServBeamRSList (e.g., via higher layer RRC signaling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-2): a set s̅₀ of SS/PBCH block indexes by currentServBeamRSList (e.g., via higher layer RRC signaling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSList (e.g., via higher layer RRC signaling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSList (e.g., via higher layer RRC signaling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-B): a set s̅₁ of SS/PBCH block indexes by CandidateBeamRSList (e.g., via higher layer RRC signaling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network (e.g., the network 130) a/the set s̅₁ of (periodic) CSI-RS resource configuration indexes by CandidateBeamRSList (e.g., via higher layer RRC signaling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

According to or following those specified herein in the present disclosure, a UE (e.g., the UE 116) could be provided or configured by the network, e.g., via higher layer RRC signaling(s)/parameter(s)—e.g., in/via/by higher layer parameter(s) CSI-ReportConfig and/or UEI-ReportConfig that provides necessary information and/or setting(s) for the UEI beam reporting—and/or MAC CE command(s) and/or dynamic DCI based L1 signaling(s) based on or according to a corresponding UE's capability or capability signaling, one or more indicators to indicate to the UE whether the UE could report, in a reporting instance/CSI-Report/UEI beam report (BR), L1 measurement result(s) comprising resource indicator(s) such as SSBRI(s)/CRI(s) and/or beam metric(s) such as L1-RSRP(s)/L1-SINR(s) for current serving beam RS(s)/RS resource(s) as defined/specified herein in the present disclosure. For example, when/if a UE is provided a higher layer parameter currentBeamInclusion (e.g., in/by/via higher layer parameter(s) CSI-ReportConfig and/or UEI-ReportConfig that provides necessary information and/or setting(s) for the UEI beam reporting) and/or the higher layer parameter currentBeamInclusion is set to ‘enabled’, the UE could or is expected to report, in a/the (same) reporting instance/CSI report/UEI-BR, the L1 measurement result(s) comprising resource indicator(s) such as SSBRI(s)/CRI(s) and/or beam metric(s) such as L1-RSRP(s)/L1-SINR(s) for the current serving beam RS(s)/RS resource(s) as defined/specified herein in the present disclosure. Otherwise, i.e., when/if a UE is not provided a higher layer parameter currentBeamInclusion (e.g., in/by/via higher layer parameter(s) CSI-ReportConfig and/or UEI-ReportConfig that provides necessary information and/or setting(s) for the UEI beam reporting), and/or when/if the UE is provided the higher layer parameter currentBeamInclusion (e.g., in/by/via higher layer parameter(s) CSI-ReportConfig and/or UEI-ReportConfig that provides necessary information and/or setting(s) for the UEI beam reporting) but the higher layer parameter currentBeamInclusion is set to ‘disabled’, the UE may or may not report (e.g., up to UE's implementation, selection, decision and/or determination), in a/the (same) reporting instance/CSI report/UEI-BR, the L1 measurement result(s) comprising resource indicator(s) such as SSBRI(s)/CRI(s) and/or beam metric(s) such as L1-RSRP(s)/L1-SINR(s) for the current serving beam RS(s)/RS resource(s) as defined/specified herein in the present disclosure.
When/if a UE is not provided a higher layer parameter currentBeamInclusion (e.g., in/by/via higher layer parameter(s) CSI-ReportConfig and/or UEI-ReportConfig that provides necessary information and/or setting(s) for the UEI beam reporting), and/or when/if the UE is provided the higher layer parameter currentBeamInclusion (e.g., in/by/via higher layer parameter(s) CSI-ReportConfig and/or UEI-ReportConfig that provides necessary information and/or setting(s) for the UEI beam reporting) but the higher layer parameter currentBeamInclusion is set to ‘disabled’, the UE could report, in a single report/reporting instance/CSI-Report/UEI-BR,
   In one example, nrofReportedRS-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, and nrofReportedRS-UEIBR (if higher layer configured) L1-RSRP(s)/L1-SINR(s) corresponding to the reported nrofReportedRS-UEIBR (if higher layer configured) SSBRI(s) and/or CRI(s).
   In another example, nrofReportedRS-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, nrofReportedRS-UEIBR (if higher layer configured) L1-RSRP(s)/L1-SINR(s) corresponding to the reported nrofReportedRS-UEIBR (if higher layer configured) SSBRI(s) and/or CRI(s), and one beam metric such as L1-RSRP/L1-SINR obtained or determined or identified for/specific to the current serving beam RS/RS resource as specified/defined herein in the present disclosure.
   In another example, (nrofReportedBM-UEIBR—1) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, and nrofReportedBM-UEIBR (if higher layer configured) L1-RSRP(s)/L1-SINR(s) with (nrofReportedBM-UEIBR—1) of them corresponding to the reported (nrofReportedBM-UEIBR—1) SSBRI(s) and/or CRI(s) and one of them obtained or determined or identified for/specific to the current serving beam RS/RS resource as specified/defined herein in the present disclosure.
   In another example, nrofReportedBM-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, one resource indicator SSBRI or CRI corresponding/specific to the current serving beam RS/RS resource as specified/defined herein in the present disclosure, and nrofReportedBM-UEIBR (if higher layer configured) L1-RSRP(s)/L1-SINR(s) corresponding to the reported nrofReportedBM-UEIBR (if higher layer configured) SSBRI(s) and/or CRI(s).
   In another example, nrofReportedRS-UEIBR (if higher layer configured) SSBRI(s) and/or CRI(s) with one or more (e.g., nrofReportedRS-UEIBR—1) of them selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, and with one of them, i.e., one of the reported nrofReportedRS-UEIBR resource indicator(s) SSBRI(s) or CRI(s), corresponding/specific to the current serving beam RS/RS resource as specified/defined herein in the present disclosure, and (nrofReportedRS-UEIBR-1) L1-RSRP(s)/L1-SINR(s) corresponding to the reported SSBRI(s) and/or CRI(s) that selects SSB(s) and/or CSI-RS(s) from the (set of) candidate/new beam RS(s)/RS resource(s) as specified/defined herein in the present disclosure.

For the design example x.1, the reported nrofReportedRS-UEIBR (if higher layer configured) SSBRI(s) and/or CRI(s) may or may not comprise the SSBRI/CRI corresponding/specific to the current serving beam RS/RS resource as specified/defined herein in the present disclosure, and the reported nrofReportedRS-UEIBR (if higher layer configured) beam metric(s) including L1-RSRP(s)/L1-SINR(s) may or may not comprise the beam metric such as L1-RSRP/L1-SINR obtained or determined or identified for/specific to the current serving beam RS/RS resource as specified/defined herein in the present disclosure. For this design example,
In one example, the UEI beam report could comprise one or more (one-bit) indicators each associated/corresponding/specific to a report quantity, e.g., a SSBRI/CRI or a L1-RSRP/L1-SINR, and/or each of the reported report quantity(s) in the UEI beam report could be associated/corresponding/specific to a (one-bit) indicator; in this case, when/if a (one-bit) indicator is set to ‘1’ (or ‘0’), the report quantity associated/corresponding/specific to the (one-bit) indicator could be for or associated/specific/corresponding to the current serving beam RS/RS resource as specified/defined herein in the present disclosure; otherwise, i.e., when/if a (one-bit) indicator is set to ‘0’ (or ‘1’), the report quantity associated/corresponding/specific to the (one-bit) indicator could be for or associated/specific/corresponding to a SSB and/or a CSI-RS selected from the (set of) candidate/new beam RS(s)/RS resource(s) as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more (one-bit) indicators each associated/corresponding/specific to a resource indicator, e.g., a SSBRI/CRI, and/or each of the reported resource indicator(s) in the UEI beam report could be associated/corresponding/specific to a (one-bit) indicator; in this case, when/if a (one-bit) indicator is set to ‘1’ (or ‘0’), the resource indicator SSBRI/CRI (and therefore, the corresponding beam metric L1-RSRP/L1-SINR in the same CSI report/UEI-BR) associated/corresponding/specific to the (one-bit) indicator could be for or associated/specific/corresponding to the current serving beam RS/RS resource as specified/defined herein in the present disclosure; otherwise, i.e., when/if a (one-bit) indicator is set to ‘0’ (or ‘1’), the resource indicator SSBRI/CRI (and therefore, the corresponding beam metric L1-RSRP/L1-SINR in the same CSI report/UEI-BR) associated/corresponding/specific to the (one-bit) indicator could select a SSB and/or a CSI-RS from the (set of) candidate/new beam RS(s)/RS resource(s) as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more (one-bit) indicators each associated/corresponding/specific to a beam metric, e.g., a L1-RSRP/L1-SINR, and/or each of the reported beam metric(s) in the UEI beam report could be associated/corresponding/specific to a (one-bit) indicator; in this case, when/if a (one-bit) indicator is set to ‘1’ (or ‘0’), the beam metric L1-RSRP/L1-SINR (and therefore, the corresponding resource indicator SSBRI/CRI in the same CSI report/UEI-BR) associated/corresponding/specific to the (one-bit) indicator could be for or associated/specific/corresponding to or determined/obtained/identified according to/based on the current serving beam RS/RS resource as specified/defined herein in the present disclosure; otherwise, i.e., when/if a (one-bit) indicator is set to ‘0’ (or ‘1’), the beam metric L1-RSRP/L1-SINR (and therefore, the corresponding resource indicator SSBRI/CRI in the same CSI report/UEI-BR) associated/corresponding/specific to the (one-bit) indicator could be determined/obtained/identified according to/based on a SSB and/or a CSI-RS selected from the (set of) candidate/new beam RS(s)/RS resource(s) as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more (one-bit) indicators each associated/corresponding/specific to a report quantity, e.g., a SSBRI/CRI or a L1-RSRP/L1-SINR, associated/specific/corresponding to and/or determined/identified/obtained according to or based on the current serving beam RS/RS resource as specified/defined herein in the present disclosure; i.e., when/if a (one-bit) indicator is present and set to a valid value e.g. ‘1’ or ‘0’, the report quantity associated/corresponding/specific to the (one-bit) indicator could be for or associated/specific/corresponding to and/or determined/obtained/identified according to or based on the current serving beam RS/RS resource as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more (one-bit) indicators each associated/corresponding/specific to a report quantity, e.g., a SSBRI/CRI or a L1-RSRP/L1-SINR, associated/specific/corresponding to and/or determined/identified/obtained according to or based on a SSB and/or a CSI-RS selected from the (set of) candidate/new beam RS(s)/RS resource(s) as specified/defined herein in the present disclosure; i.e., when/if a (one-bit) indicator is present and set to a valid value e.g. ‘1’ or ‘0’, the report quantity associated/corresponding/specific to the (one-bit) indicator could be for or associated/specific/corresponding to and/or determined/obtained/identified according to or based on a SSB and/or a CSI-RS selected from the (set of) candidate/new beam RS(s)/RS resource(s) as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more indicators each associated/corresponding/specific to a resource indicator, e.g., a SSBRI/CRI, associated/specific/corresponding to the current serving beam RS/RS resource as specified/defined herein in the present disclosure; i.e, when/if a (one-bit) indicator is present and set to a valid value e.g. ‘1’ or ‘0’, the resource indicator SSBRI/CRI (and therefore, the corresponding beam metric L1-RSRP/L1-SINR in the same CSI report/UEI-BR) associated/corresponding/specific to the indicator—e.g., when/if the index/order/position of a first CSI field in the UEI beam report that carries/conveys the (one-bit) indicator is k, the index/order/position of a second CSI field in the UEI beam report that carries/conveys the resource indicator SSBRI/CRI is k+1 or k−1 (i.e., the second CSI field could follow the first CSI field (e.g., in order or in index or in ordinal position) in the UEI beam report or vice versa)—could be for or associated/specific/corresponding to the current serving beam RS/RS resource as specified/defined herein in the present disclosure. Alternatively, the UEI beam report could comprise one or more indicators each associated/corresponding/specific to a beam metric, e.g., a L1-RSRP/L1-SINR, associated/specific/corresponding to or determined/obtained/identified according to/based on the current serving beam RS/RS resource as specified/defined herein in the present disclosure; i.e, when/if a (one-bit) indicator is present and set to a valid value e.g. ‘1’ or ‘0’, the beam metric L1-RSRP/L1-SINR (and therefore, the corresponding resource indicator SSBRI/CRI in the same CSI report/UEI-BR) associated/corresponding/specific to the indicator—e.g., when/if the index/order/position of a first CSI field in the UEI beam report that carries/conveys the (one-bit) indicator is k, the index/order/position of a second CSI field in the UEI beam report that carries/conveys the beam metric L1-RSRP/L1-SINR is k+1 or k−1 (i.e., the second CSI field could follow the first CSI field (e.g., in order or in index or in ordinal position) in the UEI beam report or vice versa)—could be for or associated/specific/corresponding to or obtained/determined/identified according to/based on the current serving beam RS/RS resource as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more indicators each associated/corresponding/specific to a resource indicator, e.g., a SSBRI/CRI, selecting a SSB and/or a CSI-RS from the (set of) candidate/new beam RS(s)/RS resource(s) as specified/defined herein in the present disclosure; i.e, when/if a (one-bit) indicator is present and set to a valid value e.g. ‘1’ or ‘0’, the resource indicator SSBRI/CRI (and therefore, the corresponding beam metric L1-RSRP/L1-SINR in the same CSI report/UEI-BR) associated/corresponding/specific to the indicator—e.g., when/if the index/order/position of a first CSI field in the UEI beam report that carries/conveys the (one-bit) indicator is k, the index/order/position of a second CSI field in the UEI beam report that carries/conveys the resource indicator SSBRI/CRI is k+1 or k−1 (i.e., the second CSI field could follow the first CSI field (e.g., in order or in index or in ordinal position) in the UEI beam report or vice versa)—could be associated/specific/corresponding to a SSB and/or a CSI-RS selected from the (set of) candidate/new beam RS(s)/RS resource(s) as specified/defined herein in the present disclosure. Alternatively, the UEI beam report could comprise one or more indicators each associated/corresponding/specific to a beam metric, e.g., a L1-RSRP/L1-SINR, associated/specific/corresponding to and/or determined/obtained/identified according to/based on a SSB and/or a CSI-RS selected from the (set of) candidate/new beam RS(s)/RS resource(s) as specified/defined herein in the present disclosure; i.e, when/if a (one-bit) indicator is present and set to a valid value e.g. ‘1’ or ‘0’, the beam metric L1-RSRP/L1-SINR (and therefore, the corresponding resource indicator SSBRI/CRI in the same CSI report/UEI-BR) associated/corresponding/specific to the indicator—e.g., when/if the index/order/position of a first CSI field in the UEI beam report that carries/conveys the (one-bit) indicator is k, the index/order/position of a second CSI field in the UEI beam report that carries/conveys the beam metric L1-RSRP/L1-SINR is k+1 or k−1 (i.e., the second CSI field could follow the first CSI field (e.g., in order or in index or in ordinal position) in the UEI beam report or vice versa)—could be for or associated/specific/corresponding to or obtained/determined/identified according to/based on a SSB and/or a CSI-RS selected from the (set of) candidate/new beam RS(s)/RS resource(s) as specified/defined herein in the present disclosure. Optionally, the one or more (one-bit) indicators here could be or could correspond to or could be in form of a bitmap such that each entry/bit position of the bitmap could correspond to a (one-bit) indicator, and/or each of the one or more (one-bit) indicators here could correspond to an entry/bit position of the bitmap.
In another example, the UEI beam report could comprise one or more indicators each having a bitwidth of ┌log₂(Nₜ)┐ and/or one or more indexes, wherein Nₜ=nrofReportedRS-UEIBR+nrofReportedRS-UEIBR; in this case, when/if an indicator/index indicates a value nₜ less than or equal to nrofReportedRS-UEIBR, the nₜ-th resource indicator SSBRI/CRI in the UEI beam report—among the reported nrofReportedRS-UEIBR resource indicators in the UEI beam report—could be associated/specific/corresponding to the current serving beam RS/RS resource as specified/defined herein in the present disclosure; and, when/if an indicator/index indicates a value nₜ greater than nrofReportedRS-UEIBR, the (nₜ—nrofReportedRS-UEIBR)-th beam metric in the UEI beam report—among the reported nrofReportedRS-UEIBR beam metrics in the UEI beam report—could be associated/specific/corresponding to or obtained/determined/identified according to/based on the current serving beam RS/RS resource as specified/defined herein in the present disclosure. Alternatively, the UEI beam report could comprise one or more indicators each having a bitwidth of ┌log₂(Nₜ)┐ and one or more indexes, wherein Nₜ=nrofReportedRS-UEIBR+nrofReportedRS-UEIBR; in this case, when/if an indicator/index indicates a value nₜ less than or equal to nrofReportedRS-UEIBR, the nₜ-th resource indicator SSBRI/CRI in the UEI beam report—among the reported nrofReportedRS-UEIBR resource indicators in the UEI beam report—could select a SSB and/or a CSI-RS from the (set of) candidate/new beam RS(s)/RS resource(s) as specified/defined herein in the present disclosure; and, when/if an indicator/index indicates a value nₜ greater than nrofReportedRS-UEIBR, the (nₜ—nrofReportedRS-UEIBR)-th beam metric in the UEI beam report—among the reported nrofReportedRS-UEIBR beam metrics in the UEI beam report—could be associated/specific/corresponding to or obtained/determined/identified according to/based on a SSB and/or a CSI-RS selected from the (set of) candidate/new beam RS(s)/RS resource(s) as specified/defined herein in the present disclosure. Optionally, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) and the corresponding beam metric(s) L1-RSRP(s)/L1-SINR(s) in the UEI beam report; in this case, when/if an indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a resource indicator SSBRI/CRI, the resource indicator SSBRI/CRI could be associated/specific/corresponding to the current serving beam RS/RS resource as specified/defined herein in the present disclosure; and, when/if an indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a beam metric L1-RSRP/L1-SINR, the beam metric L1-RSRP/L1-SINR could be associated/specific/corresponding to or obtained/determined/identified according to/based on the current serving beam RS/RS resource as specified/defined herein in the present disclosure. Alternatively, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) and the corresponding beam metric(s) L1-RSRP(s)/L1-SINR(s) in the UEI beam report; in this case, when/if an indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a resource indicator SSBRI/CRI, the resource indicator SSBRI/CRI could select a SSB and/or a CSI-RS from the (set of) candidate/new beam RS(s)/RS resource(s) as specified/defined herein in the present disclosure; and, when/if an indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a beam metric L1-RSRP/L1-SINR, the beam metric L1-RSRP/L1-SINR could be associated/specific/corresponding to or obtained/determined/identified according to/based on a SSB and/or a CSI-RS selected from the (set of) candidate/new beam RS(s)/RS resource(s) as specified/defined herein in the present disclosure.
In another example, the UEI beam report could comprise one or more indicators each having a bitwidth of ┌log₂(Nₜ)┐ and/or one or more indexes, wherein Nₜ=nrofReportedRS-UEIBR; in this case, when/if an indicator/index indicates a value nₜ, the nₜ-th resource indicator SSBRI/CRI in the UEI beam report (and therefore, the corresponding beam metric L1-RSRP/L1-SINR in the UEI beam report)—among the reported nrofReportedRS-UEIBR resource indicators in the UEI beam report—could be associated/specific/corresponding to the current serving beam RS/RS resource as specified/defined herein in the present disclosure; Alternatively, the UEI beam report could comprise one or more indicators each having a bitwidth of ┌log₂(Nₜ)┐ and one or more indexes, wherein Nₜ=nrofReportedRS-UEIBR; in this case, when/if an indicator/index indicates a value nₜ, the nₜ-th resource indicator SSBRI/CRI in the UEI beam report (and therefore, the corresponding beam metric L1-RSRP/L1-SINR in the UEI beam report)—among the reported nrofReportedRS-UEIBR resource indicators in the UEI beam report—could select a SSB and/or a CSI-RS from the (set of) candidate/new beam RS(s)/RS resource(s) as specified/defined herein in the present disclosure. Optionally, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) in the UEI beam report; in this case, when/if an indicator/index indicates a value mₜ, the mₜ-th CSI field—e.g., among the CSI fields in the UEI beam report or the CSI fields that carry or convey the resource indicator(s) SSBRI(s)/CRI(s) in the UEI beam report—would carry or convey a resource indicator SSBRI/CRI, and the resource indicator SSBRI/CRI (and therefore, the corresponding beam metric L1-RSRP/L1-SINR in the UEI beam report) could be associated/specific/corresponding to the current serving beam RS/RS resource as specified/defined herein in the present disclosure. Alternatively, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) in the UEI beam report; in this case, when/if an indicator/index indicates a value mₜ, the mₜ-th CSI field—e.g., among the CSI fields in the UEI beam report or the CSI fields that carry or convey the resource indicator(s) SSBRI(s)/CRI(s) in the UEI beam report—would carry or convey a resource indicator SSBRI/CRI, and the resource indicator SSBRI/CRI (and therefore, the corresponding beam metric L1-RSRP/L1-SINR in the UEI beam report) could select a SSB and/or a CSI-RS from the (set of) candidate/new beam RS(s)/RS resource(s) as specified/defined herein in the present disclosure.
In another example, the UEI beam report could comprise one or more indicators each having a bitwidth of ┌log₂(Nₜ)┐ and/or one or more indexes, wherein Nₜ=nrofReportedRS-UEIBR; in this case, when/if an indicator/index indicates a value nₜ, the nₜ-th beam metric L1-RSRP/L1-SINR in the UEI beam report (and therefore, the corresponding resource indicator SSBRI/CRI in the UEI beam report)—among the reported nrofReportedRS-UEIBR beam metrics in the UEI beam report—could be associated/specific/corresponding to and/or obtained/determined/identified according to or based on the current serving beam RS/RS resource as specified/defined herein in the present disclosure. Alternatively, the UEI beam report could comprise one or more indicators each having a bitwidth of ┌log₂(Nₜ)┐ and one or more indexes, wherein Nₜ=nrofReportedRS-UEIBR; in this case, when/if an indicator/index indicates a value nₜ, the nₜ-th beam metric in the UEI beam report—among the reported nrofReportedRS-UEIBR beam metrics in the UEI beam report—could be associated/specific/corresponding to or obtained/determined/identified according to/based on a SSB and/or a CSI-RS selected from the (set of) candidate/new beam RS(s)/RS resource(s) as specified/defined herein in the present disclosure. Optionally, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the beam metric(s) L1-RSRP(s)/L1-SINR(s) in the UEI beam report; in this case, when/if an indicator/index indicates a value mₜ, the mₜ-th CSI field—e.g., among the CSI fields in the UEI beam report or the CSI fields that carry or convey the beam metric(s) L1-RSRP(s)/L1-SINR(s) in the UEI beam report—would carry or convey a beam metric L1-RSRP/L1-SINR, and the beam metric L1-RSRP/L1-SINR could be associated/specific/corresponding to or obtained/determined/identified according to/based on the current serving beam RS/RS resource as specified/defined herein in the present disclosure. Alternatively, the UEI beam report could comprise one or more indicators each having a bitwidth of ┌log₂(Mₜ)┐ and one or more indexes, wherein Mₜ could correspond to a/the number of the CSI fields in the UEI beam report or a/the number of the CSI fields that carry or convey the beam metric(s) L1-RSRP(s)/L1-SINR(s) in the UEI beam report; in this case, when/if an indicator/index indicates a value mₜ, the mₜ-th CSI field—e.g., among the CSI fields in the UEI beam report or the CSI fields that carry or convey the beam metric(s) L1-RSRP(s)/L1-SINR(s) in the UEI beam report—would carry or convey a beam metric L1-RSRP/L1-SINR, and the beam metric L1-RSRP/L1-SINR could be associated/specific/corresponding to or obtained/determined/identified according to/based on a SSB and/or a CSI-RS selected from the (set of) candidate/new beam RS(s)/RS resource(s) as specified/defined herein in the present disclosure.
In another example, the bitwidth of/for a SSBRI corresponding/specific to/for the current serving beam RS/RS resource (a SSB) and/or a SSB selected from the (set of) candidate/new beam RS(s)/RS resource(s)—i.e., the set of SSB(s)—as specified/defined herein in the present disclosure could be ┌log₂(Kₛ^{SSB}+1)┐, wherein Kₛ^{SSB} is the number of SSB/PBCH blocks configured in the corresponding set of candidate/new beam RSs/RS resources (i.e., the set of SSBs). Furthermore, the bitwidth of/for a CRI corresponding/specific to/for the current serving beam RS/RS resource (a CSI-RS) and/or a CSI-RS selected from the (set of) candidate/new beam RS(s)/RS resource(s)—i.e., the set of CSI-RS resource(s)—as specified/defined herein in the present disclosure could be ┌log₂(Kₛ^{CSI-RS}+1)┐, wherein Kₛ^{CSI-RS} is the number of CSI-RS resources configured in the corresponding set of candidate/new beam RSs/RS resources (i.e., the set of CSI-RS resources). For this design example, the UEI beam report may not comprise any indicator(s) association/corresponding/specific to any report quantity(s)—e.g., a resource indicator of SSBRI/CRI or a beam metric of L1-RSRP/L1-SINR—to indicate whether a report quantity in the UEI beam report is associated/corresponding/specific and/or determined/obtained/identified based on or according to the current serving beam RS/RS resource or a SSB/CSI-RS selected from the corresponding set of candidate/new beam RS(s)/RS resource(s).

For the design example x.2, the reported nrofReportedRS-UEIBR (if higher layer configured) SSBRI(s) and/or CRI(s) may not comprise the SSBRI/CRI corresponding/specific to the current serving beam RS/RS resource as specified/defined herein in the present disclosure, and the reported nrofReportedRS-UEIBR (if higher layer configured) beam metric(s) including L1-RSRP(s)/L1-SINR(s) may not comprise the beam metric such as L1-RSRP/L1-SINR obtained or determined or identified for/specific to the current serving beam RS/RS resource as specified/defined herein in the present disclosure. For this design example,
In one example, among the reported (nrofReportedRS-UEIBR+1) beam metric(s) including L1-RSRP(s)/L1-SINR(s) in the UEI beam report, the one reported beam metric e.g. L1-RSRP/L1-SINR associated/specific/corresponding to or obtained/determined/identified according to/based on the current serving beam RS/RS resource as specified/defined herein in the present disclosure could be determined, identified and/or indicated (e.g., via indicator(s) in the corresponding UEI beam report) following or according to one or more of the design examples specified/defined/described herein in the present disclosure.
In another example, the index/order/position of the CSI field that carries or conveys the one reported beam metric e.g. L1-RSRP/L1-SINR associated/specific/corresponding to or obtained/determined/identified according to/based on the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the beam metric(s) including L1-RSRP(s)/L1-SINR(s).
   For the design example x.3, the reported (nrofReportedBM-UEIBR—1) SSBRI(s) and/or CRI(s) may not comprise the SSBRI/CRI corresponding/specific to the current serving beam RS/RS resource as specified/defined herein in the present disclosure, and the reported nrofReportedBM-UEIBR (if higher layer configured) beam metric(s) including L1-RSRP(s)/L1-SINR(s) may comprise the beam metric such as L1-RSRP/L1-SINR obtained or determined or identified for/specific to the current serving beam RS/RS resource as specified/defined herein in the present disclosure. For this design example,
In one example, among the reported nrofReportedBM-UEIBR beam metric(s) including L1-RSRP(s)/L1-SINR(s) in the UEI beam report, the one reported beam metric e.g. L1-RSRP/L1-SINR associated/specific/corresponding to or obtained/determined/identified according to/based on the current serving beam RS/RS resource as specified/defined herein in the present disclosure could be determined, identified and/or indicated (e.g., via indicator(s) in the corresponding UEI beam report) following or according to one or more of the design examples specified/defined/described herein in the present disclosure.
In another example, the index/order/position of the CSI field that carries or conveys the one reported beam metric e.g. L1-RSRP/L1-SINR associated/specific/corresponding to or obtained/determined/identified according to/based on the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the beam metric(s) including L1-RSRP(s)/L1-SINR(s).

For the design example x.4, the reported nrofReportedBM-UEIBR (if higher layer configured) SSBRI(s) and/or CRI(s) may not comprise the SSBRI/CRI corresponding/specific to the current serving beam RS/RS resource as specified/defined herein in the present disclosure, and the reported nrofReportedBM-UEIBR (if higher layer configured) beam metric(s) including L1-RSRP(s)/L1-SINR(s) may not comprise the beam metric such as L1-RSRP/L1-SINR obtained or determined or identified for/specific to the current serving beam RS/RS resource as specified/defined herein in the present disclosure. For this design example,
In one example, among the reported (nrofReportedBM-UEIBR+1) resource indicator(s) including SSBRI(s)/CRI(s) in the UEI beam report, the one reported resource indicator e.g. SSBRI/CRI associated/specific/corresponding to the current serving beam RS/RS resource as specified/defined herein in the present disclosure could be determined, identified and/or indicated (e.g., via indicator(s) in the corresponding UEI beam report) following or according to one or more of the design examples specified/defined/described herein in the present disclosure.
In another example, the index/order/position of the CSI field that carries or conveys the one reported resource indicator e.g. SSBRI/CRI associated/specific/corresponding to the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the resource indicator(s) including SSBRI(s)/CRI(s).

For the design example x.5, the reported nrofReportedBM-UEIBR SSBRI(s) and/or CRI(s) may comprise the SSBRI/CRI corresponding/specific to the current serving beam RS/RS resource as specified/defined herein in the present disclosure, and the reported (nrofReportedRS-UEIBR—1) beam metric(s) including L1-RSRP(s)/L1-SINR(s) may not comprise the beam metric such as L1-RSRP/L1-SINR obtained or determined or identified for/specific to the current serving beam RS/RS resource as specified/defined herein in the present disclosure. For this design example,
In one example, among the reported nrofReportedRS-UEIBR resource indicator(s) including SSBRI(s)/CRI(s) in the UEI beam report, the one reported resource indicator e.g. SSBRI/CRI associated/specific/corresponding to the current serving beam RS/RS resource as specified/defined herein in the present disclosure could be determined, identified and/or indicated (e.g., via indicator(s) in the corresponding UEI beam report) following or according to one or more of the design examples specified/defined/described herein in the present disclosure.
In another example, the index/order/position of the CSI field that carries or conveys the one reported resource indicator e.g. SSBRI/CRI associated/specific/corresponding to the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the resource indicator(s) including SSBRI(s)/CRI(s).
When/if a UE (e.g., the UE 116) is provided a higher layer parameter currentBeamInclusion (e.g., in/by/via higher layer parameter(s) CSI-ReportConfig and/or UEI-ReportConfig that provides necessary information and/or setting(s) for the UEI beam reporting), and/or the higher layer parameter currentBeamInclusion is set to ‘enabled’, the UE could report, in a single report/reporting instance/CSI-Report/UEI-BR,
   In one example, nrofReportedRS-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, one resource indicator e.g. SSBRI/CRI associated/specific/corresponding to the current serving beam RS/RS resource as specified/defined herein in the present disclosure, nrofReportedRS-UEIBR (if higher layer configured) L1-RSRP(s)/L1-SINR(s) corresponding to the reported nrofReportedRS-UEIBR (if higher layer configured) SSBRI(s) and/or CRI(s), and one beam metric such as L1-RSRP/L1-SINR obtained or determined or identified for/specific to the current serving beam RS/RS resource as specified/defined herein in the present disclosure.
   In another example, nrofReportedRS-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, one resource indicator e.g. SSBRI/CRI associated/specific/corresponding to the current serving beam RS/RS resource as specified/defined herein in the present disclosure, and nrofReportedRS-UEIBR (if higher layer configured) L1-RSRP(s)/L1-SINR(s) corresponding to the reported nrofReportedRS-UEIBR (if higher layer configured) SSBRI(s) and/or CRI(s).
   In another example, nrofReportedRS-UEIBR (if higher layer configured) SSBRI(s) and/or CRI(s) selecting SSB(s) and/or CSI-RS(s) from the (set of) candidate/new beam RS(s)/RS resource(s) as specified/defined herein in the present disclosure, wherein at least one of the selected SSB(s) and/or CSI-RS(s) could satisfy the condition(s) of the event(s) and/or could be determined or identified according to or based on evaluation(s), assessment(s), detection(s) and/or declaration(s) of the corresponding event(s) according to or following those specified herein in the present disclosure, nrofReportedRS-UEIBR (if higher layer configured) L1-RSRP(s)/L1-SINR(s) corresponding to the reported nrofReportedRS-UEIBR (if higher layer configured) SSBRI(s) and/or CRI(s), and one beam metric such as L1-RSRP/L1-SINR obtained or determined or identified for/specific to the current serving beam RS/RS resource as specified/defined herein in the present disclosure.
For the design example y.1, y.2 and/or y.3,
   In one example, the index/order/position of the CSI field that carries or conveys the one reported resource indicator e.g. SSBRI/CRI associated/specific/corresponding to the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the resource indicator(s) including SSBRI(s)/CRI(s).
   In another example, the index/order/position of the CSI field that carries or conveys the one reported beam metric e.g. L1-RSRP/L1-SINR associated/specific/corresponding to or obtained/determined/identified according to/based on the current serving beam RS/RS resource as specified/defined herein in the present disclosure could be the lowest (or highest) among the CSI field(s) in the UEI beam report, or among the CSI field(s) that carries or conveys the resource indicator(s) including SSBRI(s)/CRI(s) and the corresponding beam metric(s) including L1-RSRP(s)/L1-SINR(s), or among the CSI field(s) that carries or conveys the beam metric(s) including L1-RSRP(s)/L1-SINR(s).

According to or following those specified/defined herein in the present disclosure, a/the UEI beam report could comprise one or more first indicators to indicate which of the reported report quantity(s)—e.g., resource indicator(s) including SSBRI(s)/CRI(s) and/or beam metric(s) including L1-RSRP(s)/L1-SINR(s)—in the UEI beam report could satisfy the condition(s) of the event(s) and/or could be determined or identified according to or based on evaluation(s), assessment(s), detection(s) and/or declaration(s) of the corresponding event(s) according to or following those specified herein in the present disclosure, and/or which of the reported report quantity(s)—e.g., resource indicator(s) including SSBRI(s)/CRI(s) and/or beam metric(s) including L1-RSRP(s)/L1-SINR(s)—in the UEI beam report may not satisfy the condition(s) of the event(s) and/or may not be determined or identified according to or based on evaluation(s), assessment(s), detection(s) and/or declaration(s) of the corresponding event(s) according to or following those specified herein in the present disclosure. Inclusion of the one or more first indicators in the UEI beam report could be based on or according to one or more of:
The UE is enabled and/or disabled (or it is enabled and/or disabled) by the network (e.g., the network 130), e.g., via higher layer RRC signaling(s)/parameter(s) and/or MAC CE command(s) and/or dynamic DCI based L1 signaling(s) according to or based on a corresponding UE's capability or capability signaling, to include the one or more first indicators in the UEI beam report or not. Or equivalently, presence/absence of the one or more first indicators in the UEI beam report could be configured, provided, enabled and/or disabled by the network, e.g., via higher layer RRC signaling(s)/parameter(s) and/or MAC CE command(s) and/or dynamic DCI based L1 signaling(s) according to or based on a corresponding UE's capability or capability signaling of whether they are capable of supporting inclusion of the one or more first indicators in the UEI beam report. For instance, when/if a higher layer parameter inclusionOfEventTriggeringBeam is provided, configured and/or present, e.g., in/via/by the higher layer RRC signaling(s)/parameter(s) CSI-ReportConfig and/or UEI-ReportConfig that provides or configures information and/or setting(s) for the UEI beam reporting as specified/defined herein in the present disclosure, and/or the higher layer parameter inclusionOfEventTriggeringBeam is set to ‘enabled’, the UE could include, transmit or send, in the UEI beam report, the one or more first indicators. Otherwise, i.e., when/if a higher layer parameter inclusionOfEventTriggeringBeam is not provided, configured and/or present or is absent, e.g., in/via/by the higher layer RRC signaling(s)/parameter(s) CSI-ReportConfig and/or UEI-ReportConfig that provides or configures information and/or setting(s) for the UEI beam reporting as specified/defined herein in the present disclosure, and/or when/if the higher layer parameter inclusionOfEventTriggeringBeam is provided, configured and/or present, e.g., in/via/by the higher layer RRC signaling(s)/parameter(s) CSI-ReportConfig and/or UEI-ReportConfig that provides or configures information and/or setting(s) for the UEI beam reporting as specified/defined herein in the present disclosure, but is set to ‘disabled’, the UE may not include, transmit or send, in the UEI beam report, the one or more first indicators.
The UE has sent or transmitted to the network, e.g., in/via/by their capability signaling(s), whether or not they are capable of and/or their capability(s) of supporting inclusion of the one or more first indicators in a/the UEI beam report to differentiate between/among the report quantities reported in the UEI beam report that satisfy or achieve the event(s) condition(s) or not.
The higher layer configured value(s) of nrofReportedRS-UEIBR and/or nrofReportedBM-UEIBR—as specified/defined herein in the present disclosure—is lower (or greater) than or equal to a threshold, wherein the UE could determine or identity the value of the threshold based on or according to: a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
The threshold value(s) configured/provided for evaluating an event or an instance of an event, e.g., threshold-C, threshold-C′ and/or threshold-C″ for evaluating the fourth event (or Event-4) or an instance of the fourth Event (or Event-4), is lower (or greater) than or equal to a threshold, wherein the UE could determine or identity the value of the threshold based on or according to: a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
The UE is not (or is) configured or provided by the network, e.g., via higher layer RRC signaling(s)/parameter(s)—e.g., in/via/by the higher layer RRC signaling(s)/parameter(s) CSI-ReportConfig and/or UEI-ReportConfig that provides or configures information and/or setting(s) for the UEI beam reporting as specified/defined herein in the present disclosure—and/or MAC CE command(s) and/or dynamic DCI based L1 signaling(s) based on or according to a corresponding UE's capability or capability signaling, the timer/time window/time duration/time gap/time offset, the counter/maximum number of counts and/or etc. for evaluating an event or an instance of an event.
The UE is not provided a higher layer parameter currentBeamInclusion (e.g., in/by/via higher layer parameter(s) CSI-ReportConfig and/or UEI-ReportConfig that provides necessary information and/or setting(s) for the UEI beam reporting), and/or the UE is provided the higher layer parameter currentBeamInclusion (e.g., in/by/via higher layer parameter(s) CSI-ReportConfig and/or UEI-ReportConfig that provides necessary information and/or setting(s) for the UEI beam reporting) but the higher layer parameter currentBeamInclusion is set to ‘disabled’ (the corresponding UE's behaviors, expectations and/or operations could be according to or following those specified herein in the present disclosure)
The UE is not provided a higher layer parameter currentBeamInclusion (e.g., in/by/via higher layer parameter(s) CSI-ReportConfig and/or UEI-ReportConfig that provides necessary information and/or setting(s) for the UEI beam reporting), and/or the UE is provided the higher layer parameter currentBeamInclusion (e.g., in/by/via higher layer parameter(s) CSI-ReportConfig and/or UEI-ReportConfig that provides necessary information and/or setting(s) for the UEI beam reporting) but the higher layer parameter currentBeamInclusion is set to ‘disabled’ (the corresponding UE's behaviors, expectations and/or operations could be according to or following those specified herein in the present disclosure); furthermore, one or more of the followings may need to be satisfied/achieved:
   The UEI beam report does not comprise any report quantity(s)—e.g., resource indicator(s) of SSBRI(s)/CRI(s) and/or beam metric(s) of L1-RSRP(s)/L1-SINR(s)—associated/specific/corresponding to and/or determined/identified/obtained based on or according to the current serving beam RS/RS resource as specified/defined herein in the present disclosure.
   The UEI beam report could comprise one or more report quantities—e.g., resource indicator(s) of SSBRI(s)/CRI(s) and/or beam metric(s) of L1-RSRP(s)/L1-SINR(s)—associated/specific/corresponding to and/or determined/identified/obtained based on or according to the current serving beam RS/RS resource as specified/defined herein in the present disclosure, and/or the position(s)/ordering(s) of the CSI field(s) in the UEI beam report that carries or conveys the one or more report quantities is unknown to the network (e.g., the UEI beam report may not comprise any indicator(s) as specified/defined herein in the present disclosure to indicate position(s)/ordering(s) of the CSI field(s) in the UEI beam report that carries or conveys the one or more report quantities)
The UE has determined or identified that the total/maximum number of (UCI) bits for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Umax, and/or the UE has determined or identified the actual number of (UCI) bits to carry or convey the report quantity(s) including resource indicator(s) of SSBRI(s)/CRI(s) and/or beam metric(s) of L1-RSRP(s)/L1-SINR(s) of the UEI beam report in a single reporting instance/CSI report associated to a CSI reporting setting provided by CSI-ReportConfig/UEI-ReportConfig as specified/defined herein in the present disclosure is Urq, which is less than or equal to Umax (e.g., Urq<Umax).
The UE has determined or identified that the total/maximum number of (UCI) bits for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Umax, and/or the UE has determined or identified the actual number of (UCI) bits to carry or convey the report quantity(s) including resource indicator(s) of SSBRI(s)/CRI(s) and/or beam metric(s) of L1-RSRP(s)/L1-SINR(s) of the UEI beam report in a single reporting instance/CSI report associated to a CSI reporting setting provided by CSI-ReportConfig/UEI-ReportConfig as specified/defined herein in the present disclosure is Urq, which is less than or equal to Umax (e.g., Urq<Umax), and the remaining (Umax−Urq) (UCI) bits could be (large) enough to accommodate one or more of the first indicator(s) in the UEI beam report.
The UE has determined or identified that the total/maximum number of CSI fields for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Cmax, and/or the UE has determined or identified the actual number of CSI fields to carry or convey the report quantity(s) including resource indicator(s) of SSBRI(s)/CRI(s) and/or beam metric(s) of L1-RSRP(s)/L1-SINR(s) of the UEI beam report in a single reporting instance/CSI report associated to a CSI reporting setting provided by CSI-ReportConfig/UEI-ReportConfig as specified/defined herein in the present disclosure is Crq, which is less than or equal to Cmax (e.g., Crq<Cmax).
The UE has determined or identified that the total/maximum number of CSI fields for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Cmax, and/or the UE has determined or identified the actual number of CSI fields to carry or convey the report quantity(s) including resource indicator(s) of SSBRI(s)/CRI(s) and/or beam metric(s) of L1-RSRP(s)/L1-SINR(s) of the UEI beam report in a single reporting instance/CSI report associated to a CSI reporting setting provided by CSI-ReportConfig/UEI-ReportConfig as specified/defined herein in the present disclosure is Crq, which is less than or equal to Cmax (e.g., Crq<Cmax), and the remaining (Cmax−Crq) CSI fields could be (large) enough to accommodate one or more of the first indicator(s) in the UEI beam report.

Throughout the present disclosure, a report quantity including a resource indicator SSBRI/CRI or a beam metric L1-RSRP/L1-SINR reported in a/the UEI beam report satisfying the condition(s) of the event(s) and/or determined or identified according to or based on evaluation(s), assessment(s), detection(s), determination(s) and/or declaration(s) of the corresponding event(s) according to or following those specified herein in the present disclosure could simply be referred to as a report quantity including a resource indicator SSBRI/CRI or a beam metric L1-RSRP/L1-SINR reported in a/the UEI beam report satisfying/achieving the event(s) condition(s) or event condition(s). And, a report quantity including a resource indicator SSBRI/CRI or a beam metric L1-RSRP/L1-SINR reported in a/the UEI beam report not satisfying the condition(s) of the event(s) and/or not determined or identified according to or based on evaluation(s), assessment(s), detection(s), determination(s) and/or declaration(s) of the corresponding event(s) according to or following those specified herein in the present disclosure could simply be referred to as a report quantity including a resource indicator SSBRI/CRI or a beam metric L1-RSRP/L1-SINR reported in a/the UEI beam report not satisfying/achieving the event(s) condition(s) or event condition(s). In particular, inclusion of the one or more first indicators in a/the UEI beam report to differentiate between/among report quantities that satisfy/achieve the event(s) condition(s) or not could be based on or according to:
In one example, the UEI beam report could comprise one or more first (one-bit) indicators each associated/corresponding/specific to a report quantity, e.g., a SSBRI/CRI or a L1-RSRP/L1-SINR, and/or each of the reported report quantity(s) in the UEI beam report could be associated/corresponding/specific to a first (one-bit) indicator; in this case, when/if a first (one-bit) indicator is set to ‘1’ (or ‘0’), the report quantity associated/corresponding/specific to the (one-bit) indicator could satisfy/achieve the event condition(s); otherwise, i.e., when/if a first (one-bit) indicator is set to ‘0’ (or ‘1’), the report quantity associated/corresponding/specific to the first (one-bit) indicator may not satisfy/achieve the event condition(s). Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first (one-bit) indicators each associated/corresponding/specific to a resource indicator, e.g., a SSBRI/CRI, and/or each of the reported resource indicator(s) in the UEI beam report could be associated/corresponding/specific to a first (one-bit) indicator; in this case, when/if a first (one-bit) indicator is set to ‘1’ (or ‘0’), the resource indicator SSBRI/CRI (and therefore, the corresponding beam metric L1-RSRP/L1-SINR in the same CSI report/UEI-BR) associated/corresponding/specific to the first (one-bit) indicator could satisfy/achieve the event condition(s) as specified/defined herein in the present disclosure; otherwise, i.e., when/if a first (one-bit) indicator is set to ‘0’ (or ‘1’), the resource indicator SSBRI/CRI (and therefore, the corresponding beam metric L1-RSRP/L1-SINR in the same CSI report/UEI-BR) associated/corresponding/specific to the first (one-bit) indicator may not satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first (one-bit) indicators each associated/corresponding/specific to a beam metric, e.g., a L1-RSRP/L1-SINR, and/or each of the reported beam metric(s) in the UEI beam report could be associated/corresponding/specific to a first (one-bit) indicator; in this case, when/if a first (one-bit) indicator is set to ‘1’ (or ‘0’), the beam metric L1-RSRP/L1-SINR (and therefore, the corresponding resource indicator SSBRI/CRI in the same CSI report/UEI-BR) associated/corresponding/specific to the first (one-bit) indicator could satisfy/achieve the event condition(s) as specified/defined herein in the present disclosure; otherwise, i.e., when/if a first (one-bit) indicator is set to ‘0’ (or ‘1’), the beam metric L1-RSRP/L1-SINR (and therefore, the corresponding resource indicator SSBRI/CRI in the same CSI report/UEI-BR) associated/corresponding/specific to the first (one-bit) indicator may not satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first (one-bit) indicators each associated/corresponding/specific to a report quantity, e.g., a SSBRI/CRI or a L1-RSRP/L1-SINR, that satisfies/achieves the event condition(s) as specified/defined herein in the present disclosure; i.e., when/if a first (one-bit) indicator is present and set to a valid value e.g. ‘1’ or ‘0’, the report quantity associated/corresponding/specific to the first (one-bit) indicator could satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first (one-bit) indicators each associated/corresponding/specific to a report quantity, e.g., a SSBRI/CRI or a L1-RSRP/L1-SINR, that may not satisfy/achieve the event condition(s) as specified/defined herein in the present disclosure; i.e., when/if a first (one-bit) indicator is present and set to a valid value e.g. ‘1’ or ‘0’, the report quantity associated/corresponding/specific to the first (one-bit) indicator may not satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first indicators each associated/corresponding/specific to a resource indicator, e.g., a SSBRI/CRI, that satisfy/achieve the event condition(s) as specified/defined herein in the present disclosure; i.e, when/if a first (one-bit) indicator is present and set to a valid value e.g. ‘1’ or ‘0’, the resource indicator SSBRI/CRI (and therefore, the corresponding beam metric L1-RSRP/L1-SINR in the same CSI report/UEI-BR) associated/corresponding/specific to the indicator—e.g., when/if the index/order/position of a first CSI field in the UEI beam report that carries/conveys the first (one-bit) indicator is k, the index/order/position of a second CSI field in the UEI beam report that carries/conveys the resource indicator SSBRI/CRI is k+1 or k−1 (i.e., the second CSI field could follow the first CSI field (e.g., in order or in index or in ordinal position) in the UEI beam report or vice versa)—could satisfy/achieve the event condition(s) as specified/defined herein in the present disclosure. Alternatively, the UEI beam report could comprise one or more first indicators each associated/corresponding/specific to a beam metric, e.g., a L1-RSRP/L1-SINR, that could satisfy/achieve the event condition(s) as specified/defined herein in the present disclosure; i.e, when/if a first (one-bit) indicator is present and set to a valid value e.g. ‘1’ or ‘0’, the beam metric L1-RSRP/L1-SINR (and therefore, the corresponding resource indicator SSBRI/CRI in the same CSI report/UEI-BR) associated/corresponding/specific to the indicator—e.g., when/if the index/order/position of a first CSI field in the UEI beam report that carries/conveys the first (one-bit) indicator is k, the index/order/position of a second CSI field in the UEI beam report that carries/conveys the beam metric L1-RSRP/L1-SINR is k+1 or k−1 (i.e., the second CSI field could follow the first CSI field (e.g., in order or in index or in ordinal position) in the UEI beam report or vice versa)—could satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first indicators each associated/corresponding/specific to a resource indicator, e.g., a SSBRI/CRI, that may not satisfy/achieve the event condition(s) as specified/defined herein in the present disclosure; i.e, when/if a (one-bit) first indicator is present and set to a valid value e.g. ‘1’ or ‘0’, the resource indicator SSBRI/CRI (and therefore, the corresponding beam metric L1-RSRP/L1-SINR in the same CSI report/UEI-BR) associated/corresponding/specific to the indicator—e.g., when/if the index/order/position of a first CSI field in the UEI beam report that carries/conveys the (one-bit) indicator is k, the index/order/position of a second CSI field in the UEI beam report that carries/conveys the resource indicator SSBRI/CRI is k+1 or k−1 (i.e., the second CSI field could follow the first CSI field (e.g., in order or in index or in ordinal position) in the UEI beam report or vice versa)—may not satisfy/achieve the event condition(s) as specified/defined herein in the present disclosure. Alternatively, the UEI beam report could comprise one or more first indicators each associated/corresponding/specific to a beam metric, e.g., a L1-RSRP/L1-SINR, that may not satisfy/achieve the event condition(s) as specified/defined herein in the present disclosure; i.e, when/if a first (one-bit) indicator is present and set to a valid value e.g. ‘1’ or ‘0’, the beam metric L1-RSRP/L1-SINR (and therefore, the corresponding resource indicator SSBRI/CRI in the same CSI report/UEI-BR) associated/corresponding/specific to the indicator—e.g., when/if the index/order/position of a first CSI field in the UEI beam report that carries/conveys the first (one-bit) first indicator is k, the index/order/position of a second CSI field in the UEI beam report that carries/conveys the beam metric L1-RSRP/L1-SINR is k+i or k−1 (i.e., the second CSI field could follow the first CSI field (e.g., in order or in index or in ordinal position) in the UEI beam report or vice versa)—may not satisfy/achieve the event condition(s) as specified/defined herein in the present disclosure. Optionally, the one or more first (one-bit) indicators here could be or could correspond to or could be in form of a bitmap such that each entry/bit position of the bitmap could correspond to a first (one-bit) indicator, and/or each of the one or more first (one-bit) indicators here could correspond to an entry/bit position of the bitmap.
In another example, the UEI beam report could comprise one or more first indicators each having a bitwidth of ┌log₂(Nₜ)┐ and/or one or more indexes, wherein Nₜ=nrofReportedRS-UEIBR+nrofReportedRS-UEIBR; in this case, when/if a first indicator/index indicates a value nₜ less than or equal to nrofReportedRS-UEIBR, the nₜ-th resource indicator SSBRI/CRI in the UEI beam report—among the reported nrofReportedRS-UEIBR resource indicators in the UEI beam report—could satisfy/achieve the event condition(s) as specified/defined herein in the present disclosure; and, when/if a first indicator/index indicates a value nₜ greater than nrofReportedRS-UEIBR, the (nₜ—nrofReportedRS-UEIBR)-th beam metric in the UEI beam report—among the reported nrofReportedRS-UEIBR beam metrics in the UEI beam report—could satisfy/achieve the event condition(s) as specified/defined herein in the present disclosure. Alternatively, the UEI beam report could comprise one or more first indicators each having a bitwidth of ┌log₂(Nₜ)┐ and one or more indexes, wherein Nₜ=nrofReportedRS-UEIBR+nrofReportedRS-UEIBR; in this case, when/if a first indicator/index indicates a value nₜ less than or equal to nrofReportedRS-UEIBR, the nₜ-th resource indicator SSBRI/CRI in the UEI beam report—among the reported nrofReportedRS-UEIBR resource indicators in the UEI beam report—may not satisfy/achieve the event condition(s) as specified/defined herein in the present disclosure; and, when/if a first indicator/index indicates a value nₜ greater than nrofReportedRS-UEIBR, the (nₜ—nrofReportedRS-UEIBR)-th beam metric in the UEI beam report—among the reported nrofReportedRS-UEIBR beam metrics in the UEI beam report—may not satisfy/achieve the event condition(s) as specified/defined herein in the present disclosure. Optionally, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) and the corresponding beam metric(s) L1-RSRP(s)/L1-SINR(s) in the UEI beam report; in this case, when/if a first indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a resource indicator SSBRI/CRI, the resource indicator SSBRI/CRI could satisfy/achieve the event condition(s) as specified/defined herein in the present disclosure; and, when/if a first indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a beam metric L1-RSRP/L1-SINR, the beam metric L1-RSRP/L1-SINR could satisfy/achieve the event condition(s) as specified/defined herein in the present disclosure. Alternatively, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) and the corresponding beam metric(s) L1-RSRP(s)/L1-SINR(s) in the UEI beam report; in this case, when/if a first indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a resource indicator SSBRI/CRI, the resource indicator SSBRI/CRI may not satisfy/achieve the event condition(s) as specified/defined herein in the present disclosure; and, when/if a first indicator/index indicates a value mₜ, and when/if the mₜ-th CSI field—e.g., among the CSI fields in the UEI beam report or the CSI fields that carry or convey the resource indicator(s) SSBRI(s)/CRI(s) and the corresponding beam metric(s) L1-RSRP(s)/L1-SINR(s) in the UEI beam report—carries or conveys a beam metric L1-RSRP/L1-SINR, the beam metric L1-RSRP/L1-SINR may not satisfy/achieve the event condition(s) as specified/defined herein in the present disclosure.
In another example, the UEI beam report could comprise one or more first indicators each having a bitwidth of ┌log₂(Nₜ)┐ and/or one or more indexes, wherein Nₜ=nrofReportedRS-UEIBR; in this case, when/if a first indicator/index indicates a value nₜ, the nₜ-th resource indicator SSBRI/CRI in the UEI beam report (and therefore, the corresponding beam metric L1-RSRP/L1-SINR in the UEI beam report)—among the reported nrofReportedRS-UEIBR resource indicators in the UEI beam report—could satisfy/achieve the event condition(s) as specified/defined herein in the present disclosure; Alternatively, the UEI beam report could comprise one or more first indicators each having a bitwidth of ┌log₂(Nₜ)┐ and one or more indexes, wherein Nₜ=nrofReportedRS-UEIBR; in this case, when/if a first indicator/index indicates a value nₜ, the nₜ-th resource indicator SSBRI/CRI in the UEI beam report (and therefore, the corresponding beam metric L1-RSRP/L1-SINR in the UEI beam report)—among the reported nrofReportedRS-UEIBR resource indicators in the UEI beam report—may not satisfy/achieve the event condition(s) as specified/defined herein in the present disclosure. Optionally, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) in the UEI beam report; in this case, when/if a first indicator/index indicates a value mₜ, the mₜ-th CSI field—e.g., among the CSI fields in the UEI beam report or the CSI fields that carry or convey the resource indicator(s) SSBRI(s)/CRI(s) in the UEI beam report—would carry or convey a resource indicator SSBRI/CRI, and the resource indicator SSBRI/CRI (and therefore, the corresponding beam metric L1-RSRP/L1-SINR in the UEI beam report) could satisfy/achieve the event condition(s) as specified/defined herein in the present disclosure. Alternatively, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the resource indicator(s) SSBRI(s)/CRI(s) in the UEI beam report; in this case, when/if an indicator/index indicates a value mₜ, the mₜ-th CSI field—e.g., among the CSI fields in the UEI beam report or the CSI fields that carry or convey the resource indicator(s) SSBRI(s)/CRI(s) in the UEI beam report—would carry or convey a resource indicator SSBRI/CRI, and the resource indicator SSBRI/CRI (and therefore, the corresponding beam metric L1-RSRP/L1-SINR in the UEI beam report) may not satisfy/achieve the event condition(s) as specified/defined herein in the present disclosure.
In another example, the UEI beam report could comprise one or more first indicators each having a bitwidth of ┌log₂(Nₜ)┐ and/or one or more indexes, wherein Nₜ=nrofReportedRS-UEIBR; in this case, when/if a first indicator/index indicates a value nₜ, the nₜ-th beam metric L1-RSRP/L1-SINR in the UEI beam report (and therefore, the corresponding resource indicator SSBRI/CRI in the UEI beam report)—among the reported nrofReportedRS-UEIBR beam metrics in the UEI beam report—could satisfy/achieve the event condition(s) as specified/defined herein in the present disclosure. Alternatively, the UEI beam report could comprise one or more first indicators each having a bitwidth of ┌log₂(Nₜ)┐ and one or more indexes, wherein Nₜ=nrofReportedRS-UEIBR; in this case, when/if a first indicator/index indicates a value nₜ, the nₜ-th beam metric in the UEI beam report—among the reported nrofReportedRS-UEIBR beam metrics in the UEI beam report—may not satisfy/achieve the event condition(s) as specified/defined herein in the present disclosure. Optionally, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the beam metric(s) L1-RSRP(s)/L1-SINR(s) in the UEI beam report; in this case, when/if an indicator/index indicates a value mₜ, the mₜ-th CSI field—e.g., among the CSI fields in the UEI beam report or the CSI fields that carry or convey the beam metric(s) L1-RSRP(s)/L1-SINR(s) in the UEI beam report—would carry or convey a beam metric L1-RSRP/L1-SINR, and the beam metric L1-RSRP/L1-SINR could satisfy/achieve the event condition(s) as specified/defined herein in the present disclosure. Alternatively, the UEI beam report could comprise one or more first indicators each having a bitwidth of ┌log₂(Mₜ)┐ and one or more indexes, wherein Mₜ could correspond to a/the number of the CSI fields in the UEI beam report or a/the number of the CSI fields that carry or convey the beam metric(s) L1-RSRP(s)/L1-SINR(s) in the UEI beam report; in this case, when/if a first indicator/index indicates a value mₜ, the mₜ-th CSI field—e.g., among the CSI fields in the UEI beam report or the CSI fields that carry or convey the beam metric(s) L1-RSRP(s)/L1-SINR(s) in the UEI beam report—would carry or convey a beam metric L1-RSRP/L1-SINR, and the beam metric L1-RSRP/L1-SINR may not satisfy/achieve the event condition(s) as specified/defined herein in the present disclosure.

According to or following those specified/defined herein in the present disclosure, when/if the UE has determined or identified that the total/maximum number of (UCI) bits for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Umax, and/or when/if the UE has determined or identified the actual number of (UCI) bits to carry or convey the UEI beam report in a single reporting instance/CSI report associated to a CSI reporting setting provided by CSI-ReportConfig/UEI-ReportConfig as specified/defined herein in the present disclosure is Uuei, which is less than or equal to Umax (e.g., Uuei<Umax), the corresponding UEI beam report could be padded with (Umax—Uuei) bits—e.g., UCI bits—of zeros. Alternatively, when/if the UE (e.g., the UE 116) has determined or identified that the total/maximum number of CSI fields for carrying or conveying the UEI beam report in a single reporting instance/CSI report associated to a CSI reporting setting provided by CSI-ReportConfig/UEI-ReportConfig as specified/defined herein in the present disclosure, e.g., based on or according to (1) a fixed value in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals, is Cmax, and/or when/if the UE has determined or identified the actual number of CSI fields to carry or convey the UEI beam report in a single reporting instance/CSI report associated to a CSI reporting setting provided by CSI-ReportConfig/UEI-ReportConfig as specified/defined herein in the present disclosure is Cuei, which is less than or equal to Cmax (e.g., Cuei<Cmax), the remaining (Cmax−Cuei) CSI fields in the UEI beam report that do not carry or carry any report quantity(s) of the UEI beam report—e.g., the (Cmax−Cuei) CSI fields with the lowest (or highest) index(es)/ID(s) e.g. among the CSI field(s) in the UEI beam report—could carry zero(s) or could be padded with zero(s).

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method begins with the UE receiving a TCI state (1210). The UE then receives CSI reporting setting for UE-initiated or event-driven beam reporting (1220). For example, in 1220, the CSI reporting setting includes an indication related to one or more report quantities associated with a current beam and information related to event evaluation.

The UE then determines a set of one or more RS resources for event evaluation based on the CSI reporting setting (1230). In various embodiments, the UE determines, based on the indication, that the current beam RS resource corresponds to a RS resource from the set that has a same RS resource ID value as a QCL RS resource associated with the TCI state. For example, the QCL RS resource is periodic CSI-RS resource provided in the TCI state or a SSB that is QCL'ed with the periodic CSI-RS resource provided in the TCI state.

In various embodiments, the UE determines, based on the indication, that the one or more candidate beam RS resources correspond to all the RS resources in the set except the RS resource corresponding to the current beam RS resource. In various embodiments, the information comprises a threshold value, a time window duration, and a number N. The UE determines an event instance associated with a candidate beam RS resource from the one or more candidate beam RS, when a L1-RSRP of the candidate beam RS is greater than a L1-RSRP of the current beam RS by the threshold value. For example, the event is further determined based on a quantity of the event instance within the time window duration being greater than or equal to the number N.

The UE then identifies a current beam RS resource based on the indication and the TCI state (1240). The UE then identifies one or more candidate beam RS resources based on the indication (1250). The UE then determines an event based on the information and measurements of the current and candidate beam RSs (1260). The UE then transmits the beam report based on determination of the event (1270).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a transmission configuration indication (TCI) state; and
receive channel state information (CSI) reporting setting for UE-initiated or event-driven beam reporting, wherein the CSI reporting setting includes:
an indication related to one or more report quantities associated with a current beam; and
information related to event evaluation; and
a processor operably coupled with the transceiver, the processor configured to:
determine, based on the CSI reporting setting, a set of one or more reference signal (RS) resources for event evaluation;
identify, based on the indication and the TCI state, a current beam RS resource;
identify, based on the indication, one or more candidate beam RS resources; and
determine, based on the information and measurements of the current and candidate beam RSs, an event,
wherein the transceiver is further configured to transmit, based on determination of the event, the beam report.

2. The UE of claim 1, wherein the processor is further configured to determine, based on the indication, that the current beam RS resource corresponds to a RS resource from the set that has a same RS resource ID value as a quasi-co-location (QCL) RS resource associated with the TCI state.

3. The UE of claim 2, wherein the QCL RS resource is:
a periodic CSI RS (CSI-RS) resource provided in the TCI state; or
a synchronization signal/physical broadcast channel block (SSB) that is quasi-co-located (QCL'ed) with the periodic CSI-RS resource provided in the TCI state.

4. The UE of claim 1, wherein the processor is further configured to determine, based on the indication, that the one or more candidate beam RS resources correspond to all the RS resources in the set except the RS resource corresponding to the current beam RS resource.

5. The UE of claim 1, wherein the information comprises:
a threshold value;
a time window duration; and
a number N.

6. The UE of claim 5, wherein the processor is further configured to determine an event instance associated with a candidate beam RS resource from the one or more candidate beam RS, when a layer-1 reference signal receive power (L1-RSRP) of the candidate beam RS is greater than a L1-RSRP of the current beam RS by the threshold value.

7. The UE of claim 6, wherein the event is further determined based on a quantity of the event instance within the time window duration being greater than or equal to the number N.

8. A base station (BS), comprising:
a processor; and
a transceiver operably coupled with the processor, the transceiver configured to:
transmit a transmission configuration indication (TCI) state; and
transmit channel state information (CSI) reporting setting for UE-initiated or event-driven beam reporting,
wherein the CSI reporting setting includes:
an indication related to one or more report quantities associated with a current beam, and
information related to event evaluation,
wherein the CSI reporting setting indicates a set of one or more reference signal (RS) resources for event evaluation,
wherein the indication and the TCI state indicate a current beam RS resource,
wherein the indication indicates one or more candidate beam RS resources,
wherein an event is determined based on the information and measurements of the current and candidate beam RSs, and
wherein the transceiver is further configured to receive the beam report based on the event occurring.

9. The BS of claim 8, wherein the indication indicates that the current beam RS resource corresponds to a RS resource from the set that has a same RS resource ID value as a quasi-co-location (QCL) RS resource associated with the TCI state.

10. The BS of claim 9, wherein the QCL RS resource is:
a periodic CSI RS (CSI-RS) resource provided in the TCI state; or
a synchronization signal/physical broadcast channel block (SSB) that is quasi-co-located (QCL'ed) with the periodic CSI-RS resource provided in the TCI state.

11. The BS of claim 8, wherein the indication indicates that the one or more candidate beam RS resources correspond to all the RS resources in the set except the RS resource corresponding to the current beam RS resource.

12. The BS of claim 8, wherein the information comprises:
a threshold value;
a time window duration; and
a number N.

13. The BS of claim 12, wherein an event instance associated with a candidate beam RS resource from the one or more candidate beam RS occurs when a layer-1 reference signal receive power (L1-RSRP) of the candidate beam RS is greater than a L1-RSRP of the current beam RS by the threshold value.

14. The BS of claim 13, wherein the event is further based on a quantity of the event instance within the time window duration being greater than or equal to the number N.

15. A method performed by a user equipment (UE), the method comprising:
receiving a transmission configuration indication (TCI) state;
receiving channel state information (CSI) reporting setting for UE-initiated or event-driven beam reporting, wherein the CSI reporting setting includes:
an indication related to one or more report quantities associated with a current beam; and
information related to event evaluation;
determining, based on the CSI reporting setting, a set of one or more reference signal (RS) resources for event evaluation;
identifying, based on the indication and the TCI state, a current beam RS resource;
identifying, based on the indication, one or more candidate beam RS resources;
determining, based on the information and measurements of the current and candidate beam RSs, an event; and
transmitting, based on determination of the event, the beam report.

16. The method of claim 15, further comprising determining, based on the indication, that the current beam RS resource corresponds to a RS resource from the set that has a same RS resource ID value as a quasi-co-location (QCL) RS resource associated with the TCI state.

17. The method of claim 16, wherein the QCL RS resource is:
a periodic CSI RS (CSI-RS) resource provided in the TCI state; or
a synchronization signal/physical broadcast channel block (SSB) that is quasi-co-located (QCL'ed) with the periodic CSI-RS resource provided in the TCI state.

18. The method of claim 15, further comprising determining, based on the indication, that the one or more candidate beam RS resources correspond to all the RS resources in the set except the RS resource corresponding to the current beam RS resource.

19. The method of claim 15, wherein the information comprises:
a threshold value;
a time window duration; and
a number N.

20. The method of claim 19, further comprising determining an event instance associated with a candidate beam RS resource from the one or more candidate beam RS, when a layer-1 reference signal receive power (L1-RSRP) of the candidate beam RS is greater than a L1-RSRP of the current beam RS by the threshold value.
